(19) United States
(12) Patent Application Publication
(10) Pub. No.: US 2003/0037181 A1
(43) Pub. Date: Feb. 20, 2003

(54) Method and apparatus for providing process-container platforms

(76) Inventor: Erik J. Freed, Berkeley, CA (US)

Correspondence Address: Steven M. Santisi, Consilient Inc., 91 Bolivar Drive, Berkeley, CA, 94710, US

(21) Appl. No.: 09/900,842

(22) Filed: Jul. 7, 2001

Related U.S. Application Data
(60) Provisional application No. 60/216,871, filed on Jul. 7, 2000.

(51) Int. Cl. G06F 9/00; G06F 9/46

(52) U.S. Cl. 709/328; 709/202

(57) ABSTRACT

The invention includes a system and method for providing a process-container platform which includes a system for process automation and collaboration. The system includes process-containers that are mobile, self-contained, asynchronous, executable, visualizeable agents that include presentation information, logic, and data. Also included a peers that run on host networked devices such as personal computers in a local area network and are operable to display, transmit, interact with, and receive the process-containers. In addition, both on and off-line, peers are operable to execute the logic of the process-containers and provide the process-containers access to data and applications also stored or running on the local host. The process-containers are operable to move between the peers to execute the process described in the logic of the process-container. The process-container is further operable to carry its data in the form of documents, including multi-media documents, as it moves between peers.

### RELATED APPLICATIONS

This application claims priority to commonly owned, co-pending U.S. Provisional Patent Application Serial No. 60/216,871 filed on Jul. 7, 2000 and entitled “Method and Apparatus for Providing Sitelet Platforms”, the entire content of which is hereby incorporated herein by reference for all purposes.

### FIELD OF THE INVENTION

The present invention relates to methods and apparatus for process automation and collaboration. More specifically, the present invention relates to applications, software development platforms, application programming interfaces, and software execution platforms for mobile agent-based process automation and collaboration.

### BACKGROUND OF THE INVENTION

Conventional automation systems are unable to meet the diverse needs of enterprise-wide business processes that frequently span multiple organizations. Further, most business processes are dynamic, ad hoc, change and grow in unpredictable ways, long running, not well understood by any single participant much less all participants, often require some degree of collaboration between participants, and frequently require a substantial amount of exception processing. In an era in which large corporations readily spend millions of dollars annually on software, the lack of any clearly dominant commercially available application, or even a platform for developing such applications, illustrates that the existing solutions for automating enterprise-wide business processes fall short of solving the inherent challenges described above.

Once the infrastructure of the Internet was in place sufficiently to facilitate efficient communication via email and the World Wide Web (Web), there were several unsuccessful attempts to create systems to help automate the elaborate interactions between companies beyond the static and inflexible transactions of early closed systems such as the Electronic Data Interchange (EDI) system or unscalable workflow applications. Some of the first Internet-based systems to emerge included Enterprise Application Integration (EAI), Business-to-Business Integration (B2Bi), and web-based workflow. These systems suffered from a number of drawbacks including that in using these systems it was difficult to implement and maintain processes; these systems were unable to handle unpredictable or ad hoc processes; these systems did not work with diverse content formats and standards; and they were largely focused on machine-to-machine interactions. The generation of systems that followed next included publishing and portal systems. These systems suffered from some of the drawbacks of the prior generation and they included some of their own limitations. These systems could not handle exceptions or ad hoc processes; they generally did not support collaborative interactions between participants; they typically relied on a single-hub model; and they did not provide support for offline and incremental work by users of the systems.

Commerce applications came next following the portal-based systems. However, these systems were largely focused on merely enabling sales transactions and did not address the much broader and richer set of interactions engaged in by businesses and other enterprise-sized entities, particularly multi-national corporations and governments. In addition, using these systems it was difficult to extend the process beyond the transaction or deal with exceptions. These applications did not provide any facilities for collaboration and they were unable to handle diverse content formats and standards.

Looking at the conventional systems of the past it becomes clear that where the primary focus was on process automation (ERP, EIA/B2Bi, workflow systems) there was a significant shortfall of collaborative interaction. In addition, these systems were complex and costly to implement; they were inflexible and non-adaptive; and they did not readily support inter-enterprise processes. Where the primary focus was on collaborative interaction (email exchanges, groupware, workspace) there was a significant shortfall process automation. In addition to not providing any real process support, these systems did not provide system architectures that allowed sharing of processes or even selective information across organizations. Further, these collaborative systems severely lacked architectural-level support for integration with transactional systems.

It would be advantageous to provide a system that overcomes the limitations and drawbacks of the prior art discussed above. What is needed are systems and methods that can provide a metaphor for integrating human and system interactions; support structured processes while enabling ad-hoc collaboration; marry rich multi-media content and integration to transactional systems; eliminate hub-centric portal-based systems; support true cross-enterprise collaboration with a flexible network of owners and participants. What is further needed are systems based on an architecture that provides both process automation and collaboration while at the same time addressing processes that are dynamic, ad hoc, unpredictable, long running, not well understood by the participants, and require exception processing.

### SUMMARY OF THE INVENTION

To overcome the shortcomings inherent in the prior art, embodiments of the present invention provide a system and method that enables both process automation and collaboration. The present invention overcomes the drawbacks of the prior art by providing a scaleable, flexible, and adaptable architecture that both allows the automating of ad hoc processes and facilitates collaboration.

According to some embodiments of the invention, a system for automating a process includes one or more process-containers that are mobile, self-contained, asynchronous, executable, visualizeable agents that include presentation information, logic, and data. Such a system also includes one or more peers that run on host networked devices such as personal computers in a local area network and are operable to display, transmit, interact with, and receive the process-containers. In addition, peers are operable to execute the logic of the process-containers and provide the process-containers access to data and applications also stored or running on the host. In some embodiments the process-containers move between the peers to execute the process described in the logic of the process-container. The process-container is operable to carry its data in the form of documents, including multi-media documents, as it moves between peers. In some embodiments the process-containers are presented to users via the peers to allow the users to access the process-container's data and interact with the process-container's logic. In some embodiments, the host computer executing a process-container docked in a peer need not be coupled to a network because the process-container is self-contained and does not rely resources that are not immediately available to it.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

FIG. 1 is a block diagram illustrating an example system according to some embodiments of the present invention.

FIG. 2 is a block diagram illustrating a second example system according to some embodiments of the present invention.

FIG. 3 is a block diagram illustrating an example of an enabled host client or server as depicted in FIGS. 1 and 2 according to some embodiments of the present invention.

FIG. 4 is a block diagram illustrating an example of an host server according to some embodiments of the present invention.

FIG. 5 is a block diagram illustrating an example of an unenabled client coupled to a host server according to some embodiments of the present invention.

FIG. 6 is a block diagram illustrating an example of an enabled client in communication with a host server according to some embodiments of the present invention.

FIG. 7 is a block diagram illustrating an example structure of a process-container engine for use in some embodiments of the present invention.

FIG. 8 is a block diagram illustrating an example structure of a support layer of an example process-container engine for use in some embodiments of the present invention.

FIG. 9 is a block diagram illustrating an example structure of a runtime layer of an example process-container engine for use in some embodiments of the present invention.

FIG. 10 is a block diagram illustrating an example structure of a process-container session subsystem within a runtime layer of an example process-container engine for use in some embodiments of the present invention.

FIG. 11 is a block diagram illustrating an example structure of a process-container message interface for use in some embodiments of the present invention.

FIG. 12 is a block diagram illustrating an example MIME form of a process-container for use in some embodiments of the present invention.

FIG. 13 is a block diagram illustrating an example structure of a process-container service interface for use in some embodiments of the present invention.

FIG. 14 is a block diagram illustrating an example structure of a verb protocol subsystem for use in some embodiments of the present invention.

FIG. 15 is a block diagram illustrating an example structure of core model interfaces within a core layer of an example process-container engine for use in some embodiments of the present invention.

FIG. 16 is a block diagram illustrating an example structure of a core subtype for use in some embodiments of the present invention.

FIG. 17 is a block diagram illustrating an example structure of DOM-Java mapping in a core model for use in some embodiments of the present invention.

FIG. 18 is a block diagram illustrating an example structure of a core model for use in some embodiments of the present invention.

FIG. 19 is a block diagram illustrating an example structure of a process-container within an example process-container engine for use in some embodiments of the present invention.

FIG. 20 is a state-diagram illustrating an example of process-container runtime lifecycle modes as used in some embodiments of the present invention.

FIG. 21 is a block diagram illustrating an example structure of a process-container binder for use in some embodiments of the present invention.

FIG. 22 is a block diagram illustrating an example structure of an execution layer of an example process-container engine for use in some embodiments of the present invention.

FIG. 23 is a block diagram illustrating an example structure of an execution layer executing a process-container in some embodiments of the present invention.

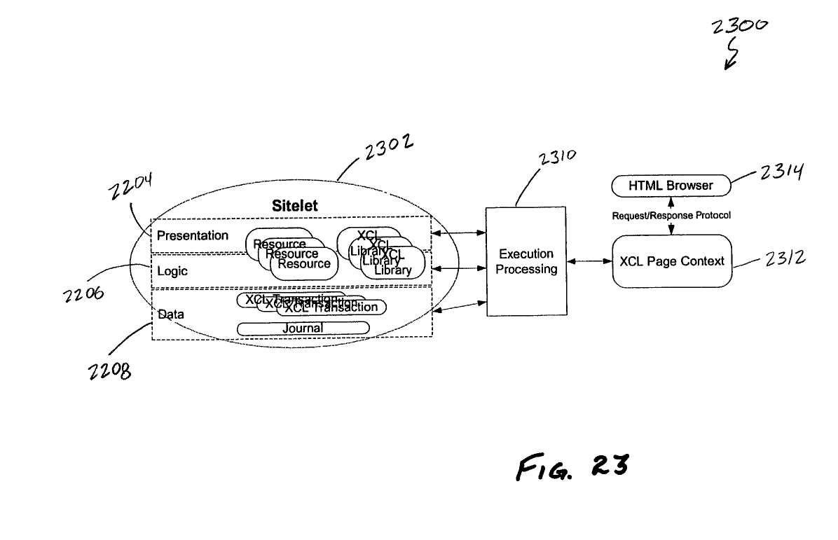

FIG. 24 is a block diagram illustrating an example structure of a component interface hierarchy for use in some embodiments of the present invention.

FIG. 25 is a block diagram illustrating an example structure of a component subtypes interface hierarchy for use in some embodiments of the present invention.

FIG. 26 is a block diagram illustrating an example structure of a page context for use in some embodiments of the present invention.

FIG. 27 is a state-diagram illustrating an example of page context lifecycle modes as used in some embodiments of the present invention.

FIG. 28 is a block diagram illustrating an example structure of a page protocol for use in some embodiments of the present invention.

FIG. 29 is a block diagram illustrating an example structure of a page initialization process for use in some embodiments of the present invention.

FIG. 30 is a block diagram illustrating an example structure of a scheduler for use in some embodiments of the present invention.

FIG. 31 is a block diagram illustrating an example structure of an annotation execution for use in some embodiments of the present invention.

FIG. 32 is a block diagram illustrating an example structure of a browser model for use in some embodiments of the present invention.

FIG. 33 is a block diagram illustrating an example structure of a page building process for use in some embodiments of the present invention.

FIG. 34 is a block diagram illustrating an example structure of an event flow process for use in some embodiments of the present invention.

FIG. 35 is a scope diagram illustrating an example structure of static scope for use in some embodiments of the present invention.

FIG. 36 is a scope diagram illustrating an example structure of dynamic scope for use in some embodiments of the present invention.

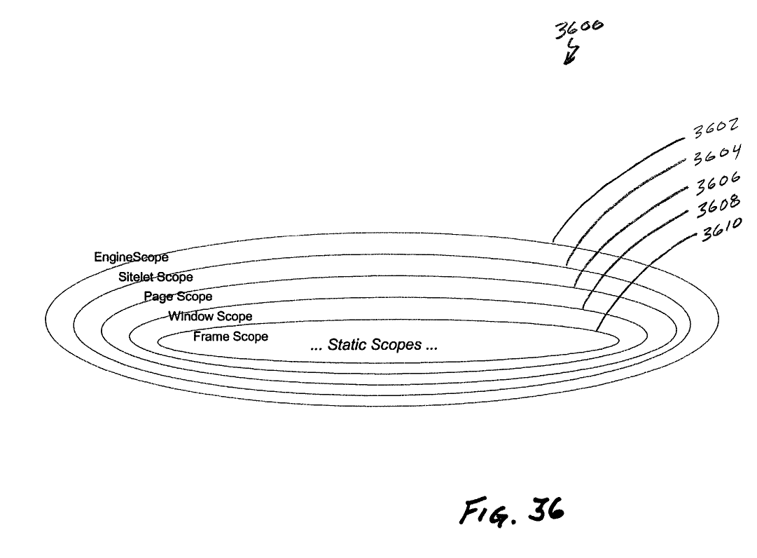

FIG. 37 is a block diagram illustrating an example structure of a source to sink event flow for use in some embodiments of the present invention.

FIG. 38 is a block diagram illustrating an example structure of a scope level broadcast for use in some embodiments of the present invention.

FIG. 39 is a block diagram illustrating an example structure of an event encapsulation for use in some embodiments of the present invention.

FIG. 40 is a block diagram illustrating an example structure using publish and subscribe parameters to cross scope boundaries for use in some embodiments of the present invention.

FIG. 41 is a block diagram illustrating an example structure using publish and subscribe parameters to publish articles for use in some embodiments of the present invention.

FIG. 42 is a block diagram illustrating an example structure of variable scoping for use in some embodiments of the present invention.

FIG. 43 is a block diagram illustrating an example structure of a XCL transform for use in some embodiments of the present invention.

FIG. 44 is a block diagram illustrating an example structure of a XCL collection for use in some embodiments of the present invention.

FIG. 45 is a block diagram illustrating an example structure of an extensions architecture for use in some embodiments of the present invention.

FIG. 46 is a block diagram illustrating an example structure of a processing model for use in some embodiments of the present invention.

FIG. 47 is a block diagram illustrating an example structure to support execution and back-end processing of Process-containers in some embodiments of the present invention.

### DETAILED DESCRIPTION OF THE INVENTION

Applicants have recognized that a need exists for systems and methods that provide both process automation and collaboration. The present invention provides a novel approach to engineering software automation and collaboration solutions. This approach is based upon a novel set of design principles that were derived via an analysis of the salient tenets of automation. Some of these tenets include the idea that language and its use provide a preferred model for automation and the idea that good automation preferably maximizes both of the sometimes contradictory elements of freedom and control in the use of software.

Language, both spoken and written, in the way it efficiently and naturally facilitates and thus, automates communication, provides an example of how highly optimal forms of automation may be implemented by providing systems that are adapted to and consistent with the way people naturally do things. In terms of computer software applications, email may be thought of a system for automating conversation and the word processor may be thought of as a system for automating written language. The fact that email and word processors are by far the most used software applications validates the idea that automation implemented using software should enable the natural behaviors of people by aligning itself with the characteristics of language.

Maximizing both freedom and control in a software application can be difficult because asserting strong controls may overly restrict users' freedom while allowing too much freedom may interfere with mechanisms for maintaining control. Freedom allows users, for example, to perform the functions provided by the software in a manner that makes sense to them and allows them to be creative or have their specific needs met. Control allows users to be confident that software functions are performed, for example, without corrupting data, according to a defined schedule, or in a secure environment. Optimizing the balance between freedom and control so as to maximize both is clearly the preferred compromise that most nearly matches the natural tendencies of most users.

If the tenets of automation discussed above are accepted and one looks objectively at how “state of the art” automation relates or fails to relate to these tenants, a number of software design principles can be derived. These principles include the ideas that (1) conventional database transactions are oriented to system transactions and not toward people interactions; (2) enhancements not perceptible at the user interface do not compel adoption; (3) as humanity is preferably and naturally decentralized so should application platforms be; (4) applications that cause users to perform operations solely to accommodate the application instead of tasks directly related to completing substantive objectives fail to relate to how people naturally to things; and (5) object oriented application development principles remain relevant and are applicable to Internet applications.

Database transactions are for systems not for people. The first design principle is that database transactions are not part of the way that people work. However, looking at most of the presently commercially available applications, one would think people enjoy data entry and formulating queries. Transactions were designed to assist the database in providing a simple model for concurrency and robustness. However, this simple model imposes some onerous burdens on users: (1) users are forced to complete their work in one session; (2) users are unable to make intermediate results of their work visible to others; and (3) the system is unable to make intermediate results available for external processing. These restrictions on user freedom have the consequences that, among other things, long running tasks are not suitable to such systems; users are not able to collaborate without “committing” to the global state of the database; and opportunities for concurrent processing are squandered.

The “desktop,” a metaphorical computer interface that naturally allows users to interact with multiple applications and/or instances of applications in the same way people use multiple books, papers, charts, and images on the working surface of an actual desk, is the dominant interface for the majority of modern computer operating systems. From the perspective of creating an application that is compelling to users, the preferred area to add value is precisely where the user will experience the value add. Thus, application platforms that do not add value at that level, will have great difficulty truly captivating users.

Centralization restricts scalability, creates bottlenecks, and does not allow use of distributed processing power. The Web was not intended to centralize, but to decentralize. An application platform that supports only centralized processes will have great difficulty scaling to the size of the Web, nor will it fit the temperament of the WEB.

Applications should not own users, users should own the applications. A good application platform should assist the user in building applications that suit the user, not the application. Users should be given the control to automate applications when and how they best serve the processes that people actually undertake. Processes are not in any one application, they span multiple applications.

Objects and object-oriented design can be applied to and add value to XML, HTML, and other Web languages. The same concepts of problem subdivision and reusability are even more applicable in modern WEB applications.

A. Definitions

Throughout the description that follows and unless otherwise defined, the following terms will refer to the meanings provided in this section. These terms are provided to clarify the language selected to describe the embodiments of the invention both in the specification and in the appended claims. Many additional terms are defined throughout the specification.

The term “document” shall refer to any form of electronic data such as, for example, a database, spreadsheet, illustration, text file, movie, photograph, or audio recording that contains information.

The term “Process-container” shall refer to a mobile, self-contained, asynchronous, executable, visualizeable agent that has advanced presentation, logic, and data layers that may be embodied using extensible mark-up language (XML), Web, and Java® standards. Note that in the Provisional Application from which the present application claims priority, a Process-container was referred to as a “Sitelet™.”

The term “client device” shall refer to a computing device operating generally under user control. Client devices will typically be personal computers but may include may other networkable and/or wireless devices.

The term “server device” shall refer to a computing device operating generally under program control. Server devices will typically be server computers running one or more enterprise applications including database management systems. Server devices may also include may other networkable and/or wireless devices.

The term “input device” shall refer to a device that is used to receive an input. An input device may communicate with or be part of another device (e.g. a personal computer, a personal digital assistant, an end-user device, a server device). Possible input devices include: a bar-code scanner, a magnetic stripe reader, a computer keyboard, a point-of-sale terminal keypad, a touch screen, a microphone, an infrared sensor, a sonar-based distance measurement device, a computer port, a video camera, a digital camera, a GPS receiver, a radio frequency identification (RFID) receiver, a RF receiver, a thermometer, and a weight sensor.

The term “output device” shall refer to a device that is used to output information. An output device may communicate with or be part of another device (e.g. a personal computer, a personal digital assistant, an end-user device, a server device). Possible output devices include: a cathode ray tube (CRT) monitor, liquid crystal display (LCD) screen, light emitting diode (LED) screen, a printer, an audio speaker, an infra-red transmitter, and a radio transmitter.

B. System

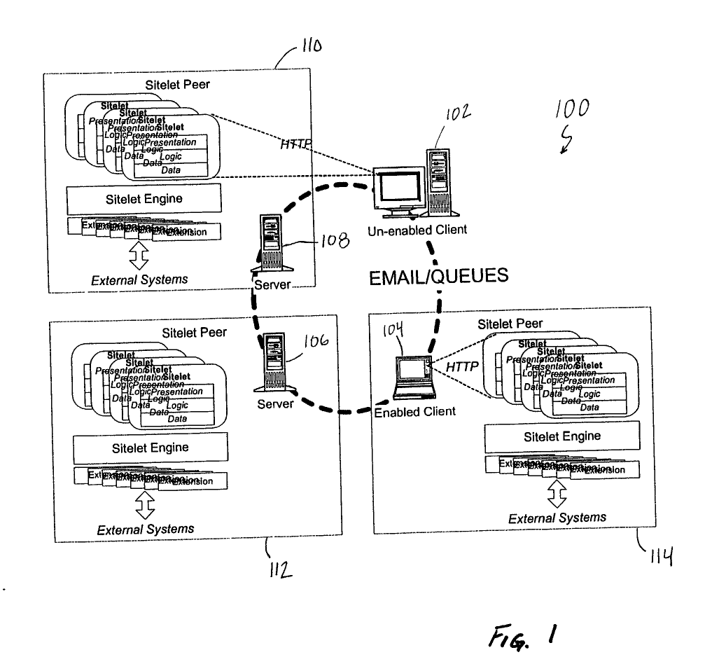

Referring now to FIG. 1, a system 100 according to some embodiments of the present invention includes one or more server devices 106,108 that are in one or two-way communication with each other and/or one or more of each of a plurality of client devices 102, 104. Communication between the server devices 106, 108 and the client devices 102,104 may be direct and/or via a network such as the Internet.

Each of the server devices 106,108 and the client devices 102, 104 may comprise computers, such as those based on the Intel® Pentium® processor, that are adapted to communicate with each other. Any number of server devices 106, 108 and client devices 102, 104 may be in communication with each other. The server devices 106,108 and the client devices 102, 104 may each be physically proximate to each other or geographically remote from each other. These devices may each include input devices and output devices.

As indicated above, communication between the server devices 106,108 and the client devices 102,104 may be direct or indirect, such as over an Internet Protocol (IP) network such as the Internet, an intranet, or an extranet running on one or more remote servers or over an on-line data network including commercial on-line service providers, bulletin board systems, routers, gateways, and the like. In yet other embodiments, the devices may communicate over local area networks including Ethernet, Token Ring, and the like, radio frequency communications, infrared communications, microwave communications, cable television systems, satellite links, Wide Area Networks (WAN), Asynchronous Transfer Mode (ATM) networks, Public Switched Telephone Network (PSTN), other wireless networks, and the like.

Those skilled in the art will understand that devices in communication with each other need not be continually transmitting to each other. On the contrary, such devices need only transmit to each other as necessary, and may actually refrain from exchanging data most of the time. For example, a device in communication with another device via the Internet may not transmit data to the other device for weeks at a time. Additionally, devices 102,104,106, 108 may disconnect from each other and the network and then later reconnect.

The server devices 106, 108 and the client devices 102,104 may function as “web servers” that generate web pages which are documents stored on Internet-connected computers accessible via the World Wide Web using protocols such as, e.g., the hyper-text transfer protocol (“HTTP”). Such documents typically include a hyper-text markup language (“HTML”) file, associated graphics, and script files. A web server may allow communication with the server devices 106, 108 and the client devices 102,104 in a manner known in the art. The server devices 106, 108 and the client devices 102, 104 may use a web browser, such as NAVIGATOR® published by NETSCAPE® for accessing HTML forms generated or maintained by or on behalf of the server devices 106,108 and the client devices 102,104.

As indicated above, any or all of the server devices 106,108 and the client devices 102, 104 may include, e.g., processor based cash registers, telephones, interactive voice response (IVR) systems such as the ML400-IVR designed by MISSING LINK INTERACTIVE VOICE RESPONSE SYSTEMS, cellular phones, vending machines, pagers, personal computers, portable types of computers, such as a laptop computer, a wearable computer, a palm-top computer, a hand-held computer, and/or a Personal Digital Assistant (“PDA”).

In some embodiments of the invention the server devices 106, 108 may be operated under the control of one or more users. Further, in some embodiments, the client devices 102, 104 may operate automatically, under program control, and/or independent of users. Although not pictured, the server devices 106, 108 and the client devices 102, 104 may also be in communication with one or more institutions to effect transactions and may do so directly or via a secure network such as the Fedwire network maintained by the United States Federal Reserve System, the Automated Clearing House (“ACH”) Network, the Clearing House Interbank Payments System (“CHIPS”), or the like. C. DEVICES

The devices 102, 104, 106, 108 are operative to manage the system and execute various methods via the execution of the software of the present invention. The devices may be implemented as one or more system controllers, one or more dedicated hardware circuits, one or more appropriately programmed general purpose computers, or any other similar electronic, mechanical, electromechanical, and/or human operated device.

The devices comprise a processor, such as one or more Intel® Pentium® processors. The processor may include or be coupled to one or more clocks, which may be useful for journaling and determining information relating to synchronization, and one or more communication ports through which the processor communicates with other devices. The processor is also in communication with a data storage device. The data storage device includes an appropriate combination of magnetic, optical and/or semiconductor memory, and may include, for example, additional processors, communication ports, Random Access Memory (“RAM”), Read-Only Memory (“ROM”), a compact disc and/or a hard disk. The processor and the storage device may each be, for example: (i) located entirely within a single computer or other computing device; or (ii) connected to each other by a remote communication medium, such as a serial port cable, telephone line, radio frequency transceiver, or the like. In some embodiments for example, the devices may comprise one or more computers (or processors) that are connected to a remote server computer operative to execute programs and store data, where the data storage device is comprised of the combination of the remote server computer and the stored information.

The data storage device stores a program, also referred to herein as a Peer 700, for controlling the processor of a device 102, 104, 106, 108. The processor performs instructions of the program, and thereby operates in accordance with the present invention, and particularly in accordance with the structures and methods described in detail herein. The present invention can be embodied as a computer program developed using an object oriented language that allows the modeling of complex systems with modular objects to create abstractions that are representative of real-world, physical objects and their interrelationships. However, it would be understood by one of ordinary skill in the art that the invention as described herein can be implemented in many different ways using a wide range of programming techniques as well as general purpose hardware systems or dedicated controllers. The program may be stored in a compressed, uncompiled and/or encrypted format. The program furthermore may include program elements that may be generally useful, such as an operating system, a database management system and “device drivers” for allowing the processor to interface with computer peripheral devices. Appropriate general purpose program elements are known to those skilled in the art, and need not be described in detail herein. Further, the program is operative to execute a number of invention-specific modules or subroutines including but not limited to one or more routines to perform object mapping, one or more routines to provide persistence, one or more routines to journaling, one or more routines to provide querying, one or more routines to provide schema validation, one or more routines for compounding documents, and one or more routines for synchronizing documents. These routines are described in detail below in conjunction with the drawings.

According to some embodiments of the present invention, the instructions of the program may be read into a main memory of the processor from another computer-readable medium, such from a ROM to a RAM. Execution of sequences of the instructions in the program causes processor to perform the process steps described herein. In alternative embodiments, hard-wired circuitry or integrated circuits may be used in place of, or in combination with, software instructions for implementation of the processes of the present invention. Thus, embodiments of the present invention are not limited to any specific combination of hardware, firmware, and/or software.

In addition to the program, the storage device is also operative to store Process-containers. The Process-containers are described in detail below and example structures are depicted with sample entries in the accompanying figures. As will be understood by those skilled in the art, the schematic illustrations and accompanying descriptions of the sample Process-containers presented herein are exemplary arrangements for stored representations of information and logic. As with the program, any number of other arrangements may be employed besides those suggested by the images shown. For example, even though a particular number of Process-container components are illustrated in a given drawing, the invention could be practiced effectively using any number of functionally equivalent components. Similarly, the illustrated layers of the program represent exemplary information only; those skilled in the art will understand that the number and content of the layers can be different from those illustrated herein.

D. Program

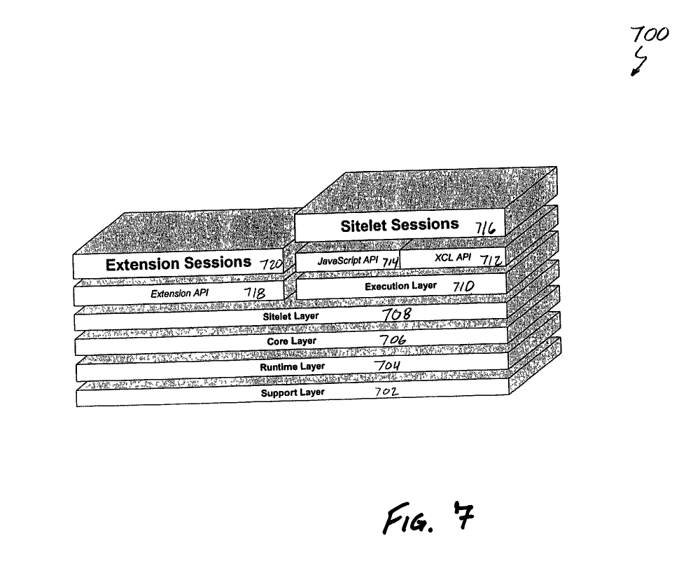

As indicated above, it should be noted that although the example embodiment of FIG. 7 is illustrated to include a particular number of layers, other arrangements may be used which would still be in keeping with the spirit and scope of the present invention. In other words, the present invention could be implemented using any number of different layers or structures, as opposed to the ones depicted in FIG. 7. Further the individual layers could be stored on different servers (e.g. located on different storage devices in different geographic locations). Likewise, the Process-containers could also be located remotely from the client device 102 and/or on another server device 108. As indicated above, the program includes instructions for retrieving, manipulating, and storing data in the Process-containers as necessary to perform transactions according to various methods of the invention as described below.

1. Process-Container Overview

As defined above, the Process-container is a mobile, self-contained, asynchronous, executable, visualizeable agent that has advanced presentation, logic, and data layers that may be embodied using XML-Web-Java standards. Each Process-container instance represents a individualized ‘macro’ application that supports the implementation of sophisticated peer-to-peer process application architectures. Process-containers provide a portable mini-web-site that captures the best of web sites, database applications, email, and documents.

Process-containers are ‘self-contained’. This means that the Process-container is in important ways oblivious to physical location and may operate on any client or server without dependence on network connections, as long as content references are limited to those that may be satisfied by its own cached internal world of content. This ‘caching’ mechanism gives the Process-containers the following characteristics: tolerance of unreliable, nonexistent, and/or low bandwidth connections; ability to scale via leveraging client processing power and reduced client-server network traffic; ability to disperse processing to support fault tolerance and load balancing; and a high degree of data-coherency that supports linear performance gains when used in multi-processor execution platforms.

Process-containers and the data that they represents are asynchronous with respect to, for example, the lifecycle of the databases from which they originated. This implies that Process-container resources do not need to be synchronized but if any immediate or eventual synchronization with the original data is desired this may happen through asynchronous protocols such as optimistic concurrency or checkin/checkout.

The Process-Container Peer

The Process-containers flow, via, for example, email and other protocols, between instances of Process-container Peer. These Peers which may play the role of a Server or of a Client, may include a set of Process-container instances, a Process-container Engine, and a set of Java servlet plugins based on a proprietary Extension API. If the Peer is on the client, then this Peer will usually be embedded into an application such as Microsoft Outlook for example.

Process-Container Presentation

The presentation part of a Process-container may be rendered in a standard HTML environment. The author of a Process-container may use HTML, Javascript, CSS, and other MIME resources in any combination desired to create an appropriate highly adaptive visualization of the Process-container content.

Process-Container Logic

The logic part of a Process-container may be executed in the Process-container Engine to drive manipulation of presentation and data layers. This may be authored using a combination of the XCL API and/or JavaScript API.

Process-Container Data

The data part of a Process-container may include a combination of instances of the MIME Process-container Resource and/or the XML Process-container Transaction.

Process-Container Journal

All manipulations of the Process-container either from executing the Process-container or via and Extensions, may be Journaled. This ‘logging’ behavior is used to support many important low and high level features in the Process-container platform.

2. The Process-Container System

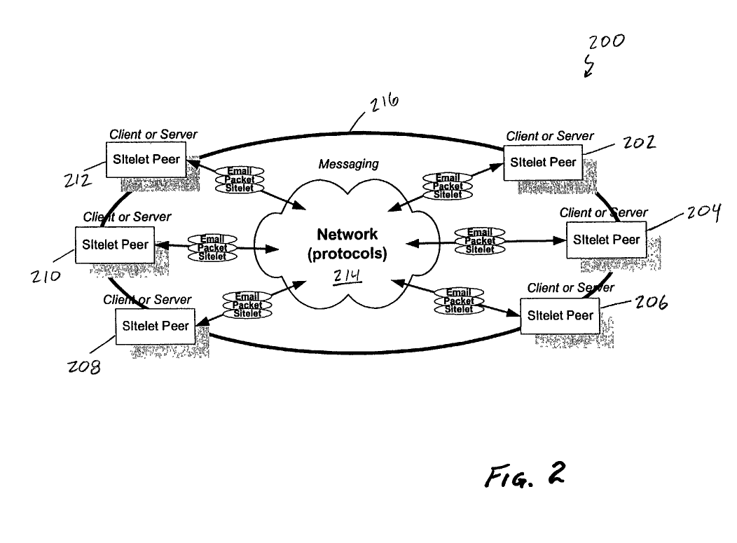

Turing to FIG. 2, the Process-container System has an uniquely flexible distributed system architecture based to a large degree on the mobile, self-contained, asynchronous properties of Process-containers. The Process-container System environment is a peer-to-peer architecture where Process-containers are hosted and executed on instances of a Process-container Engine which may be configured to play the role of a Process-container Server or a Process-container Client. The Process-containers may move freely from Server to Client, Client to Server, Server to Server, and Client to Client. The engine architecture may be identical whether it is acting as a client or a server. This fundamental symmetry provides for great flexibility when setting up Process-container distribution architectures.

The peer-to-peer architecture described above is based on the concept that Process-containers are self-contained and may be moved around using asynchronous protocols. These asynchronous protocols mean that one may build scaleable and robust applications.

A notable feature of the peer-to-peer architecture of the present invention is the use of messaging. This asynchronous model of sending packets of information with deferred return of status or data, is enabling infrastructure. The peer-to-peer model of the present invention is built on top of Sun Microsystems Java J2EE messaging technology so that peers may communicate with peers through robust scaleable streams of information that may be implemented on top of any store and forward messaging product including the very important and ubiquitous EMail server infrastructure.

Process-Container Peer

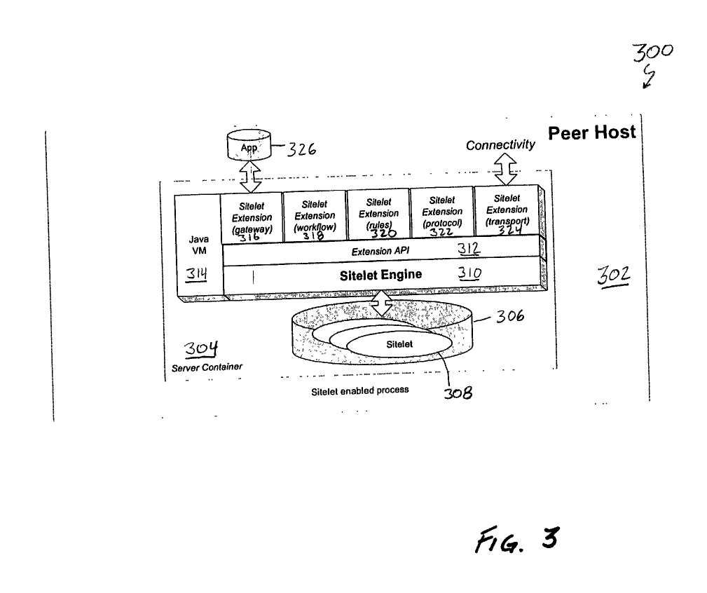

Turning, to FIG. 3, a Process-container Peer is defined to be a Process-container-enabled process running on a suitable Peer Host. This process preferably includes a suitable Java Virtual Machine (Java VM) along with a serviceable Java Servlet Container. Situated in this Servlet-container, and running in the Java VM, is a Process-container Engine, that provides basic Process-container creation, destruction, execution, manipulation, and persistent storage, along with a standard Java-based plug-in functionality extension backbone called the Extension API. This Peer may function as either a Server or a Client depending on its desired usage and configuration of Extensions.

Servlet Container

The Servlet container may be any J2EE servlet specification compliant server infrastructure. This may be used to support the startup and shutdown of the Process-container Engine and to manage HTTP requests.

Extensions

The Extensions installed into a Process-container Engine provides a Java based extension capability to enable more complex processing, protocols, and connectivity. Extensions may be implemented as servlets with a special set of capabilities as defined in the Extension API.

Process-Container Server

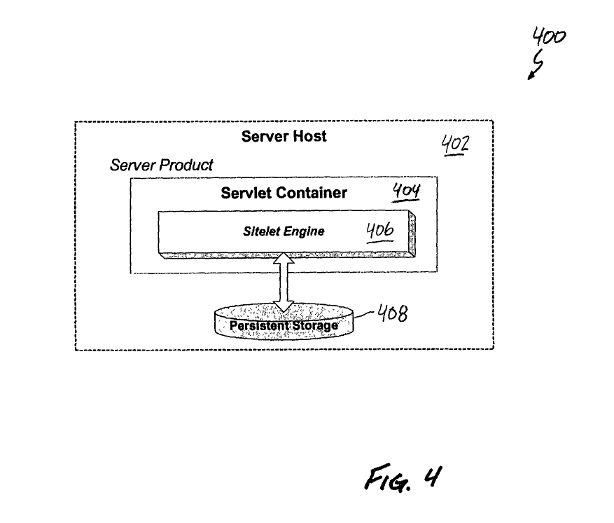

Turning to FIG. 4, the Process-container Server may be implemented as a Process-container Engines placed into one's choice of Servlet Conformant web and application servers. The Process-container Server strategy is to not necessarily build, but to enable, server side infrastructure.

Process-Container Client

The Process-container clients may be embodied in two distinct forms: the unenabled and the enabled client.

Unenabled Clients

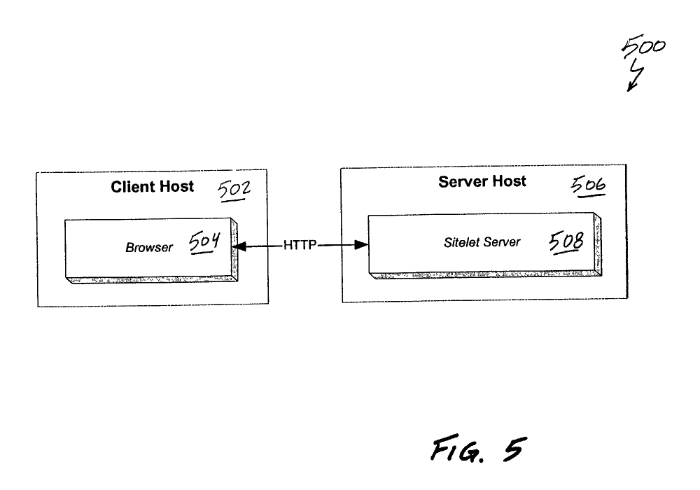

Turning to FIG. 5, the unenabled client may be implemented as a simple thin-client wherein the client only requires a browser or other visualization tool. This browser may connect to a Process-container Engine on another host using standard HTTP protocols.

Enabled Clients

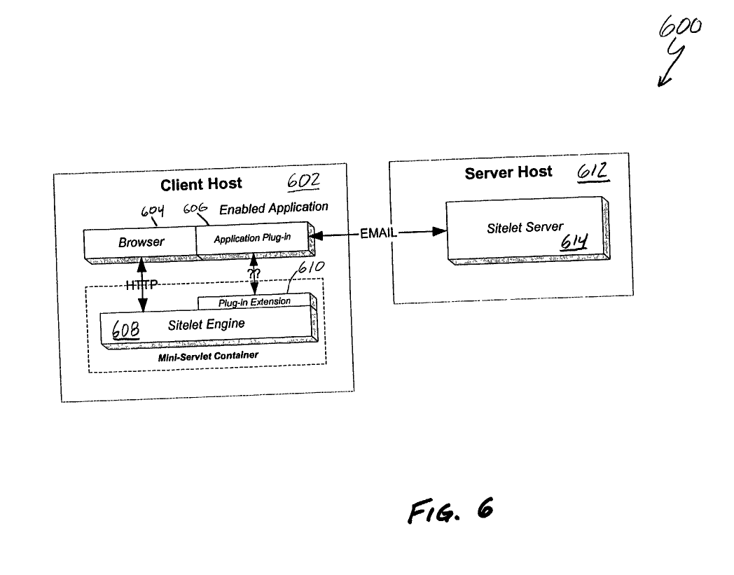

Turning to FIG. 6, an Enabled client is a peer-style client that has almost all of the capabilities of an individual Process-container Server to add to a Process-container Client application environment.

Servlet Container

The Process-container Environment includes the concept of a low-footprint ‘Servlet Container’ that has just enough functionality to support the lifecycle of multiple Servlets with basic HTTP protocol support and just enough functionality to support a Process-container enabled Client. This the single-user client version of the server side multi-user Servlet Container.

Server as Client

Strictly speaking, this Servlet container is only necessary for applications that do not have one already, however this includes most applications except for the case of a WEB server acting as a client. In general this scenario falls under the category of a server (peer) talking to another server (peer) and is not covered in this chapter.

Types of Enabled Clients

There are various types of enabled client scenarios that may be supported. These may include Email Agents, Beans compatible Applications, ActiveX control compatible applications, and DLL applications. Since the Process-container is very naturally treated as an email, it is a natural to use in an email application such as Microsoft® Outlook® or Lotus® Notes®. The Process-container Environment may also support the concept of Process-container embodiment in the form of a Java® Bean®, an ActiveX® control, and a Windows® Win32 dll.

Process-Container Enabled Clients

The overall client architecture for process-container-enabled applications is based on a low footprint version of the Process-container Engine combined with a Process-container ‘enabler’ component interacting with the application's Presentation, Logic, and Data layers and connecting its semantics to the semantics of the Engine.

Client Versus Peer Role

This discussion focuses largely on the problem of single-user GUI based applications, but may be extended in many aspects to the more general problem of a peer-to-peer architecture where the concept of a client and a server are more accurately thought of as roles played in a given interaction, and not as limitations of capabilities.

Process-Container Engine

Turning to FIG. 7, the Engine Java Object is the heart of the Process-container Java run-time environment. It is responsible for choreographing the run-time lifecycle of Process-containers in all its aspects. It is used to ‘process-container-enable’ any ‘servlet-enabled’ application or web server. The Engine contains the following components:

The Architectural Layers

The layers within the engine architecture may include a Support Layer, a Runtime Layer, a Core Layer, a Process-container Layer, and a Execution Layer. In addition, the architecture may further include application programming interfaces (APIS) such as an Extension API, a Javascript API, and a XCL API.

3. The Support Layer

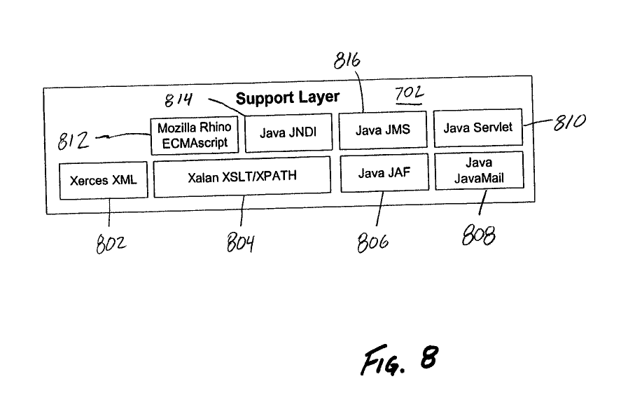

Turning to FIG. 8, the Support Layer is a set of third party Java packages that are integrated with the Process-container Engine so as to support both internal Engine functionality and Process-container Extensions developed using the Extension API. This means that the APIs that are specified at the Support layer are available to all Engine code and Extension code. It is also permissible to reference these types directly in the Extension API.

The Support layer preferably provides compatibility between the Process-container Client and Process-container Server environments. This means that as much as possible, the packages provided at in the support layer are guaranteed to be available in both environments. However the exact capabilities of each package, based on local drivers/providers available, may vary.

The Server side may run in a commercial J2EE environment running on a version 1.2 compatible Java VM. Many clients however, run on a Microsoft 1.1.6 VM and likely would have difficulty supporting the heavy footprint of a full J2EE environment. The present invention solves this situation by providing a different Extension environment on the client that provides minimal JMS/JNDI functionality.

As in the particular example embodiment described herein, the Support Layer may include the following support packages: ECMAScript, Xerces DOM/XML, Xalan XSLT/XPATH, Java JNDI, Java JMS, Java JAF, Java JavaMail, and Java Servlet.

The Support Layer provides a JavaScript interpreter package that conforms to ECMA-262, revision 3 created by the ECMA Technical Committee TC39. This is to support the Execution Layer in its support of the Javascript API. For example, the Rhino 1.5 package described at:http://www.mozilla.org may be used.

The Support Layer provides a W3 compliant XML parser. For example, the Apache Xerces package available at: http://xml.apache.org/ can be used. This supports the following XML standards: Document Object Model (DOM) Level 2 Specification Version 1.0 W3C Candidate Recommendation May, 10, 2000; Extensible Markup Language (XML) 1.0 W3C Recommendation Feb. 10, 1998; SAX, the Simple API for XML which is a standard interface for event-based XML parsing that was developed collaboratively by the members of the XML-DEV mailing list hosted by OASIS; XML Schema Part 1: Structures W3C Working Draft Apr. 7, 2000; and XML Schema Part 2: Datatypes W3C Working Draft Apr. 7, 2000.

The Support Layer may provide a W3 compliant XSLT/XPATH processor. For example, the Apache Xalan package available at: http://xml.apache.org/ may be used. This package supports the following XML standards: XSL Transformations (XSLT) Version 1.0 W3C Recommendation Nov. 16, 1999 and XML Path Language (XPath) Version 1.0 W3C Recommendation Nov. 16, 1999.

The Support Layer may also provide a Java J2EE compliant Servlet package, a Java J2EE compliant JNDI package, a Java J2EE compliant JMS package, a Java J2EE Release JavaMail release 1.1.3 package, and a Java J2EE compliant JAF package.

4. The Runtime Layer

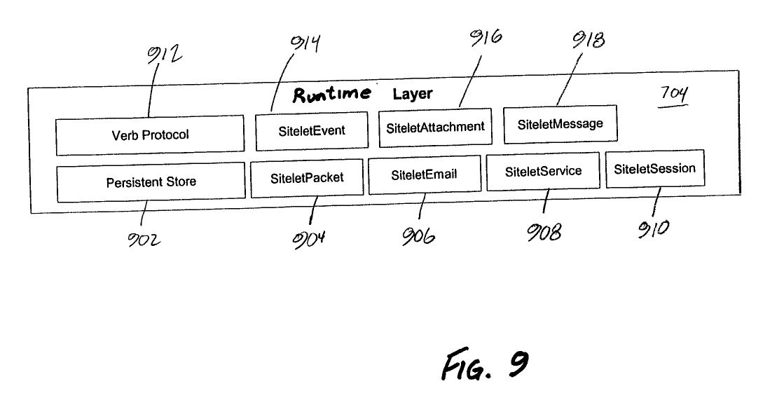

Turning to FIG. 9, the run-time layer is a set of Java interfaces and implementations that support general run-time characteristics of the Process-container Engine. This layer depends on the Support Layer below it and provides capabilities to the Core Layer and above. This layer may include the following Java subsystems and interfaces: Persistent Store Subsystem; Process-container Session Subsystem; Verb Protocol Subsystem; Process-container Event Interface; Process-container Attachment Interface; Process-container Packet Interface; Process-container Email Interface; Process-container Message Interface; and Process-container Service Interface.

Persistent Store Subsystem

While this capability exists at the Run-time layer, is it addressed in the Process-container Store.

Process-Container Session Subsystem

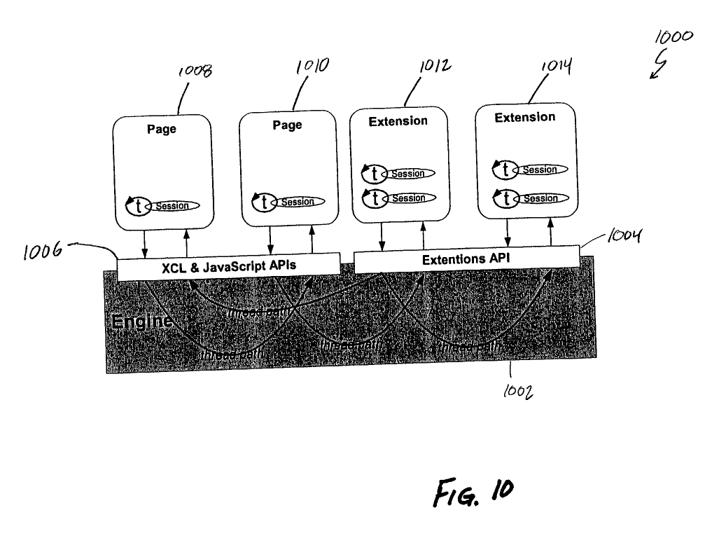

Turning to FIG. 10, the Process-container Session subsystem within the run-time layer, is responsible for managing issues of flow of control, authentication, transactions, and resource management.

Flow of Control

Within the Process-container Engine all threads doing useful work preferably have a Process-containerSession associated with them.

Authentication

When the Session is created, an authentication context is preferably built.

Resource Management

Sessions include the concept of owning various resources within the Process-container Engine.

Transactions Sessions will align with Java JTA transactions models for use when accessing EJB, JDBC, JMS and other J2EE resource managers.

Process-Container Event Interface

Process-container Message Interface

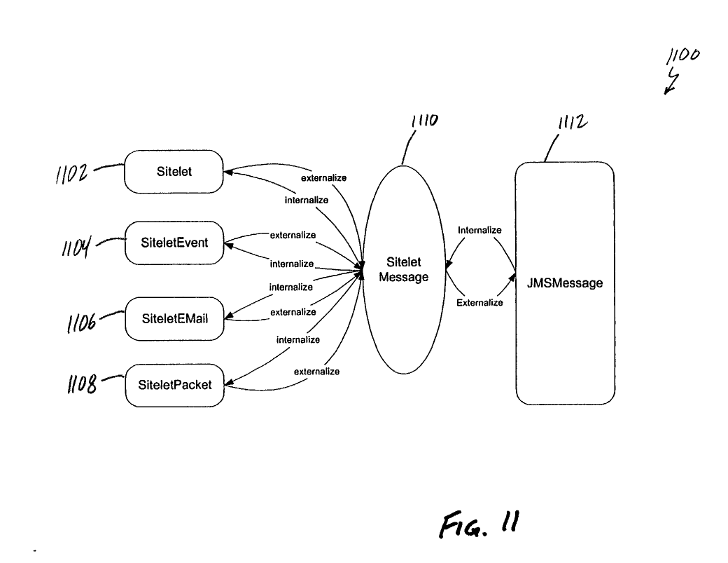

Turning to FIG. 11, the Process-containerMessage is the mechanism whereby various Process-container objects are externalized for movement in JMS queues. This is to support interactions between Extensions and executing Process-containers.

MIME Form

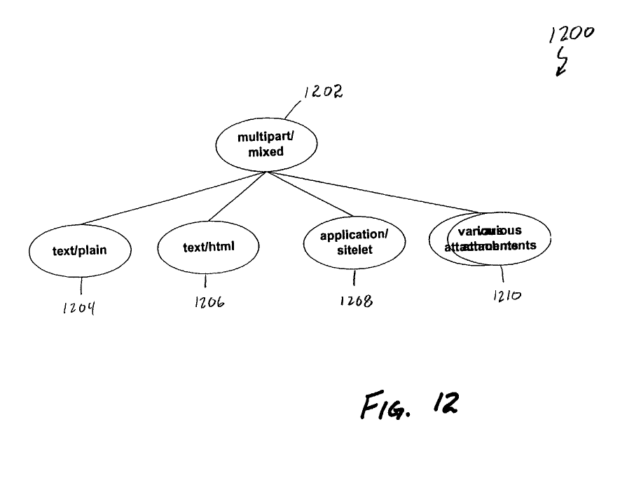

Illustrated in FIG. 12, the MIME form of the Process-container is where the previously described Email object from the Document form is extracted to create standard EMAIL parameter header, and an associated MIME structure (tree). The previous document form is then inserted into the MIME structure as a MIME attachment. This MIME form is appropriate for transport over normal email protocols (SMTP, MAPI, MAPI, POP).

A Process-container Attachment Interface, a Process-container Packet Interface, and a Process-container Email Interface may also be provided.

Process-Container Service Interface

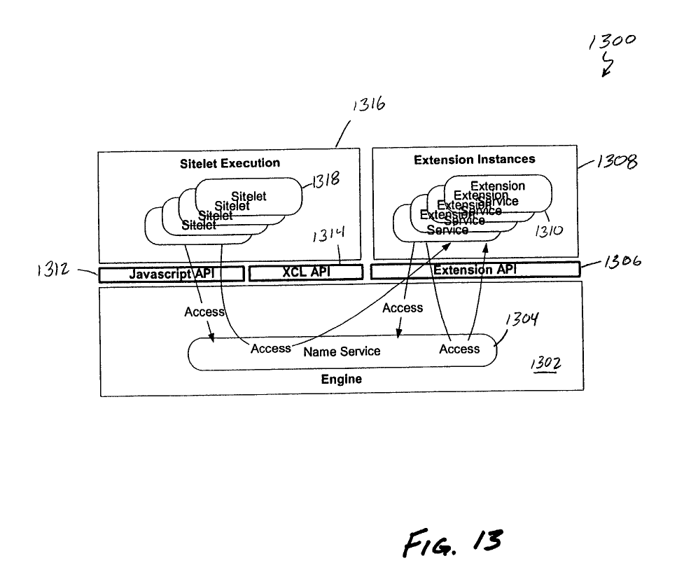

Turning to FIG. 13, Services within the Process-container engine are now discussed. Service Interfaces may be accessed from Java Extensions via JNDI and/or XCL JavaScript Rules via special script bindings.

Service Interfaces may be implemented using Java objects in the Engine and/or Java objects in Extensions. Services provide a uniform way to support and control accesses between various parts of the Engine run-time environment.

Lifecycle

Services have special startup and shutdown semantics. They are assumed to place themselves into the JNDI name space and register themselves with the Engine.

Authentication

Services support the concept of session and authentication. Any thread entering through a Service interface boundary will preferably be attached to a Process-container Session Subsystem implementation appropriate for validating and controlling access to resources within the service.

Script Bindings

Services may be accessed from XCL Rules via through the Process-container Javascript API. The Service when it is registered with the Engine, tells the Execution Layer logic to make the interface available to running JavaScript.

Client Side Services

Since many Services will be implemented using Extensions, it is important to consider that Javascript that relies too heavily on Services may be placing undue requirements on the ubiquity of a particular Service Extension it has become dependant on.

Verb Protocol Subsystem

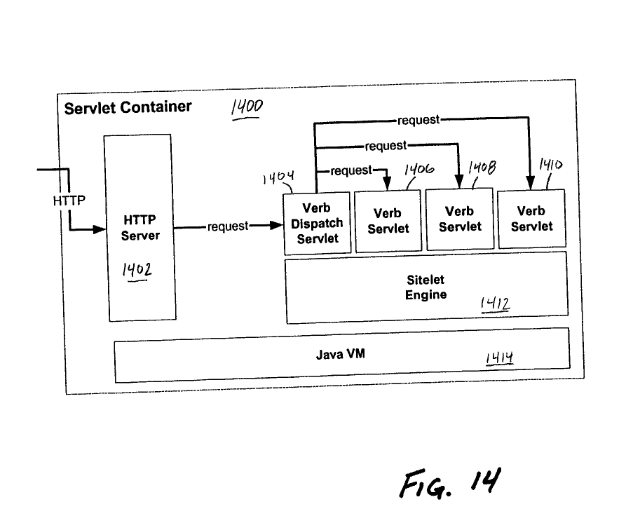

Turning to FIG. 14, the Engine may always be hosted in a Servlet container this is either a Web Server that is capable of hosting Servlets as in the Process-container Server, or a low footprint Servlet Container of the present invention as in the Process-container Client. This Servlet container provides the most basic of run-time environments: a startup and shutdown within a Java VM, and a HTTP server protocol implementation.

Verb Protocol

The Servlet container is configured to start up the ‘Verb Dispatch Servlet’. This single Servlet starts up the Engine in the local Java VM and also starts up a set of hard-wired ‘Verb Servlets’. Each of these verb servlets registers a particular ‘verb’ associated with the some HTTP request type. This allows the engine to create URIs of the form: http://some.host.com/some/process-container/servle/path/verb?<parameters>These URIs are used to establish what is called the ‘verb-protocol’ or set of verbs with specific parameters that the engine is guaranteed to respond to as HTTP requests. One verb type is the .

5. The Core Layer

The Core Layer is a Java class library that builds on top of DOM level 2 functionality to create a Java XML Object based environment. It supports the semantics of the Process-container Layer, and builds on top of the semantics of the Runtime Layer.

Core Layer Capabilities

The Core layer includes the following capabilities:

Java Object Mapping

Within the Core Layer, once an XML document is parsed into a special Core Layer Java object with the IslDocument interface, all elements within it may be accessed as special Java objects.

Persistence

Since all Java Objects built using the Core Layer are backed by a DOM tree, they may be externalized in the same way that XML may be externalized.

Journaling

The Core Model has special hooks to support the concept of a Process-container Journal. This is done through supporting the appropriate event structure to provide hooks for any changes to underlying Core objects.

XPATH queries

The Core Model using the Xalan XSLT/XPATH package, supports unlimited queries on the Core Model. Queries return Core Model objects.

Schema Validation

The Core Model supports schema validation as supported in the Xerces DOM/XML package.

Compound Documents

The Core Model supports the manipulation of documents that may inserted into, and withdrawn from, other documents.

Core Model Level Synchronization

The Core Model's synchronization model is that all documents and their contained objects are un-shared. This means that the Core Model assumes, but does not enforce that there is only one Process-container Session Subsystem Session ‘owning’ a document at a time. All interactions with that document including manipulation of its subordinate objects do not have to be synchronized once that document is owned. This document level granularity melds well with Support Layer support systems concurrency semantics. This is, however, a huge assumption in that if it ever becomes necessary to support lots of concurrent access to a given document, that this would become a concurrency hot-spot and its coarse grainedness while simple and robust may not scale appropriately.

Core Model Interfaces

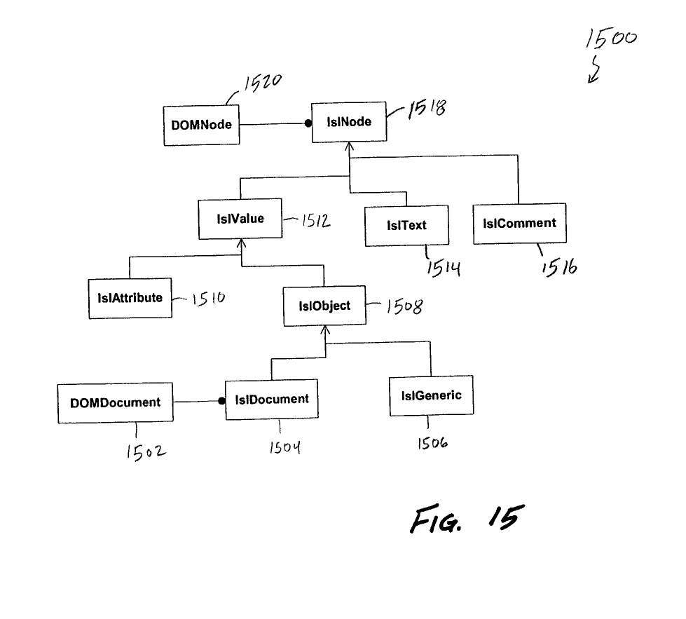

Shown in FIG. 15 are the Core Model interfaces. The IslNode 1518 represents a wrapper on top of a DOM Node 1520 that supports basic node-level behaviors. This type supports XPATH queries. The IslAttribute 1510 represents a wrapper on top of a DOM Attribute Node that supports basic attribute-level behaviors. The IslText 1514 represents a wrapper on top of a DOM Text Node that supports basic text behaviors. The IslComment 1516 represents a wrapper on top of a DOM Comment Node that supports basic comment behaviors. The IslValue 1512 represents the ability to manipulate the content of a DOM attribute or a DOM element as a value in symmetrical manners. Values are simple literals such as String, Float, Integer, and Date. The Islobject 1508 represents the ability to manipulate a DOM Element as a structured Java Object with its content being other contained IslNodes. The IslDocument 1504 represents the ability to manipulate a DOM Document Element 1502 as a structured Java Object with its content being other contained IslNodes 1518. This type supports Object Factory and DOM-Java Mapping. The IslGeneric 1506 represents a subtype of the IslObject 1508 class meant to hold XML nodes that are not mapped into the Object Factory.

Core Subtype

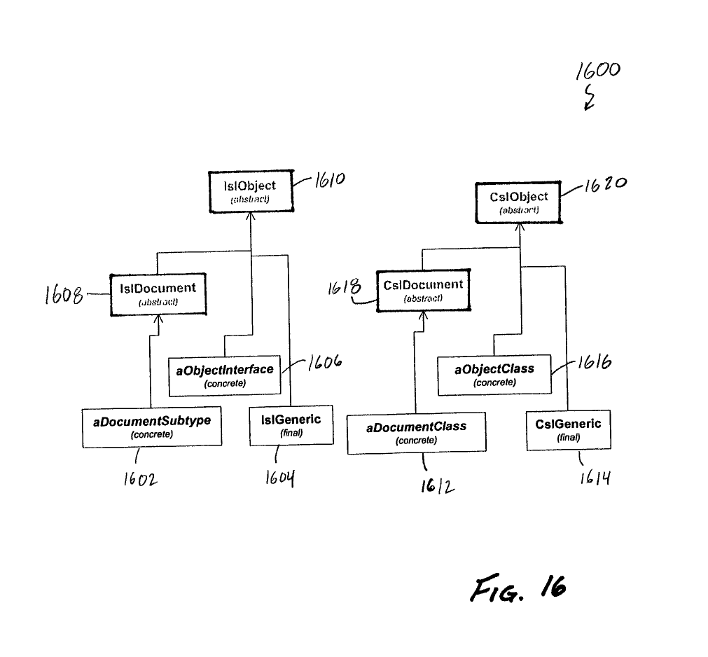

The Core Model, illustrated in FIG. 16, provides both an Interface and Implementation Hierarchy. These are used to support the creation of custom object and document subtypes as well as supplying core semantics by support the subclassing of appropriate core and document subclasses. This supports a very Java-XML based programming model for all layers above the Core Layer in the Process-container Engine.

Generic Object

When an XML element is encountered that does not have a custom mapping, then the IslGeneric interface and CslGeneric class are used.

DOM-Java Mapping

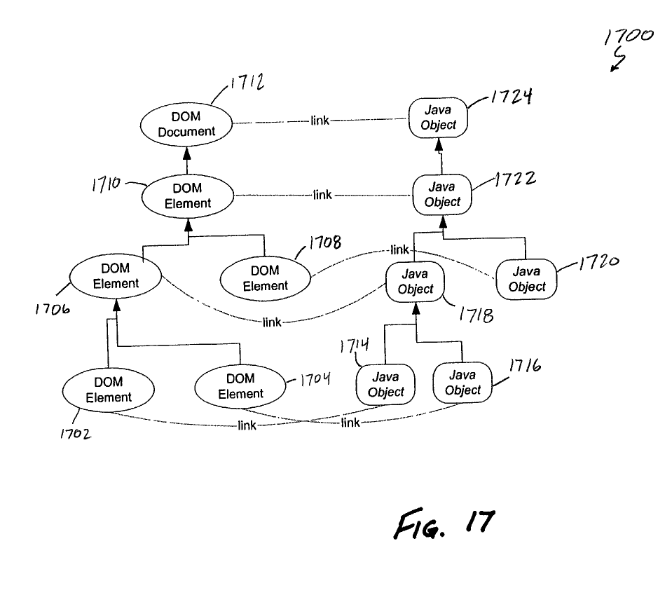

As shown in FIG. 17, the Core Model may include two parallel trees: (1) a DOM document and (2) a lazily constructed Core Model Document.

Tree Linking

These two trees are linked together by a combination of a reference from the Java Obect to the DOM Node, and a hashtable lookup of the Java Object based on the DOM Node as a key. This reverse linkage lookup avoids having to change the interface of the DOM API. This linkage management is done by the IslDocument implementation.

Lazy Construction

The extra price of having two parallel trees, both in complexity and performance, is mitigated to a certain extent by having the Java Object tree constructed lazily. This means that a given node in a given DOM tree only has its linked Java Object created when a direct request is made for it via a Core Query, some other Core Model tree manipulation.

Object Factory

The Java Object for a given DOM Element is constructed by an Object Factory based on three criteria: a DOM tag name and an Interface Specification. So as a given element is constructed, the Object factory does a lookup on first the interface specification and then if that is missing, the DOM tag name, and if that is not found among the Factory's registered types, then the Generic Object is returned.

Interface Specification

<element1 process-container: Interface=‘java.package.name.CoreSubtype’>

In order to support the ability to construct an XML element without having to specify the element name, the interface specification is used. This attribute, if found, overrides any Element name mappings.

Model

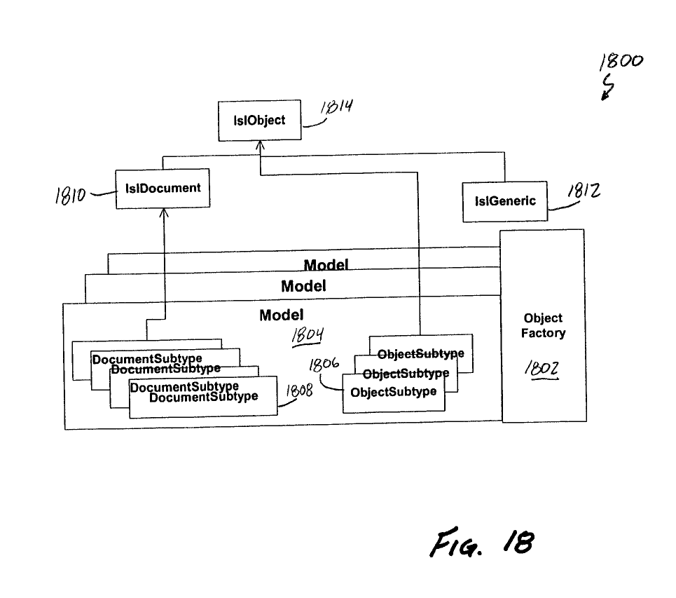

Turning to FIG. 18, the Core Model supports the registration of custom object and document subtype interfaces and implementations through a concept called a Model. The Model provides these types to the Object Factory to use when mapping DOM elements to Core Subtype instances.

Markers

<element1 process-container:Marker=‘3’>

The Marker is a core model specific attribute that is used by the Core Model to map the identity of a given DOM element in a tree to a particular Java object. This is what creates the Tree Linking from the DOM node to a possible previously constructed Core Model object or document. This is used for instance to map the results of an XSLT query to a pre-existing Java object.

Data Typing is also available.

6. The Process-Container Layer

The Process-container Layer is built on top of the Core Model Layer and includes the following major components: a Process-container; a Process-container Resource; a Process-container Binder; a Process-container Transaction; a Process-container Attachment; and a Process-container Journal.

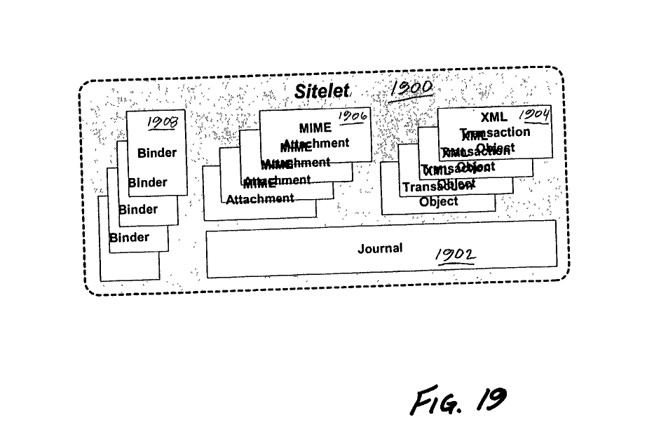

Turning to FIG. 19, the Process-container may be decomposed into one or more instances of a Binder, a Process-container Journal, one or more instances of a Process-container Attachment, and one or more instances of a Process-container Transaction.

Process-Container Identity

Each Process-container has an application defined URL that uniquely identifies the Process-container over its full lifecycle. Only one Process-container of a given identity may be hosted within the same Process-container Engine at the same time.

Process-Container Lifecycle

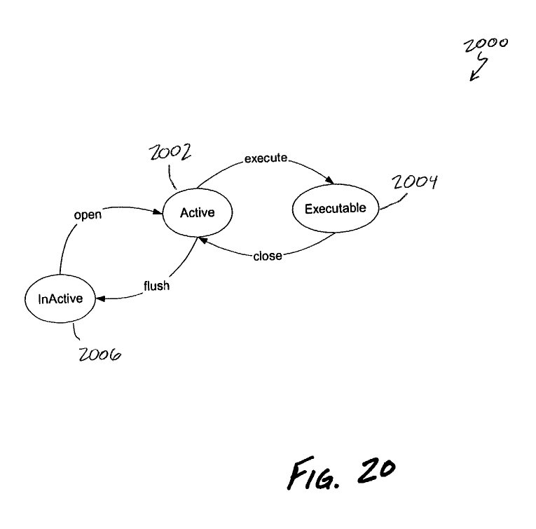

Turning to FIG. 20, Process-containers are created, destroyed, have one or more instances of Binder, Attachment, and Transaction added and deleted from them, and are moved around via the Extension API.

Process-Container Shell Annotation

In order to support their execution, Process-containers have a Shell annotation, that represents the starting point for interacting with the content of a Process-container.

Process-Container Thread Synchronization

One feature of the Process-container engine is that the run-time session support enforces session thread serialization at the Process-container granularity. This means that in general write permissions on a Process-container may belong to only one Session at one time. This allows session threads which have ownership of a Process-container to freely access most elements of the Process-container without concern about concurrency conflicts. This is a significant benefit of the asynchronous self-contained agent model of the present invention. Having a coherent complex object means that on a multiprocessor engine the complete Process-container with all of its contained objects, may be in whole or in part, localized to a single process cache. This avoids frequent cache-flushing which usually distorts otherwise linear performance scaling as processors are added.

Process-Container Run-Time Lifecycle Modes

The Process-container has three operation modes: Active, Execution, and Inactive. The Active operational mode of a Process-container occurs when the Process-container has been fetched. In the Execution operational mode, when an HTTP Page request is received that directs the Process-container Engine to start execution on a Process-container, a Page Context is created for the Process-container. The Inactive mode results after the Process-container is flushed to disk (and the Java object has been abandoned).

Process-Container as a Document

Process-containers share many concepts in common with Documents like Microsoft® Word® files. These may include verbs such as Open; Close; Save; Revert; Undo; and Redo. A Process-container may be opened. This means to initialize the Process-container including rolling forward the in-memory image to match the last saved persistent image. This is done using the Process-container Journal. Almost all operations on the Process-container, will preferably be performed after the Process-container is opened.

A Process-container may be closed. This means to free up a resources that the Process-container may be holding down, and freeing up the associated Java object. If the in-memory Process-container Object is not saved (its content not synchronized with the persistent image in the Process-container Store), then its changes will be lost. When a Process-container is saved, its in-memory image is synchronized with its persistent image in the Process-container Store. When a Process-container is reverted, then its in-memory image is rolled back, using the Process-container Journal, to match the last ‘saved’ persistent image. When the undo verb is received, the Process-container rolls-back the in-memory state using the Process-container Journal, that reflect the in-memory state that was in force before the last external event was received by the Process-container. When the redo verb is received, the Process-container rolls-forward the in-memory state using the Process-container Journal, that reflect the in-memory state that was in force before the last undo was performed

Process-Container Binder

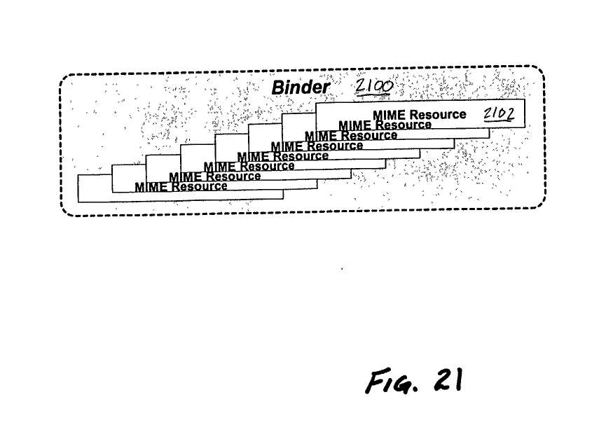

Turning to FIG. 21, a Process-container Binder is a set of Process-container Resource instances that Process-container authors use to organize Process-container functionality into identifiable, downloadable objects. They are the Process-container analog of the Java JAR file.

Meta-Data

Binders are considered meta-data. They preferably are not be updated by the Process-container during execution and may be shared as necessary between Process-containers.

Binder Identity

Each Binder may be uniquely located and identified via a URL. This identity and location is set by the Author when the Binder is developed.

Binder Downloading

The Binder may be downloaded by referencing its URL. This cached downloaded may then be shared between Process-containers as they reference the same Binder.

Binder Lifecycles

The Binder is placed into and removed from Process-containers at any point during the Process-container Lifecycle. Binders may be placed into the Process-container by different engines on behalf of separate applications.

Process-Container Transaction

Transactions are one very special type of Process-container Resource that is an XML document that represents transactional data within a Process-container. These documents have the following special processing applied to them during the Process-container lifecycle: they go through special ‘import’ and ‘export’ processing to add or remove them from the Process-container; all physical level data changes are ‘logged’ and are undoable; and if desired, compliance to an external DTD or other XML schema standard is enforced.

Process-Container Attachment

Process-container Attachments are a type of Process-container Resource that is any arbitrary MIME bytestream that is instance data intended to be accessed by one particular Process-container. This would include such things as specific Office documents added to the Process-container.

Process-Container Resource

One of the most salient aspects of a Process-container is its inherent support for aggregations of an arbitrary URL identified MIME ‘Resources’ in encrypted, compressed binary encoded form within the Process-container XML.

Resource VURL

The URL of each Resource may be considered a ‘virtual’ URL in that the Process-container Engine manages run-time references to a Resource URL through a virtual to physical mapping layer that allows the network identity to be remapped a local cached version made physical through the Process-container Engine. In this manner, all Process-container contained Resources are free to move from physical engine to physical engine and have the associated Process-container content accesses guaranteed to always succeed. The Process-container Engine contains services that support the ‘swizzling’ of content or the replacement of abstracted virtual Resource URLs (VURLs) with appropriate Resource PURL instances.

Resource PURL

Resource PURLs represent concrete, physical URLs that are replacements made by the Process-container Store to be used by the external Browser rendering component, to access a ‘local’ cached version made when the Process-container was ‘docked’ in that Process-container Engine.

Opaque Resources

Many of the Resources contained in a Process-container are simple binary byte streams that represent content that is not further interpreted by the Process-container environment. Examples of opaque resources include images, audio, video, binary data files, and non-XML documents.

Object Resources

Many of the Resources contained within a Process-container represent documents that the Process-container Engine considers interpretable or non-opaque. These are mostly XML documents, but include such files as Javascript and Cascading style sheets that are also ‘understood’ by the Process-container run-time as other than an opaque byte stream. These interpreted Resources are converted to specialized Engine ‘Objects’ that support many things including the ‘swizzling’ of relevant properties of the understood object.

Meta-Data Resources

Many of the Resources contained within a Process-container are considered ‘meta-data’. These meta-data Resources are read-only, shared, and are expected to have matching content and identity from one Process-container to another. Meta-data defines the ‘type’ of a Process-container.

Data Resources

Many of the Resources contained within a Process-container are considered ‘data’. These data Resources are private to the Process-container, writeable, and are expected to have varying content from one Process-container to another. Data is where the ‘instance’ properties of a Process-container are stored.

XCL Documents

Some of the content, in most cases Meta-data Resources, contain a Process-container specific dialect of XML called XML Component Language (XCL). This dialect of XML is used to annotate other forms of XML such as HTML, XSLT, and Transactions to Process-container-enable the presentation, logic, and data of the content. XCL is discussed in much greater detail below.

Process-Container Journal

The Journal model is a set of objects built on top of the Core Layer. Each Process-container may include an integrated journaling system with a Journal object.

Mutations

The Journal is a linear sequence of Mutations. Each mutation reflects a change in state of the Process-container. Mutations are grouped into ‘cycles’ which means a set of Mutations reflecting those changes associated with a single external event.

Physical Journaling

Physical Journaling is where all interactions with Process-container Resources that represent instance data, including Process-container Transactions, Process-container Attachments, have all changes made to them logged in the Journal. This logging behavior is used to support Process-container as Document; Asynchronous Synchronization Protocols; and a Replication Protocol.

Logical Journaling

Logical Journaling is where all interactions with the Process-container at a logical level are recorded. Examples are those Process-container state changes that are not directly physical events on a Process-container Resource. For instance logging of Publish/Subscribe Parameter events and in general presentation layer events. Logical journaling includes support for Process-container as Document.

Application Journaling

Application level journaling is where Extension API applications or XCL Rule instances may create events that are logged for later retrieval to support specific Process-container Interacting undo/redo behaviors.

Security and Authentication

The Journal supports a specific security model where segments of the Journal attributed to various people or systems may be isolated, possibly encrypted, and possible digitally signed. This is discussed in the Journal Security Model.

Journal Playback

Java Applications using the Extension API, may interact with the a Process-container's journal using the Process-container Journal object. This object allows the user to step forward or back through a Process-container's log and capture the sequence of events to support synchronization or data pro-filing.

7. The Execution Layer

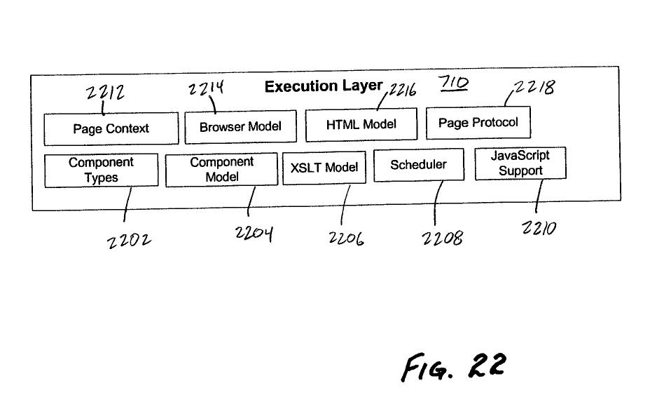

The Execution Layer is a set of Java interfaces and classes that support the execution of Process-containers. The Execution layers builds on top of the semantics of the Process-container Layer, and supports the semantics of the Javascript API and XCL API. As illustrated in FIG. 22, this layer may include the following Java subsystems and interfaces: Page Context 2212, Browser Model 2214, XCL Component Model 2204, XCL Component Type Model 2202, HTML Model 2216, XSLT Model 2206, JavaScript Support 2210, Page Protocol 2218, and a Scheduler 2208.

Execution Overview

The Process-container is executed by first locating the Process-container Shell Annotation specified in the Process-container, activating the specified XCL Component in the specified XCL Library. This activation in turns activates and executes all referenced Component. This shell annotation acts like a call to main( ) as in C, C++, and Java. The result of this processing is to create a Page Context that renders itself to a remote Browser, and then waits for external events over the Page Protocol. The requests are processed through the Page Context, potentially causing a wave of Components to be scheduled, and then re-rendering as appropriate to the remote Browser.

XCL Syntax Support

The XCL syntax, since it is a tree of intermixed and nested XCL and non-XCL markup, may be activated as a Core Layer Java Object model tree that contains both XCL Model objects. HTML Model objects, XSLT Model objects, and Opaque XML Model objects.

XCL Model

The XCL Model is the combination of the XCL Component Model and the XCL Component Type Model.

Opaque XML Model

Much of what is processed by execution layer is XML by what are called Generic Object instances. These undergo no special processing other than scanning for special XCL directives.

XSLT Model

The Execution layer supports an enhanced XSLT model that allows the user to manipulate the XSLT content of a transform.

HTML Model

The Execution layer supports an enhanced HTML model that allows the user to manipulate the HTML content of a Page.

XCL Component Model

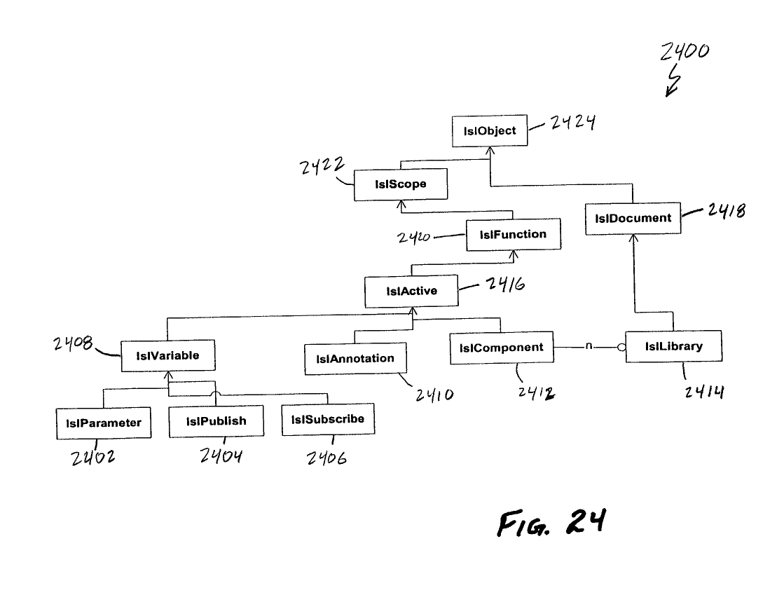

As shown in FIG. 24, the component interface hierarchy includes several Java interface classes. The IslScope interface represents the XCL scoping behavior for an XCL subtree. This is used to control the flow of events, variable lookups etc. The IslFunction interface is used to model the functional aspects of an XCL subtree. This includes parameterization, publish/subscribe variables etc. The IslActive interface represents a XCL subtree that may undergo Activation, Evaluation, Execution, and Deactivation. The IslComponent directly supports the XCL Component construct. The IslAnnotation directly supports the XCL Annotation construct. The IslVariable directly supports the XCL Variable construct. The IslVariable directly supports the Component Parameter construct. The IslPublish directly supports the XCL Publish Variable construct. The Islpublish directly supports the XCL Subscribe Variable construct. The IslLibrary directly supports the XCL Library construct.

XCL Component Type Model

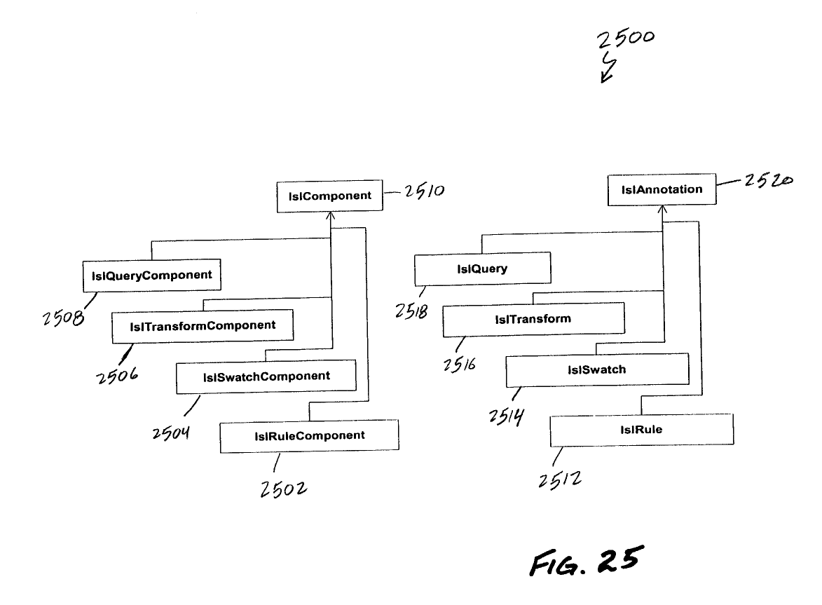

As shown in FIG. 25, the component subtypes interface hierarchy may include the following Java interface classes:

Query

The IslQueryComponent and the IslQuery interfaces support the Query Component and Query Annotation XCL constructs respectively.

Transforms

The IslTransformComponent and the IslTransform interfaces support the Transform Component and Transform Annotation XCL constructs respectively.

Swatch

The IslSwatchComponent and the IslSwatch interfaces support the Swatch Component and Swatch Annotation XCL constructs respectively.

Rule

The IslRuleComponent and the IslRule interfaces support the Rule Component and Rule Annotation XCL constructs respectively.

JavaScript Support

There are various ways that the Execution layers supports access to ECMAscript and the Javascript API of the present invention. These may include: the XCL Rule via the XCL API and the XSLT javascript extensions.

Page Context

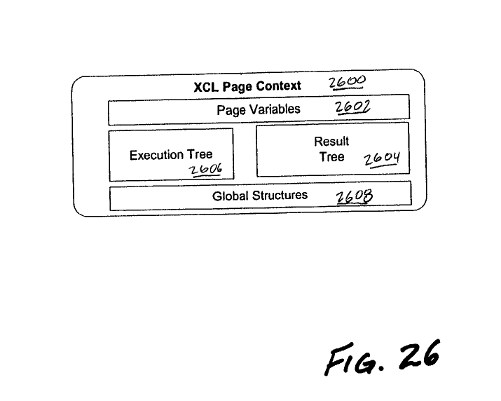

Turning to FIG. 26, the Page Context is the execution image for an executing Process-container. It is divided into two distinct sub-trees; the Execution Tree and the Result Tree. Also associated with the Page context are a set of Page Variables and some Global Structures.

Page Variables

The Page contains a set of XCL Variable instances that contain run-time data of the page. These are used in PageScopes to make these variables available to the executing XCL.

Global Structures

There are a set of global structures in the Page Context. These may include a Scheduler and an Article Manager.

Execution Tree

The scope tree in the page structure contains what amounts to the tree version of a run-time execution stack.

Result Tree

The content tree in the page structure contains a tree that is the final visible results of the current page event cycle. This is HTML in a browser-independent form.

Page Lifecycle

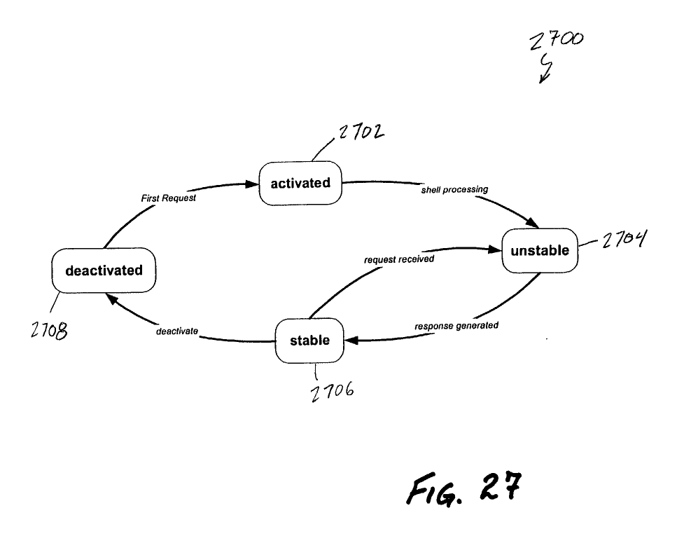

Turning to FIG. 27, the Page Context lifecycle is based on the concepts of activation, deactivation, stabilization and destabilization.

Deactivated

Until the first Page Request on given Process-container is received, the Page Context is non-existent (deactivated). However, when the Process-container receives its first page-request, it checks to see if the Page Context is extent (activated), and if not activates it (creates the page). Once the Page Context is available, the request is passed to it, which immediately makes it ‘unstable’ because the first page-request requires a page response.

Unstable

When a Page Request is received, the page immediately becomes unstable, and the execution layer's main job is to achieve Page Context stability. This is achieved by processing the request, and generating an appropriate Page Response.

Stable

After the Page Response is generated, it goes into a quiescent state where no more Components may be scheduled.

Page Protocol

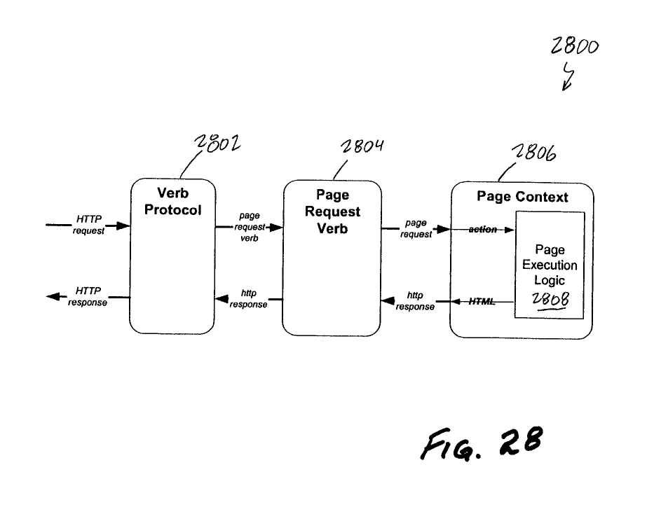

Turning to FIG. 28, the Execution Layer uses the Verb Protocol Subsystem to provide a verb called the page-request verb to support a series of possible external manipulations of the Page Context. This external manipulation of the Page Context is called a Page Action.

Page Request

A Page Request is an HTTP request coming into the Page from the local Servlet Container. This page request contains a URL which represents a combination of the desired Page Action, the appropriate Process-container/Page as the target for this request, and the data associated with the Action. This request is forwarded through the page-request verb and is processed into a page action that is sent to the Page Execution Logic.

Page Execution Logic

The Page Execution logic is where the Page Action is interpreted and appropriate processing is performed on the state of the Page. The Page Execution Logic may include the following elements: Action Processing, Scheduler, and Browser Model. The Execution Logic's main job is to stabilize the Page Context after it has received a Page Action. Once this stabilization has occurred, then a Page Response may be generated.

Page Response

The Result Tree of a stabilized Page Context may be rendered to create the appropriate HTTP response to be sent back to the Browser Client.

Action Processing

Pages may react to various Page Actions. Each of these actions is processed individually.

Page Action

A Page action may come in the following forms: Visualize Action, Opaque Action, Update Action, Undo Action, and Save Action.

Visualize Action

The visualize action may be used for the following reasons: Page Activation which leads to initial rendering of Results Tree; and Page Refresh which leads to a complete re-rendering of the Results Tree.

Opaque Action

The Opaque Action is used for communication between the Browser Client and the Browser Model. It is interpreted by the Page Context directly.

Update Action

The Update Action is used to send updates from the Browser Client to the Page Context. These updates are browser events potentially conveying data.

Undo Action

The Undo Action is processed to roll-back the state of the Page Context to the last stabilized state.

Redo Action

The Redo Action is processed to roll-forward the state of the Page Context to a previously undone stabilized state.

SaveAction

The Save Action is processed to persist the current state of the Process-container.

Revert Action

The Revert Action is processed to roll-back the in-memory state of the Process-container and Page to the last persisted state of the Process-container.

Page Activation

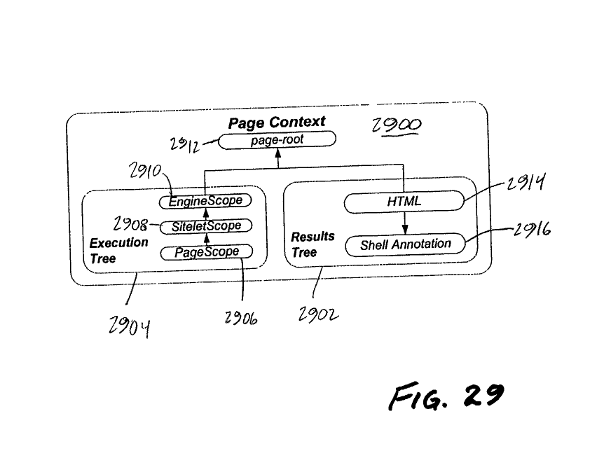

Turning to FIG. 29, Page Activation is where the Page Context structures are constructed for the first time.

Page Initialization

The first phase of Page activation is where the Page Context is set up for the first Component Scheduling, the Shell Annotation Execution. The steps involved include placing the initial Dynamic Scope instances at the root of the Execution Tree; placing the HTML root tag at the root of the Results Tree; placing the Shell Annotation under the HTML root; placing the Shell Annotation into the Scheduler; running the Scheduler; and building the remainder of the Page Result Tree by the Shell Annotation.

Shell Annotation Execution

The Process-container Shell Annotation when run acts exactly like other Component executions. This builds the Results Tree from scratch.

Scheduler

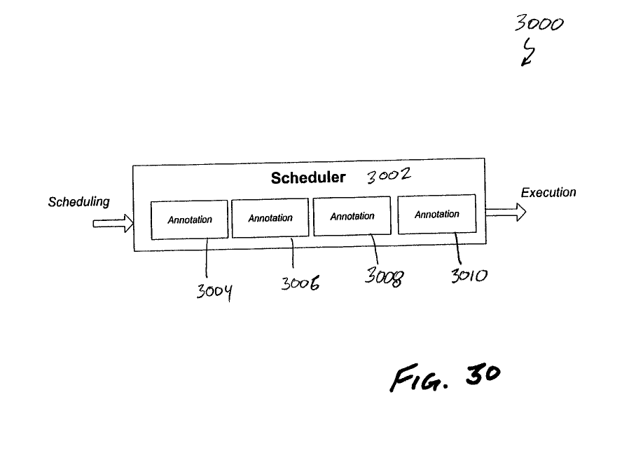

Turning to FIG. 30, the Scheduler accepts new XCL Annotation instances for scheduling. These Annotations then undergo Annotation Execution according to a Scheduling Algorithm.

Scheduling Algorithm

The Scheduling algorithm is based on the following rules in high to low priority order: (a) if the scheduled Annotation is already in the scheduling queue, then it is not added a second time; (b) if the scheduled Annotation is deactivated, then it is removed from the scheduling queue; and (c) the first scheduled Annotation is the first executed (first in, first out).

Subtree Lifecycles

The Page Context is composed of both an Execution Tree and Result Tree both of which include many individual subtrees that are the result of the execution of Annotations. Each of these subtrees has its own lifecycle which includes the following phases; the Activation Phase, the Evaluation Phase, the Execution Phase, the Deactivation Phase, and the Rendering Phase.

The Activation Phase is where a new subtree, usually part of a Results Set is constructed into the Scope of a Page Context for the first time. All run-times structures are initialized and all nested child Annotations are executed at least once. This phase is only run once per annotation.

The Evaluation Phase is where a subtree goes through appropriate attribute values and element contents, evaluating them as an XCL Expression. The content of the attribute or element is replaced by the result of this expression evaluation.

The Execution Phase is where the previous Results Set members of a given Annotation Execution are removed, undergoing the Deactivation Phase, and new Results-set are inserted as produced by the execution of the particular Annotation involved.

The Deactivation Phase is where the given subtree has all of its associated run-time resources disabled and removed from where they were rooted. This may be run once on a given subtree, because after deactivation, the Annotation and all of its children undergo deactivation and are no longer valid XCL subtrees.

The final form of subtree traversal, the Rendering Phase, is engaged when the whole Page Context results-tree undergoes Update Rendering.

Annotation Execution

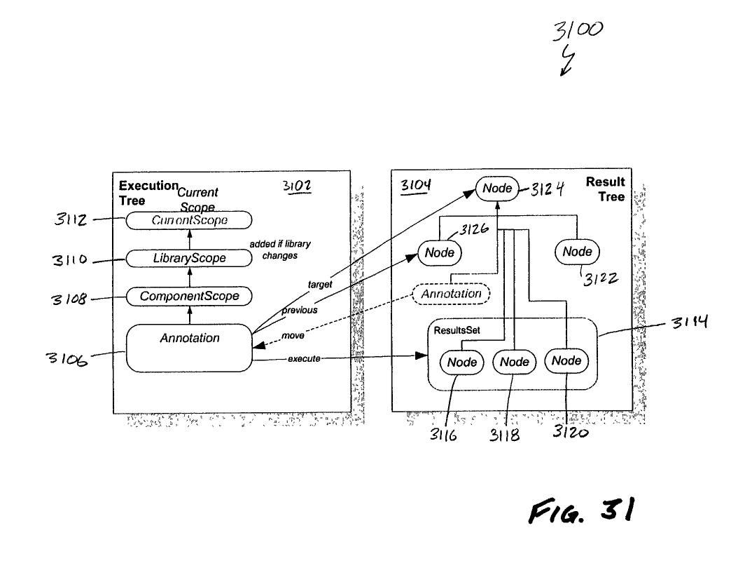

Turning to FIG. 31, when an Annotation is executed, the body of the associated Component (or Annotation if it is an Inline Component), is executed in a manner that is specific to the associated Component Kind.

Results Set

This execution in all cases returns either nothing, or an XML fragment node set. This results-set node-set is placed after its previous node as a child in its target.

Previous Node

The previous node is the node that the Annotation had as a previous sibling and this marks where its Results-set is to go.

Target Node

The Target node is the same node as was the parent of the Annotation before it was taken from its original parent.

Browser Model

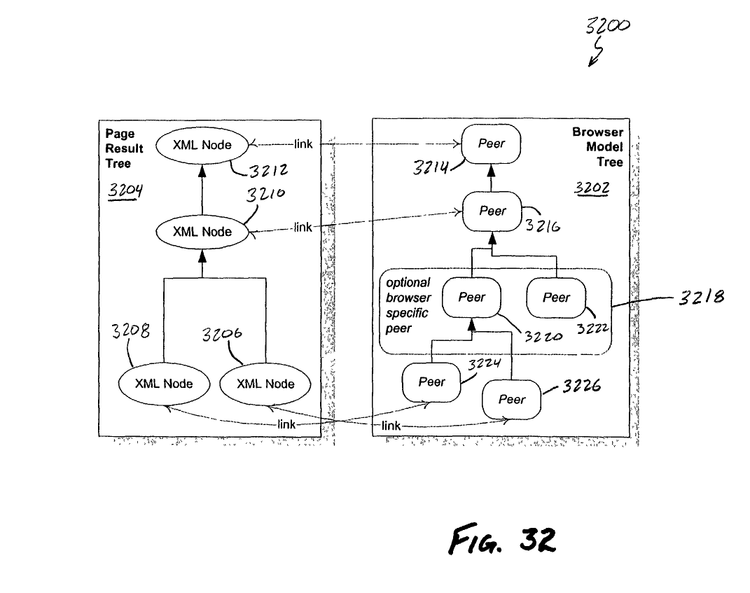

Turning to FIG. 32, the Browser Model provides browser-independence for Process-containers. There is a separate kind of browser model for each supported browser company and version. The Result Tree is interpreted by the current browser model and is output in HTML that is browser specific.

Browser

The Browser Model manages a roughly parallel structure to the page Result Tree except that instead of being a tree of Core Model nodes, it is a set of Peer instances that represent the binding between the Page and the Browser models.

Peer

The Browser model is asked to construct Peers for every element in the Results-Tree. These Peers in turn are used by the Browser model to build browser-dependant versions of the HTML they are to send back to the Browser Client.

Browser Client

The Browser Client is one of a set of supported HTML rendering clients such as Internet Explorer or Netscape communicator. The Browser model builds multi-frame structures using JavaScript in the Browser Client.

Update Rendering

The Browser model traverses the Results Tree and sends via the Page Response, via Targeted Updates. the information needed by the Browser Client to display the current state of the page.

Targeted Updates

Targeted updates are updates coming from the browser model that are targeted to only those parts of the HTML that have actually changed. This means that the structures on the Browser Client are optimally redrawn.

Article Manager

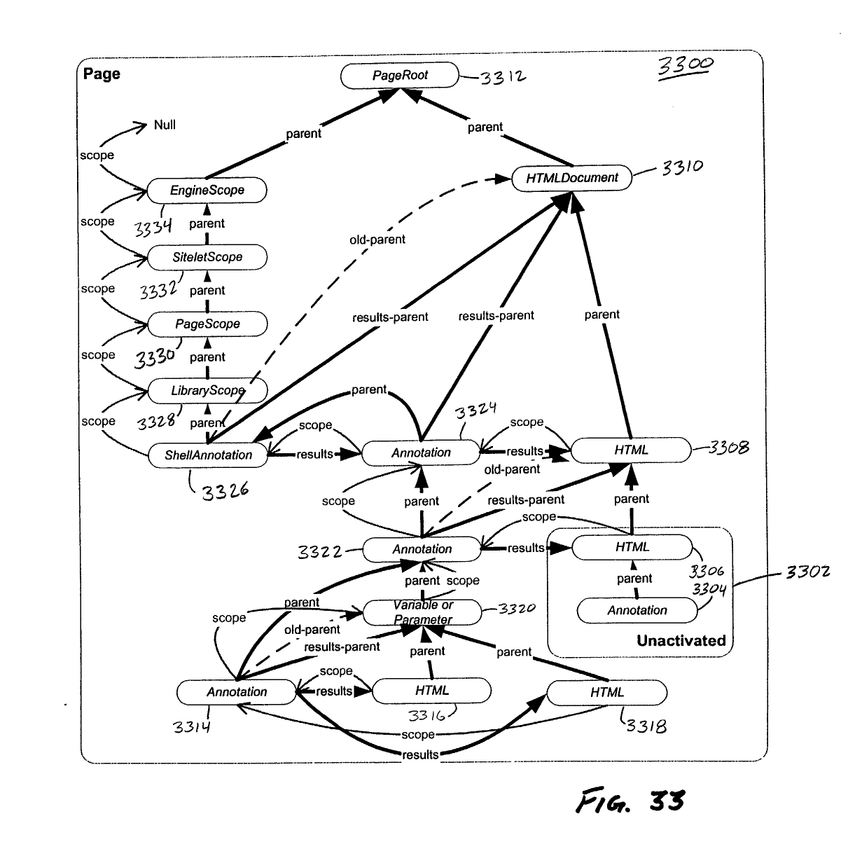

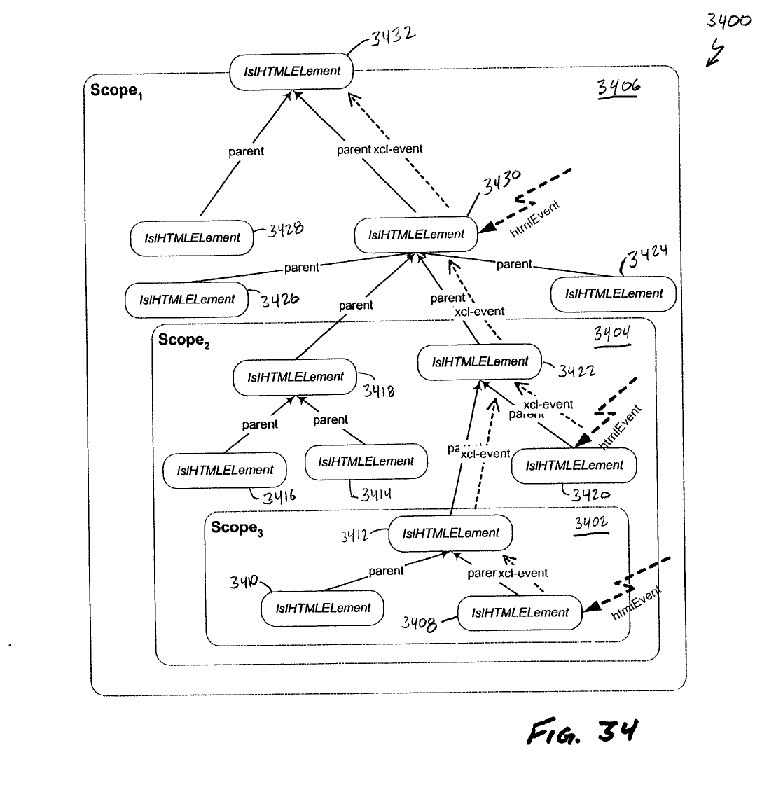

The article manager is used to support page context structure to support Articles. Turning to FIG. 33, Page Building is illustrated. FIG. 34 illustrates Event Flow.

8. XCL API

One very important type of Resource contained within a Process-container are XML Process-container Resources which are instances of the XCL Library written following the XML Component Language XCL Source Language. Each of these libraries contain one or more instance of XCL Component.

XCL Source Language

XCL source language includes XML tags with the XCL namespace prefix ‘xcl’, and XML tags coming from arbitrary other XML dialects. The XCL source language processes certain other dialects of XML, HTML and XSLT, with special semantics. All other XML is treated as generic XML.

XCL Name

XCL uses names to identify constructs for later reference.

XCL Component

Each of these components in their associated library represent the meta-data defining a fine-grained, re-useable, event-driven executable module of XML functionality that can be ‘called’ within the context of other XCL components.

Component Encapsulation

Components are designed to be highly re-useable, modular, coherent semantic constructs.

Component Functions

Components can be thought of as functions in the traditional sense. They have the concepts of signatures, evaluation, and return values. Also the encapsulation guarantees of components are very similar to the type encapsulation of functions.

Component Kind

There are four kinds of components: XCL Rule, Rule Annotation, XCL Swatch, and XCL Query.

Component Definition

Components are specified in the XCL dialect using XCL component constructs. The component definition includes the declaration, the signature, and the body.

Component Declaration

<xcl:SwatchComponent name=‘haynes’>

. . . swatch component definition . . .

</xcl:SwatchComponent>

<xcl:RuleComponent name=‘jones’>

. . . rule component definition . . .

</xcl:RuleComponent>

<xcl:TransformComponent name=‘peterson’>

. . . transform component definition . . .

</xcl:TransformComponent>

<xcl:QueryComponent name=‘drew’>

. . . query component definition . . .

</xcl:QueryComponent>

The XCL Component Declaration identifies the XML construct as an XCL component definition and associates it with a XCL Name. The Declaration contains an instance of a Component Signature and an instance of a Component Body.

Component Signature

<xcl:Component name=‘green’>

<xcl:Parameter name=‘marsalis’/>

<xcl:Publish name=‘fuller’/>

<xcl:Subscribe name=‘evans’/>

</xcl:Component>

The Component signature defines the encapsulation of the component Scope. This is done through zero or more instances of a Component Parameter and zero or more instances of Publish/Subscribe Parameter. This signature defines the ‘type’ of the XCL component. The return type of a XCL Component is always assumed to be a fragment of well formed XML.

Component Parameter

<xcl:Parameter name=‘tyner’>

. . . optional default parameter data . . .

</xcl:Parameter>

Parameters are the way that data is passed into the functional scope of a given component. They have a XCL Name and a some possible contained XML that becomes the default assignment for that Parameters.

Component Body

<xcl:Body>

. . . component executable content . . .

<xcl:Body>

The Component body includes executable content who's exact form is specific to a particular Component Kind

Inline Component

It is also possible to directly specify a component ‘in-line’ to another component. Strictly speaking this mode is triggered by the inclusion of an Annotation Body in and XCL Annotation. This means that the component's annotation is not separated from the components Component Definition.

XCL Library

<xcl:Library>

. . . identity . . .

. . . authoring properties . . .

. . . one or more component definitions . . .

</xcl:Library>

Any given Components is placed into exactly one XCL Library. It has a identity, a set of authoring properties,

Library Identity

<Process-container:VURL>

. . . URL defining identity and location of library . . .

</Process-container:VURL>

Since a XCL Library is a standard Process-container Resource, it is identified by a standard Resource VURL.

Library Authoring Properties

<xcl:Author>

. . . name of author responsible for library . . .

</xcl:Author>

XCL Annotation

Once an XCL XCL Component is defined, it can be called within the Component Body of another XCL component (at least those who have XML as executable con-tent. These functional calls are invoked through the use of Annotations. These invocations are proxies that represent a later substitution of the XML of the actual Annotation with the XML that is the result of the functional component call. For instance one call of each Annotation Kind (on page 84), is shown below:

<blakey>

<xcl:Rule name=‘morgan’>

<xcl:Swatch name=‘basie’>

<xcl:Transform name=‘ellington’>

<xcl:Query name=‘strayhorn’>

</blakey>

Annotation Declaration

<xcl:Swatch name=‘vituous’>

. . . swatch definition . . .

</xcl:Swatch>

<xcl:Rule name=‘pederson’>

. . . rule definition . . .

</xcl:Annotation>

<xcl:Transform name=‘fortune’>

. . . transform definition . . .

</xcl:Transform>

<xcl:Query name=‘tyner’>

. . . query definition . . .

</xcl:Query>

The XCL Annotation Declaration identifies the XML construct as an XCL Annotation definition and associates it with a XCL Name and possible an attribute to specify the XCL Library. The Declaration contains an instance of a Annotation Signature and a possible instance of a Annotation Body.

Annotation Signature

<xcl:Swatch name=‘dolphy’>

<xcl:Parameter name=‘marsalis’/>

<xcl:Publish name=‘fuller’/>

<xcl:Subscribe name=‘evans’/>

<xcl:Swatch>

The Annotation signature instantiates the data and events passing into the Annotation Scope. This is done through zero or more instances of a Annotation Parameter and zero or more instances of Publish/Subscribe Parameter. This signature defines the ‘type’ of the XCL Annotation.

Annotation Parameter

<xcl:Parameter name=″>

. . . optional default parameter data . . .

</xcl:Parameter>

Parameters are the way that data is passed into the functional scope of a given Annotation. They have a XCL Name and a some possible contained XML that becomes the default assignment for that Parameter.

Annotation Body

<xcl:Body>

. . . Annotation executable content . . .

<xcl:Body>

The Annotation body includes specific executable content whose exact form is specific to a particular Component Kind. By putting a Body into the Annotation we create some-thing called an Inline Component.

Annotation Kind

There are four kinds of Annotations, one for each Component Kind.

Annotation Execution

The invocation of a annotation is not exactly like traditional functions is in how and when they are executed. Instead of being executed procedurally, they are executed either during activation or after scheduling.

Activation

Activation is where the annotation is set up for execution and also where it is executed.

XCL Scope

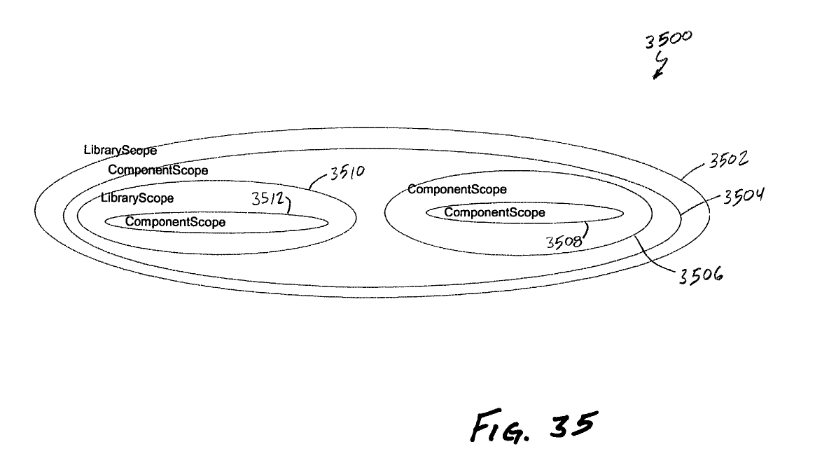

Turning to FIG. 35, the XCL execution logic takes the XCL source and uses it to build a set of scopes at run-time. These scopes are very similar to stack frames in a standard procedural language except that they are organized into trees. These trees are actually built and modified at run-time as XCL annotations are brought into scope, executed

Static Scopes

The first part of Scoping within XCL is defined statically. This means that it is defined by the nature of the way that component definitions call other components in the same or a different XCL Library.

The Library Scope supports access to a set of XCL Variable instances associated with the current XCL Library that this XCL was defined within. The Component Scope supports access to a set of XCL Variable instances associated with the current XCL Component of which this XCL is part.

Dynamic Scope

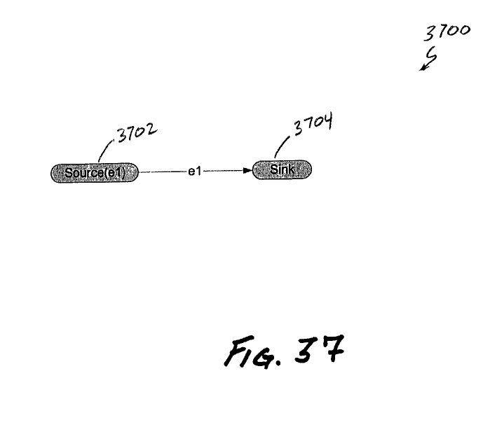

Turning to FIG. 37, the second part of Scoping within XCL is defined dynamically. These scopes are defined by the run-time environment set up to provide a context for the static scopes. Dynamic Scopes are mostly used to access the properties of a run-time aspect of the executing XCL. The following dynamic scopes are introduced:

Engine Scope: The Engine Scope supports access to a set of XCL Variable instances associated with the current Process-container Engine that this XCL is executing on.

Process-container Scope: The Process-container Scope supports access to a set of XCL Variable instances associated with the current Process-container that this XCL is executing in.

Page Scope: The Page Scope supports access to a set of XCL Variable instances associated with the current Page Context that this XCL is executing in.

Window Scope: The Window Scope supports access to a set of XCL Variable instances associated with the current XCL Window that this XCL is executing in.

Frame Scope: The Frame Scope supports access to a set of XCL Variable instances associated with the current XCL Frame that this XCL is executing in.

XCL Event

As part of the basic contracts within the XCL environment is the concept of events. Because the XCL environment is based on event driven re-evaluating functional components, understanding sourcing and sinking and general flow of events is a critical aspect of understanding XCL.

Named-Event

There is basic form of events in XCL is the XCL named-event. Theses named events can be sourced and sinked within the XCL environment.

Event Data

Named-events can have data associated with them. This data is expressed as fragments of well formed XML.

Browser Event Source

XCL supports the concept of browser-event sources on all/most? HTML tags. These are the standard DOM HTML events that are used by javascript in HTML. The browser events that can be sunk from a given HTML element follows the W3C DOM level 2 javascript bindings. Examples are: onClick, onSelect, and onChange. Browser-events do not actually broadcast within the component scope like named-events do. In fact, before they can propagate with a component scope, browser events must be ‘mapped’ by a event-map construct. This special xcl eventMap attribute looks like:

<SOMEHTMLELEMENT xcl:eventMap=‘someBrowserEvent:someNamedEvent;’/>

The construct above take the HTML element ‘SOMEHTMLELEMENT’ and translates a browser-event source ‘someBrowserEvent’ to a broadcast, to all event-sinks within the current component scope, of the named-event ‘someNamedEvent’. Some browser-event have associated data. This associated data is in the form of a string. For instance the onChange browser event has the new string value of the associated HTML element.

Event Sources and Sinks

Turning to FIG. 37, there are both event-sources and event-sinks within the XCL environment. Events by definition flow from event sources to event sinks. Scope Level Broadcast

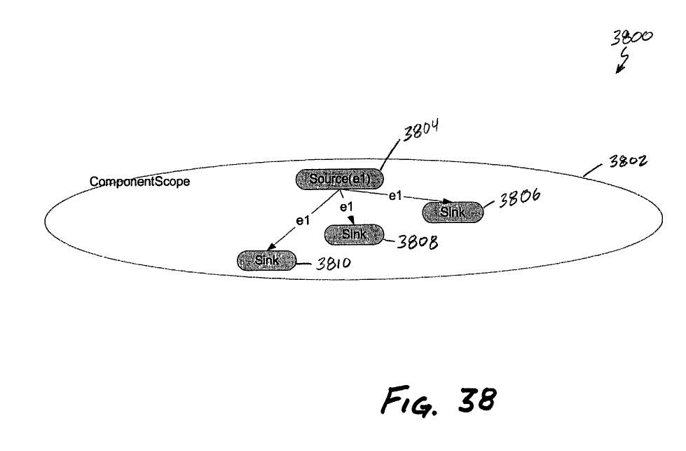

Turning to FIG. 38, any named-event source within the encapsulated scope of a Component broadcasts all of its events to all matching named event sinks within that encapsulated scope.

Event Encapsulation

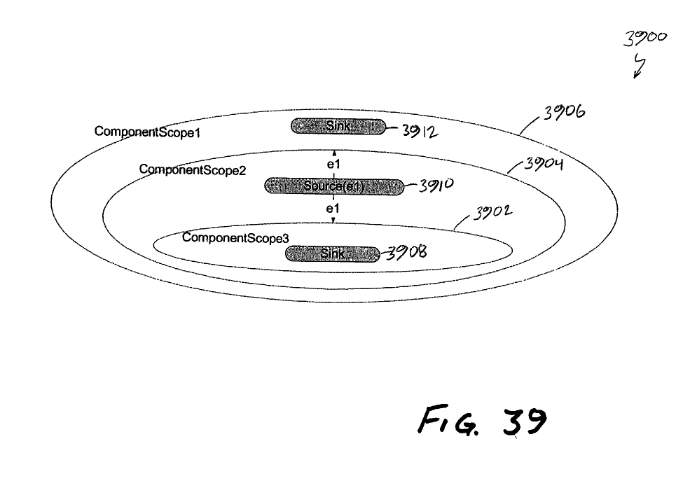

Turning to FIG. 39, all flow of named-events is controlled by the encapsulation of the component scope. The broadcast of a named-event from a given source is by default stopped at the component scope boundaries.

Publish/Subscribe Parameter

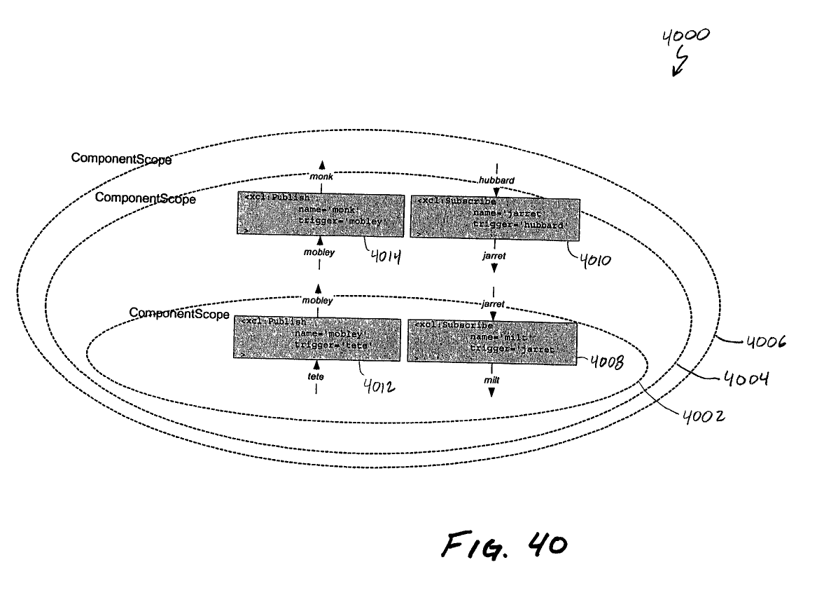

Turning to FIG. 40, in order to puncture the component scope boundary, two special types of parameters called publish and subscribe need to be used.

Publish Variable

Publish parameters allow events to be pushed from the current component scope outward to its containing component scope.

<xcl:Publish name=‘dizzy’ trigger=‘mingus’>

. . . publish data . . .

</xcl:Publish>

Subscribe Variable

Subscribe parameters allow events to be pulled from the containing scope component into the current component scope.

<xcl:Subscribe name=‘mingus’ trigger=‘dizzy’>

. . . subscribe default . . .

</xcl:Subscribe>

Subscribe Propagation

<xcl:Subscribe name=‘hawkins’ trigger=‘webster’ propagate=‘parent|local|both’>

. . . subscribe default . . .

</xcl:Subscribe>

Subscribe parameters have an attribute called ‘propagate’ that can be set to ‘parent’, ‘local’ or ‘both’. If it is not provided, then the default value is ‘parent’. The semantics of these options are:

parent: the event is propagated only to the parent component scope

local: the event is only propagated within the current local component scope.

both: the event is propagated to both the local and parent component scopes.

Publish Subscribe Data

Publish and subscribe parameters can have data contained within them or not. If a publish parameter contains data, then the name-event will have that data attached to it when it is published. If the subscribe parameter has data attached to it, then this will be used as the default value until a new name-event triggers it.

Articles

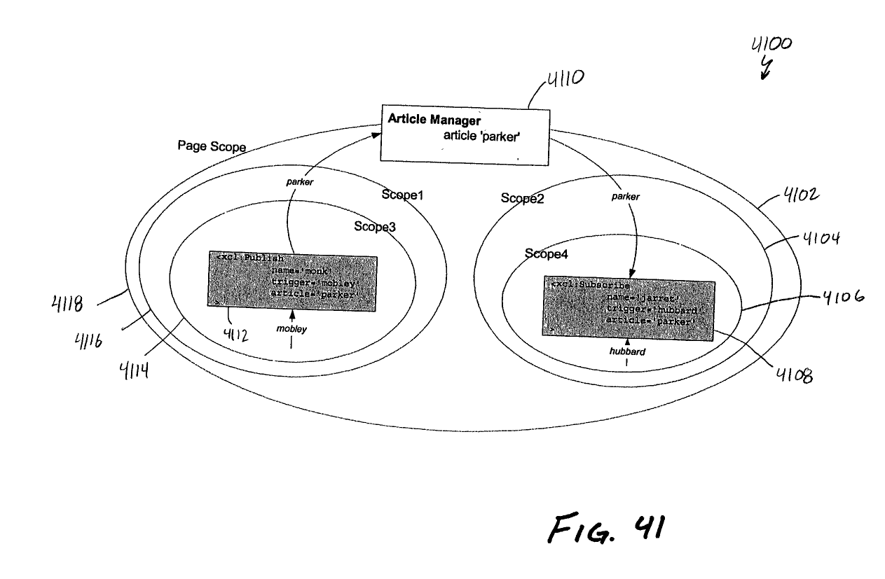

Turning to FIG. 41, publish subscribe variables can also be used to publish what are called ‘articles’. These are page global events that can be subscribed to by any component scope.

<xcl:Subscribe name=‘mingus’ trigger=‘dizzy’ article=‘PageLevelEvent>

. . . subscribe default . . .

</xcl:Subscribe>

Publish Subscribe Filtering

<xcl:Subscribe name=‘<expr1>’ trigger=‘<expr2>’ article=‘<expr3>’>

. . . subscribe default data . . .

</xcl:Subscribe>

<xcl:Publish name=‘<expr4>’ trigger=‘<expr5>’ article=‘<expr6>’>

. . . publish data attachment . . .

</xcl:Publish>

All publish and subscribe parameters can have their names, trigger, and article attribute values specified as a regular-expression. This regular-expression is used to specify a filtering mechanism that allows a set of named-event names to be selected based on matching the regular expression supplied. The following are examples:

Subscribe Name Filtering

Filtering can be used to support the subscription of groups of named-events through the component scope boundary without having to specify each one individually. Setting the name attribute to the all inclusive match ‘*’, tells the event system to pass whatever events are in trigger attribute as the same named event. It is only legal to have one name, or a ‘*’ in the name attribute value.

<xcl:Subscribe name=‘*|name’ trigger=‘<expr1>’>

. . . publish data attachment . . .

</xcl:Subscribe>

Subscribe Trigger Filtering

Filtering can be used to support the publishing of groups of trigger named-events through the component scope boundary without having to specify each one individually. Setting the name attribute to the all inclusive match ‘*’, tells the event system to pass whatever events are in trigger attribute as the same named event. It is only legal to have one name, or a ‘*’ in the name attribute value.

<xcl:Publish name=‘*|name’ trigger=‘<expr1>’>

. . . publish data attachment . . .

</xcl:Publish>

XCL Variable

<xcl:Variable name=‘hendrix’>

. . . variable content . . .

</xcl:Variable>

XCL supports a construct called a Variable. This allows the arbitrary construction of data containers that can be referenced by name during XCL execution.

Variable Names and References

$hendrix.

Each Variable has an attribute that is an XCL Name. This name supports access to the Variable's content in an instance of a XCL Expression using a Variable Reference.

Variable Content

Each Variable potentially has some sort of Content expressed within it. If it has no content, then the content is assigned to be NULL. Otherwise any well formed XML fragment can be placed into Variable including plain text.

Variable Scoping

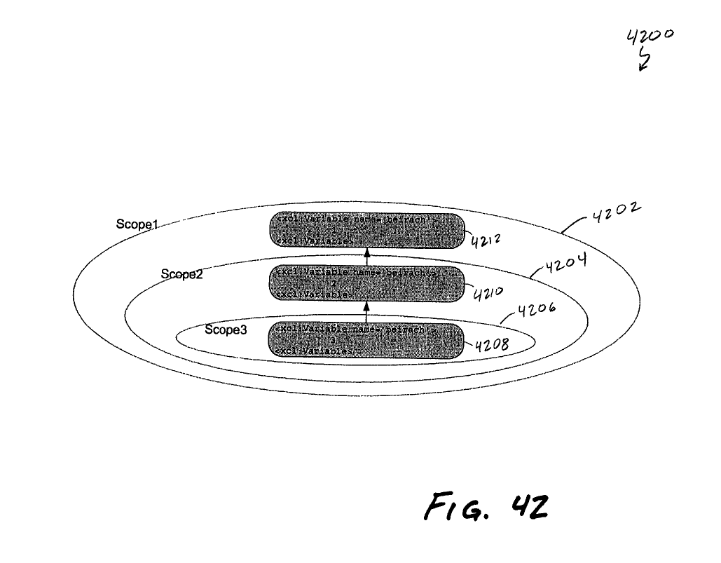

Referring to FIG. 42, variables represent a data access method that breaks the Component encapsulation.

XCL Expression

XCL supports the evaluation of the an XCL expression placed into either attribute or element content. This expression is a combination of a possible root variable reference, and an XPATH expression with possible Variable References

Expression Syntax

root-expression::

{rootvariable} expression

expression::

{xpath}{variable}

variable::

‘$’ identifier

The XCL expression syntax is shown above.

Expression Evaluation

The XCL expression when evaluated returns zero or more XML nodes. This definition includes the possibility of returning: nothing, plain text, comments, attributes, and elements.

Attribute Expression

<element attributed=‘root-expression’/>

An attribute expression is an xcl expression that is inserted into an XML attribute. The only acceptable types of return for this form of expression are: nothing and plain text.

Element Expression

<element>root-expression </element>

An element expression is an xcl expression that is inserted into an XML element. All possible return types are supported.

Where Are Expressions Evaluated

Expressions cannot be placed into any attribute or element. Only certain attributes and elements within the XCL Source Language. It would illogical to have some elements or attributes contain expressions because the syntax of the expression could not be distinguished from normal plain text.

Forced Evaluation

<xcl:element evaluate=‘truelfalse’>possible expression </xcl:element>

<element xcl:evaluate=‘truelfalse’>possible expression </element>

XCL supports a special attribute called ‘xcl:evaluate’ that force the evaluation of the contents of an element. If the element is in the XCL namespace, then the ‘evaluate’ attribute name is used instead.

Variable Reference

variable::

‘$’ identifier. 93

An XCL expression can be solely a variable reference, or can have variable references intermixed anywhere within the expression.

Root Variable Reference

An XCL expression usually has to be started by a variable reference.

Resource Root

There can be support for the ability to specify a VURL at the beginning of an XCL expression. This would start the XPATH at the document element of the XML resource identified by that VURL.

XPATH

The full Xalan XSLT/XPATH expression language is supported within the text of an XCL expression.

XCL Swizzling

Like it is for the XCL Expression, much of theXCL Source Language, can have various attributes or elements ‘swizzled’. This means that the contents of that attribute or element is assumed to be in the form of a Resource VURL. At run-time this VURL is replaced with a Resource PURL.

XCL Query

Queries are XCL components that support the execution of XPATH queries.

Query Component

<xcl:QueryComponent name=‘identifier1’>

. . . signature . . .

. . . Query Body . . .

</xcl:QueryComponent>

A Query Component includes a Component Signature, and a Query Body.

Query Body

The Query Body contains a XPath expression to be either as a Resource Query or a Context Query.

Resource Query

<xcl:QueryComponent name=‘identifier1’ resource=‘VURL’>

The Resource Query is where a Process-container Transaction, is the root of the XPATH query.

Context Query

<xcl:QueryComponent name=‘identifier1’ context=‘xclExpression’>

The Context Query is where an XCL expression is the root of the XPATH query.

Query Annotation

<xcl:Query name=‘identifier1’>

. . . signature instantiation . . .

. . . optional inline QUery Body . . .

</xcl:Query>

Queries are executed through the Annotation syntax. They may include an instantiated Component Signature, and a potential inline Query Body.

Simple Inline Queries

<xcl:Query context=‘xclExpression’>

. . . xpath expression . . .

</xcl:Query>

<xcl:Query resource=‘VURL’>

. . . xpath expression . . .

</xcl:Query>

Because this construct is so important for many XCL programming tasks, a very simple ‘syntactic sugar’ version of the inline query is defined.

XCL Rule

Rules are XCL components that support the execution of ECMAscript (javascript).

Rule Component

<xcl:RuleComponent name=‘identifier1’>

. . . signature . . .

. . . Rule Body . . .

</xcl:RuleComponent>

A Rule Component includes a Component Signature, and a Rule Body

Rule Body

<xcl:Body name=‘identifier1’>

. . . ECMAScript source . . .

</xcl:Body>

The Rule Body is assumed to be in the form of a standard JavaScript function body. However since the Rule Component defines the parameters, the body does not need the: function(parameter, parameter, parameter) {

. . . rule semantics . . .

}

Form. Just intra-function rule semantics themselves are included.

Rule Annotation

<xcl:Rule name=‘identifier1’>

. . . signature instantiation . . .

. . . optional inline Rule Body . . .

</xcl:Rule>

Queries are executed through the Annotation syntax. They include an instantiated Component Signature, and a potential inline Rule Body.

XCL Transform

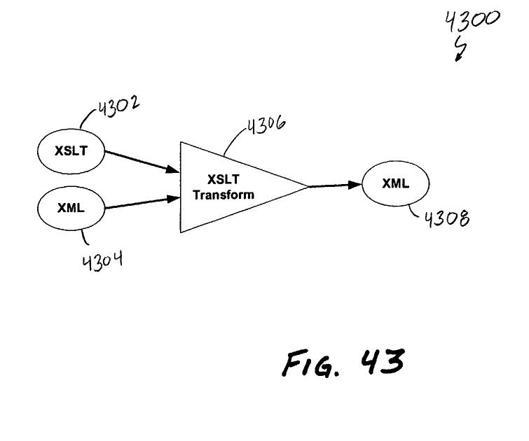

Turning to FIG. 43, transforms are XCL components that support the execution of XSLT standard ‘transforms’. These transforms take an XSLT transform Body, a special Source parameter that contains arbitrary XML, and then using an XSLT processing engine creates a XML fragment that is the result of the transform process.

Transform Component

<xcl:TransformComponent name=‘identifier1’>

. . . signature . . .

. . . XSLT Body . . .

</xcl:TransformComponent>

A Transform Component includes a Component Signature, including a special Source Parameter, and a Transform Body.

Source Parameter

<xcl:Parameter name=‘source’>

There is a predefined parameter in each Transform, that represents the source.

Transform Body

The Transform Body contains an XSLT style sheet minus the enclosing:

<xsl:stylesheet>

tag. This Transform Body can contain XCL elements along with other XML elements. These elements will be executed.

Transform Annotation

<xcl:Rule name=‘identifier1’>

. . . signature instantiation . . .

. . . optional inline XSLT Body . . .

</xcl:Rule>

Queries are executed through the Annotation syntax. They include an instantiated Component Signature, and a potential inline Transform Body.

XCL Swatch

The XCL swatch represents a an arbitrary parameterized XML fragment.

Swatch Component

<xcl:SwatchComponent name=‘identifier1’>

. . . signature . . .

. . . Swatch Body . . .

</xcl:SwatchComponent>

Swatch Body

<xcl:Body name=‘identifier1’>

. . . arbitrary XML . . .

</xcl:Body>

The Swatch Body is assumed to be any well formed XML fragment. 97

Swatch Annotation

<xcl:Rule name=‘identifier1’>

. . . signature instantiation . . .

. . . optional inline Swatch Body . . .

</xcl:Rule>

Swatches are executed through the Annotation syntax. They include an instantiated Component Signature, and a potential inline Swatch Body.

XCL White Space

XML is a language that by default treats white-space as non-ignorable. This is called white-space preservation. XCL libraries are space preserving. They are also designed to be supportive of readable code. That means when a construct like:

<xcl:Variable name=‘coltrane’>

This is some text

</xcl:Variable>

is parsed, the variable ‘coltrane’ does not contain the string:

“This is some text”

but rather contains:

“\n\tThis is some text\n”

If you want it to contain the former string you would have to write:

<xcl:Variable name=‘coltrane’>This is some text</xcl:Variable>

This is very appropriate behavior for XML as it is not at all obvious when white space is a ‘read-ability’ artifact or a ‘content’ artifact. This does not look that bad. However if you make a more complex potentially deeply nested statement such as:

<xcl:Swatch name=‘coltrane’>

<xcl:Parameter name=‘miles’/>

<xcl:Rule name=‘corea’>

<xcl:Parameter name=‘byrd’>

this is a long line that needs no white space at either
end

</xcl:Parameter>

</xcl:Rule>

</xcl:Parameter>

</xcl:Swatch>

Then it might be very important to be allowed to ‘readability’ white space liberally without having it effect content. To make it even more trick, any given XCL construct can be sensitive or not to white-space depending on what it is. For instance the XCL snippet:

<xcl:SwatchComponent name=‘dizzy’>

<xcl:Variable name=‘miles’>

<data> lkjhsdfg <data>

</xcl:Variable>

<xcl:Swatch>

Does not care about white-space between the swatch annotation ‘dizzy’ and the variable ‘miles’. Ideally control over how XCL treats white space within its libraries is desired. This is indeed possible and the applicable construct looks like the following:

<xcl:Construct1 trim=‘cabv’>

<xcl:Construct2 trim=‘cabv’ />

</xcl:Construct1>

or the following:

<xcl:Construct1 trim=‘cabv’>

<nonxcl:Construct2 xcl:trim=‘cabv’/>

</xcl:Construct1>

Note that in the first form, the inner construct2 since it is an XCL construct, used the default namespace meaning that the ‘trim’ attribute name is used. In the latter form where the inner construct2 is not an XCL construct, the fully qualified ‘xcl:trim’ attribute name is used. The semantics of this construct are divided into four rules of which any or all can be applied by adding the appropriate letter to the attribute value in any order.

Content Trimming Rule

The first semantic rule is enabled when the letter ‘c’ or ‘C’ are extent in the trim attribute value. This rule is called content trimming. This means that for the applicable construct, the ignorable white space on either end of the XML contained within it is trimmed. An example of this is:

<xcl:Variable name=‘lionel’ trim=‘c’>

<el/>

</xcl:Construct1>

which after processing would be equivalent to writing:

<xcl:Variable name=‘lionel’><el/></xcl:Variable>

which many would say is more readable.

Before Trimming Rule

The second semantic rule is enabled when the letter ‘b’ or ‘B’ are extent in the trim attribute value. This rule is called before trimming. This means that for the applicable construct, the ignorable white space before it is trimmed. An example of this is:

<xcl:Variable name=‘cannonball’>

<xcl:Rule trim=‘b’/>

</xcl:Construct1>

which after processing would be equivalent to writing:

<xcl:Variable name=‘lionel’><xcl:Rule/>

</xcl:Variable>

After Trimming Rule

The third semantic rule is enabled when the letter ‘a’ or ‘A’ are extent in the trim attribute value. This rule is called after trimming. This means that for the applicable construct, the ignorable white space after it is trimmed. An example of this is:

<xcl:Variable name=‘cannonball’>

<xcl:Rule trim=‘a’/>

</xcl:Construct1>

which after processing would be equivalent to writing:

<xcl:Variable name=‘lionel’>

<xcl:Rule/></xcl:Variable>

Value Trimming Rule

The fourth semantic rule is enabled when the letter ‘v’ or ‘V’ are extent in the trim attribute value. This rule is called after trimming. This means that for the applicable construct, the ignorable white space after it is trimmed. An example of this is:

<xcl:Variable name=‘cannonball’>

<xcl:Rule trim=‘a’/>

</xcl:Construct1>

which after processing would be equivalent to writing:

<xcl:Variable name=‘lionel’>

<xcl:Rule/></xcl:Variable>.

9. XCL User Interface

The XCL API has a set of language constructs and run-time mechanisms that support the ability to write thin client user interfaces with full support from a unique XML based component language.

XCL Widget

XCL supports its own form of Widgets which are defined to be visual elements that support the display of, and interaction with, scalar data. There are actually only three base primitives: TextField Widget, Editor Widget, and Select Widget. There are however several derived syntactic sugar versions of the above: Button Widget and Checkbox Widget. The syntactic sugar versions are literally subtypes of the base primitives.

Binding Clause

<xcl:Binding>

<xcl:Query resource=“http://www. infocanvas.com/Process-container/data.xml”>

//playsBass

</xcl:Query>

</xcl:Binding>

Common to all widgets is a binding clause. This clause establishes the data source and sink for the widget.

Sink and Source Binding

Bindings are used to express data-source and data-sink behaviors. Data-source behaviors are where the associated Widget gets it's visualized value from. Data-sink behaviors are where interactive updates to the visualized widget are used to update some XML nodes somewhere.

Query Bindings

If the interior of Binding clause is an XCL query, then special sink and source behaviors are provided. The query binding is bidirectional meaning that the widget is initialized to the result of the query, and any updates to the widget are directed back to the nodes representing the results of the query. The widget will be visually updated any time the query is executed.

Non-Query Bindings

If the interior of Binding clause is an not an XCL query, then only source behaviors are provided. In this case, the widget is always initialized to the interior of its binding. The widget will be visually updated any time the interior XCL is executed.

TextField Widget

<xcl:TextField>

<xcl:Binding> . . . xcl . . . </xcl:Binding>

</xcl:TextField>

The TextField widget is used to allow one-line text field text editing.

Editor Widget

<xcl:Editor>

<xcl:Binding> . . . xcl . . . </xcl:Binding>

</xcl:Editor>

The Editor widget is used to allow multi-line text or html markup editing.

Select Widget

<xcl:Select

metaphor=“buttongroupllistboxldropdown”

selection=“singlelmultiple”>

<xcl:Binding> . . . binding . . . </xcl:Binding>

<xcl:ActionSet> . . . actions . . . </xcl:ActionSet>

</xcl:Select>

The Select widget is the way that XCL models a visualized set of choices and allows data binding and expressive data sink flexibility. At the top level a Select includes a binding and an ActionSet.

Selection Mode

Select widgets have the option to allow single or multiple selection modes. Single Select mode means that within the Actions clause only the result of a single Action can be enabled at one time. In the multiple mode, more than one action can be enabled simultaneously.

Selection Metaphor

The Select widget has a number of selection metaphors. These metaphors define how a set of actions are visualized.

buttongroup: A set of actions that are visualized as buttons.

listbox: A set of actions that are visualized as a listbox.

dropdown: A set of actions that are visualized as a dropdown.

ActionSet

<xcl:ActionSet>

. . . combination of actions, labels, and HTML markup . . .

</xcl:ActionSet>

An ActionSet is a clause that contains Actions, Labels, and potentially HTML markup. It defines the actions that a Select provides along with directives about associated visual cueing and organization.

Action

<xcl:Action metaphor=“checkbox|radiobutton|image”>

. . . values associated with various states of the action . . .

</xcl:Action>

A Widget Action is a combination of the following: a visual cue of a particular metaphor for a specific interaction option in the select and/or a Value or set of Values associated with various states in the Action. These together represent an action that a user can ‘choose’ to take, the visual changes associated with choosing that action, and the resultant updates to the bound data.

ActionState

<xcl:ActionState state=‘state’>

. . . update value associated with this state . . .

</xcl:ActionState>

<xcl:ActionState state=‘state’>

. . . update value associated with this state . . .

</xcl:ActionState>

The ActionState clause is designed to associate different visual and update values with different states that an Action can be in. These states have well defined default and specifiable behaviors. Each Action can be assumed to be in exactly one of its States at a time. The value associated with a State, can be any sort of XML fragment, including plain text (a common mode for simple select scenarios).

ActionState State

Each ActionState has either an implicit or explicit state associated with it. If these states are explicit then there is an attribute called ‘state’ associated with it that determines this state value. If the state is implicit then default values are assumed based on the document ordering of the particular ActionState within the parent Action. The set of appropriate state values for a set of ActionState instances within an Action can be specified in a number of ways: a contiguous integer set starting from 0 and going to a number N that specified the order of ActionState instances to be visually cued and/or as a set of identifiers associated with the states of a given Action metaphor.

Action Metaphor

Each action has a metaphor associated with it. This controls both interaction and ActionState semantics for the Action. The current set of metaphors is:

checkbox: a HTML checkbox is displayed. There are exactly two possible states, the first state being visually cued as unchecked, the second state as checked. As a default if no ActionState clauses are inserted the update bindings will be ‘false’ and ‘true’ respectively.

image: a set of HTML images are displayed. There are an unlimited number of states associated with an unlimited number images. This is used to do the ‘multistate button’.

radiobutton: a HTML radiobutton is displayed. There are exactly two possible states, the first state being visually cued as enabled, the second state as disabled. Action states are specified to determine the update values.

Label
<!- ################################### −>
<!- label associate with an ActionState −>
<!- ################################### −>
<xcl:ActionState>

<xcl:Label>

<img src=‘../images/false.gif’/>

</xcl:Label>
...update value...

</xcl:ActionState>
<!- ################################### −>
<!- label associate with an Action −>
<!- ################################### −>
<xcl:Action>

<xcl:Label>guitar</xcl:Label>
<xcl:ActionState>...update value...</xcl:ActionState>
<xcl:ActionState>...update value...</xcl:ActionState>

</xcl:Action>
To support Select clauses, a Label clause is provided. This clause informs
the Select clause that some sort of label is associated with an Action or
an ActionState.
ActionSet XML markup
<xcl:ActionSet>

<table>

<tr>

<td>

<xcl:Action>

<xcl:ActionState>

<bass selected=“true”></bass>

</xcl:ActionState>
<xcl:ActionState>

<bass selected=“false”></bass>

</xcl:ActionState>

</xcl:Action>

</td>
<td>

<xcl:Action metaphor=“radioButton”>

<xcl:ActionState>

<guitar selected=“true”></guitar>

</xcl:ActionState>
<xcl:ActionState>

<guitar selected=“false”></guitar>

</xcl:ActionState>

</xcl:Action>

</td>
<td>

<xcl:Action metaphor=“radioButton”>

<xcl:ActionState>

<drums selected=“true”></drums>

</xcl:ActionState>
<xcl:ActionState>

<drum selected=“false”></drums>

</xcl:ActionState>

</xcl:Action>

</td>

</tr>

</table>

</xcl:ActionSet>

ActionSets support the concept of intermixed XML markup including HTML and XCL elements. This mode is supported for the select ‘buttongroup’ metaphor. With advances in HTML or in the Browser Model this mode may be supported for other metaphors.

Button Widget

<xcl:Button eventMap=“browserEvent:named-event;”>

click here

</xcl:Button>

<xcl: Button eventMa p=“browserEvent:named-event;”>

<img src=‘imageURL’/>

</xcl:Button>

The XCL button is actually a syntactic sugar version of one particular Select clause scenario. It presents the enclosed HTML that when actuated (receives a user stimulus), sources a Named-event via the Browser event source eventMap clause.

Checkbox Widget

<xcl:Checkbox>.

<xcl:Query resource=“http://www.infocanvas.com/Process-container/data.xml”>

//plays Bass

</xcl:Query>

</xcl:Checkbox>

The XCL checkbox is also a syntactic sugar version of one particular Select widget scenario.

XCL Collection

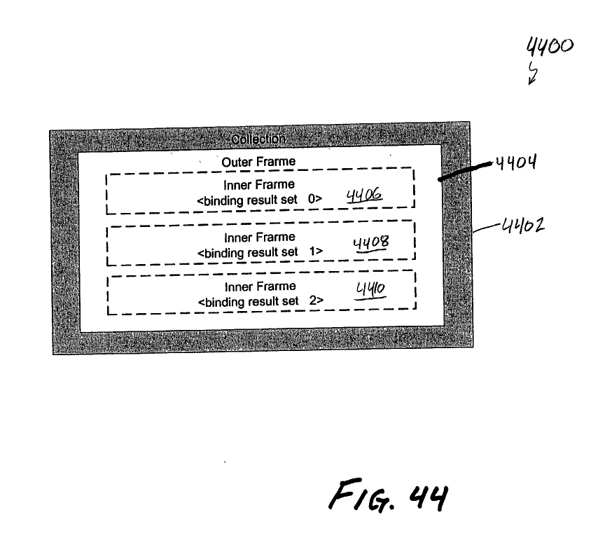

Turning to FIG. 44, collections are XCL user interface constructs that support the visual presentation and interaction with XML node sets. These are usually the result of XCL queries that return more than one result node, but can easily contain any form of XML.

<xcl:Collection>

<xcl:Binding> . . . some data-source/data-sink . . . <xcl:Binding>

<xcl:Layout> . . . some layout XCL . . . </xcl:Layout>

<xcl:Rows>2</xcl:Rows>

</xcl:Collection>

Data Binding

<xcl:Binding>

<xcl:Query context=“employees”>

employees/employee

</xcl:Query>

<xcl:Binding>

The Binding clause in a Collection construct is used to bind the collection to some data. Usually this is a query, in which case special events are handled to support updates, or this is some other arbitrary XCL in which case, the Data Binding is only to support the data-source binding for this collection. In this latter case, it is presumed that the data-sink or update binding is either not necessary or supported in custom manners.

Layout

<xcl:Layout>

<xcl:Transform name=“employeeTransform”/>

</xcl:Layout>

Special Collection Events

xcl:query:movefirst: subscribe to xcl:query:movefirst allows query catch the move first event fired by the collection tool bar.

xcl:query:movelast: subscribe to xcl:query:movelast allows query catch the move last event fired by the collection tool bar.

xcl:query:moveprevious:subscribe to xcl:query:moveprevious allows query catch the move previous event fired by the collection tool bar.

xcl:query:movenext: subscribe to xcl:query:movenext allows query catch the move next event fired by the collection tool bar.

xcl:query:delete: subscribe to xcl:query:delete allow querys catch the delete event fired by the collection tool bar.

xcl:query:insert: subscribe to xcl:query:insert allow querys catch the insert event fired by the collection tool bar.

xcl:query:nextpage: subscribe to xcl:query:nextpage allow querys catch the next page event fired by the collection tool bar.

xcl:query:previouspage: subscribe to xcl:query:previouspage allow querys catch the previous page event fired by the collection tool bar.

XCL Style

The XCL language supports the use of Presentation Styles based on standard Cascading Style Sheets (CSS).

XCL Navigate

<xcl:Navigate trigger=‘named-event-list’ frame=‘identifier’>

. . . XCL to place into the identified frame . . .

</xcl:Navigate>

<xcl:Navigate trigger=‘named-event-list’ window=‘identifier’>. 109

. . . XCL to place into the identified window . . .

</xcl: Navigate>

The XCL language supports a special form of Anchor called a Navigate, that acts mostly like an anchor but has special semantics for the Process-container Environment.

XCL Window

<xcl:Window name=‘identifier’>

. . . more XCL but in a different window . . .

</xcl:Window>

The XCL language supports the use HTML Windows, with special semantics for the Process-container Environment.

XCL Frame

<xcl:Frame name=‘identifier’>

. . . more XCL but in a different frame . . .

</xcl:Frame>

The XCL language supports the use standard HTML Frames, with special semantics for the Process-container Environment.

Widget Examples

Below are a series of example of using widgets in XCL.

Labeled Button

<xcl:Button eventMap=“onClick:myRule;”>

click here

</xcl:Button>

This button provides a clickable text label.

Image Button

<xcl:Button eventMap=“onClick:myRule;”>

<img src=‘ . . . /images/myButtonGif’/>

</xcl:Button>

This button provides a clickable image.

TextField

<xcl:TextField>

<xcl:Binding>

<xcl:Query resource=“http://www.infocanvas.com/Process-
container/data.xml”>

//playsBass

</xcl:Query>

</xcl:Binding>

</xcl:TextField>

This button provides a an editable text field that is input and output bound to a query.

Text Field with Event Mapping

<xcl:TextField eventMap=“onBeforeUnload;”>

<xcl:Binding>

<xcl:Query resource=“http://www.infocanvas.com/Process-
container/data.xml”>

//playsBass

</xcl:Query>

</xcl:Binding>

</xcl:TextField>

This button provides a an editable text field that is input and output bound to a query but the update is only applied when the onBeforeUnload event is fired in the browser.

Stateless Button

<xcl:Select metaphor=“buttonGroup” selection=“stateless”>

<xcl:ActionSet>

<span style=“style1”>click here to do the right thing

<xcl:Action eventMap=“onClick:someRule”></xcl:Action>

</span>

</xcl:ActionSet>

</xcl:Select>

This select statement models a stateless button.

TriState Button

<xcl:Select metaphor=“buttonGroup” selection=“multi”>

<xcl:Binding>

<xcl:Query resource=“http://www.infocanvas.com/Process-
container/data.xml”>

//playsBass

</xcl:Query>

</xcl:Binding>
<xcl:ActionSet>

<xcl:Action metaphor=“custom”>

<xcl:ActionState>

<xcl:Label>

<img src=‘../images/true.gif’/>

</xcl:Label>
<bass selected=“true”></bass>

</xcl:ActionState>
<xcl:ActionState>

<xcl:Label>

<img src=‘../images/false.gif’ />

</xcl:Label>
<bass selected=“false”></bass>

</xcl:ActionState>
<xcl:ActionState>

<xcl:Label type=“gif”>

<img src=‘../images/maybe.gif’ />

</xcl:Label>
<bass selected=“maybe”></bass>

</xcl:ActionState>

</xcl:Action>

</xcl:ActionSet>

</xcl:Select>

This select statement models a tri-state button. This means that the button has a series of states that it can be cycled through, each with its own image to represent it and an update to the binding query of three different values.

Checkbox with Custom States

<xcl:Select metaphor=“buttonGroup” selection=“single”>

<xcl:Binding>

<xcl:Query resource=“http://www.infocanvas.com/Process-
container/data.xml”>

//playsBass

</xcl:Query>

</xcl:Binding>
<xcl:ActionSet>

<xcl:Action metaphor=“checkbox”>

<xcl:ActionState>

<bass selected=“true”></bass>

</xcl:ActionState>
<xcl:ActionState>

<bass selected=“false”></bass>

</xcl:ActionState>

</xcl:Action>

</xcl:ActionSet>

</xcl:Select>

This select statement models a complex checkbox with two custom defined states.

Checkbox (Syntactic Sugar Version)

<xcl:Checkbox>

<xcl:Query resource=“http://www.infocanvas.com/Process-container/data.xml”>

//playsBass

</xcl:Query>

</xcl:Checkbox>

This checkbox is actually a form of select with syntactic sugar to make it easier to write. The binding is updated with true/false.

Select DropDown

<xcl:Select metaphor=“dropdown”>

<xcl:Binding>

<xcl:Query resource=“http://www.infocanvas.com/Process-
container/data.xml”>

//instrumentPlayed

</xcl:Query>

</xcl:Binding>
<xcl:ActionSet>

<xcl:Action>

<xcl:Label>bass</xcl:Label>
<xcl:ActionState>
<bass selected=“true”></bass>

</xcl:ActionState>
<xcl:ActionState>

<bass selected=“false”></bass>

</xcl:ActionState>

</xcl:Action>
<xcl:Action>

<xcl:Label>guitar</xcl:Label>
<xcl:ActionState>

<guitar selected=“true”></guitar>

</xcl:ActionState>
<xcl:ActionState>

<guitar selected=“false”></guitar>

</xcl:ActionState>

</xcl:Action>
<xcl:Action>

<xcl:Label>drums</xcl:Label>
<xcl:ActionState>

<drums selected=“true”></drums>

</xcl:ActionState>
<xcl:ActionState>

<drums selected=“false”></drums>

</xcl:ActionState>

</xcl:Action>

</xcl:ActionSet>

</xcl:Select>

This select statement is the way to implement a complex ‘droplist’. Each action has custom state definitions.

ListBox

<xcl:Select metaphor=“listbox” selection=“multi|single”>

<xcl:Binding>

<xcl:Query resource=“http://www.infocanvas.com/Process-
container/data.xml”>

//instrumentsPlayed

</xcl:Query>

</xcl:Binding>
<xcl:ActionSet>

<xcl:Action>

<xcl:Label>bass</xcl:Label>
<xcl:ActionState>

<bass selected=“true”></bass>

</xcl:ActionState>
<xcl:ActionState>

<bass selected=“false”></bass>

</xcl:ActionState>

</xcl:Action>
<xcl:Action>

<xcl:Label>guitar</xcl:Label>
<xcl:ActionState>

<guitar selected=“true”></guitar>

</xcl:ActionState>
<xcl:ActionState>

<guitar selected=“false”></guitar>

</xcl:ActionState>

</xcl:Action>
<xcl:Action>

<xcl:Label>drums</xcl:Label>
<xcl:ActionState>

<drums selected=“true”></drums>

</xcl:ActionState>
<xcl:ActionState>

<drums selected=“false”></drums>

</xcl:ActionState>

</xcl:Action>

</xcl:ActionSet>

</xcl:Select>

This select statement is an example of a way to implement a ‘listbox’. Each action has custom state definitions.

ButtonGroup with HTML markup

<xcl:Select metaphor=“buttonGroup” selection=“single”>

<xcl:Binding>

<xcl:Query resource=“http://www.infocanvas.com/Process-
container/data.xml”>

//instrumentPlayed

</xcl:Query>

</xcl:Binding>
<xcl:ActionSet>

<table>

<tr>

<td>

<xcl:Action>

<xcl:ActionState>

<bass selected=“true”></bass>

</xcl:ActionState>
<xcl:ActionState>

<bass selected=“false”></bass>

</xcl:ActionState>

</xcl:Action>

</td>
<td>

<xcl:Action metaphor=“radioButton”>

<xcl:ActionState>

<guitar selected=“true”></guitar>

</xcl:ActionState>
<xcl:ActionState>

<guitar selected=“false”></guitar>

</xcl:ActionState>

</xcl:Action>

</td>
<td>

<xcl:Action metaphor=“radioButton”>

<xcl:ActionState>

<drums selected=“true”></drums>

</xcl:ActionState>
<xcl:ActionState>

<drums selected=“false”></drums>

</xcl:ActionState>

</xcl:Action>

</td>

</tr>

</table>

</xcl:ActionSet>

</xcl:Select>

This select statement is the way to implement a ‘radionbutton’. Each action has custom state definitions.

MultiState Multiple Buttongroup

<xcl:Select metaphor=“buttonGroup” selection=“multi”>

<xcl:Binding>

<xcl:Query resource=“http://www.infocanvas.com/Process-
container/data.xml”>

//shoppingBasket

</xcl:Query>

</xcl:Binding>
<xcl:ActionSet>

<xcl:Action>

<xcl:ActionState>

<xcl:Label>

<img src=‘../images/zilch.gif’ />

</xcl:Label>

</xcl:ActionState>
<xcl:ActionState>

<xcl:Label>

<img src=‘../images/basses1.gif’ />

</xcl:Label>
<bass mfgr=“fender”></bass>

</xcl:ActionState>
<xcl:ActionState>

<xcl:Label>

<img src=‘../images/basses2.gif’ />

</xcl:Label>
<bass mfgr=“ibanez”></bass>

</xcl:ActionState>
<xcl:ActionState>

<xcl:Label>

<img src=‘../images/basses3.gif’ />

</xcl:Label>
<bass mfgr=“stradivarius”></bass>

</xcl:ActionState>

</xcl:Action>
<xcl:Action>

<xcl:ActionState>

<xcl:Label>

<img src=‘../images/zilch.gif’ />

</xcl:Label>

</xcl:ActionState>
<xcl:ActionState>

<xcl:Label>

<img src=‘../images/guitars1.gif’ />

</xcl:Label>
<guitar mfgr=“fender”></guitar>

</xcl:ActionState>
<xcl:ActionState>

<xcl:Label>

<img src=‘../images/guitars2.gif’ />

</xcl:Label>
<guitar mfgr=“ibanez”></guitar>

</xcl:ActionState>
<xcl:ActionState>

<xcl:Label>

<img src=‘../images/guitars3.gif’ />

</xcl:Label>
<guitar mfgr=“stradivarius”></guitar>

</xcl:ActionState>

</xcl:Action>
<xcl:Action>

<!−notice: no action label−>
<xcl:ActionState>

<xcl:ActionState>

<xcl:Label>

<img src=‘../images/zilch.gif’ />

</xcl:Label>

</xcl:ActionState>
<xcl:Label>

<img src=‘../images/drums1.gif’ />

</xcl:Label>
<drums mfgr=“gretsch”></drums>

</xcl:ActionState>
<xcl:ActionState>

<xcl:Label>

<img src=‘../images/drums2.gif’ />

</xcl:Label>
<drums mfgr=“tama”></drums>

</xcl:ActionState>
<xcl:ActionState>

<xcl:Label>

<img src=‘../images/drums3.gif’ />

</xcl:Label>
<drums mfgr=“sears”></drums>

</xcl:ActionState>

</xcl:Action>

</xcl:ActionSet>

</xcl:Select>

This select statement is an example implementation of a multi-state button. Note that it is much simpler than the functional equivalent logic if written in JavaScript.

Editor 1

<xcl:Editor>

<xcl:Binding>

<xcl:Query resource=“http://www.infocanvas.com/Process-
container/data.xml”>

//playsBass

</xcl:Query>

</xcl:Binding>

</xcl:Editor>

This simple editor statement enables a multiple line editor like text area.

Editor 2

<xcl:Editor eventMap=“onBeforeUnload”>

<xcl:Binding>

<xcl:Query resource=“http://www.infocanvas.com/Process-container/data.xml”>

//playsBass

</xcl:Query>

</xcl:Binding>

</xcl:Editor>

This simple editor statement enables a multiple line editor like text area that only updates right before the unload event.

10. Javascript API

The JavaScript Process-container model is a set of ECMAscript objects provided to support the XCL Rule JavaScript programming model. The Engine supports edition 3 of ECMAScript, corresponding to JavaScript 1.5. The Script API starts with a set of global JavaScript functions:

Current Component Scope

XclComponent getCurrentComponent( )

This function accesses the current component scope.

Current Document

XclDocument getCurrentDocument( )

This function accesses the current document scope.

Current Library

XclLibrary getCurrentLibrary( )

This function accesses the current library scope.

Fetch Library

XclLibrary getLibrary(URL library)

This function accesses a library by VURL.

Create Query

XclQuery newQuery( )

This function creates a new XclQuery.

DOM Level II Bindings

The JavaScript API supports interaction with the presentation, logic, and data layers of the Process-container via a full W3 DOM level II JavaScript bindings. The following objects are defined as part of this DOM binding set: XclDOMString, XclDOMTimeStamp, XclDOMImplementation, XclDocumentFragment, XclDocument, XclNode, XclNodeList, XclNamedNodeMap, XclCharacterData, XclAttr, XclElement, XclText, XclComment, XclCDATASection, XclDocumentType, XclNotation, XclEntity, XclEntityReference, and XclProcessingInstruction.

XclDOMString

A DOMString is a sequence of 16-bit units. Applications must encode DOMString using UTF-16 (defined in [Unicode] and Amendment 1 of [ISO/IEC 10646]). The UTF-16 encoding was chosen because of its widespread industry practice. Note that for both HTML and XML, the document character set (and therefore the notation of numeric character references) is based on UCS [ISO-10646]. A single numeric character reference in a source document may therefore in some cases correspond to two 16-bit units in a DOMString (a high surrogate and a low surrogate). Even though the DOM defines the name of the string type to be DOMString, bindings may use different names. For example for Java, DOMString is bound to the String type because it also uses UTF-16 as its encoding. As of August 1998, the OMG IDL specification included a wstring type. However, that definition did not meet the interoperability criteria of the DOM API since it relied on negotiation to decide the width and encoding of a character.

XclDOMTimeStamp

A DOMTimeStamp represents a number of milliseconds. Even though the DOM uses the type DOMTimeStamp, bindings may use different types. For example for Java, DOMTimeStamp is bound to the long type. In ECMAScript, TimeStamp is bound to the Date type because the range of the integer type is too small.

XclDOMImplementation

The XclDOMImplementation interface provides a number of methods for performing operations that are independent of any particular instance of the document object model. The DOMlmplementation object has the following methods:

boolean hasFeature( ) method

boolean hasFeature(XclDOMString feature, XclDOMString version)

createDocumentType( ) method

XclDocumentType createDocumentType(

XclDOMString qualifiedName,

XclDOMString publicid,

XclDOMString systemid

)

createDocument method( ) method

XclDocument createDocument(namespaceURI, qualifiedName, doctype)

XclDocumentFragment

XclDocumentFragment is a “lightweight” or “minimal” Document object. It is very common to want to be able to extract a portion of a document's tree or to create a new fragment of a document. Imagine implementing a user command like cut or rearranging a document by moving fragments around. It is desirable to have an object which can hold such fragments and it is quite natural to use a Node for this purpose. While it is true that a Document object could fulfill this role, a Document object can potentially be a heavyweight object, depending on the underlying implementation. What is really needed for this is a very lightweight object. XclDocumentFragment is such an object. Furthermore, various operations, such as inserting nodes as children of another Node, may take XclDocumentFragment objects as arguments; this results in all the child nodes of the XclDocumentFragment being moved to the child list of this node. The children of a XclDocumentFragment node are zero or more nodes representing the tops of any sub-trees defining the structure of the document. XclDocumentFragment nodes do not need to be well-formed XML documents (although they do need to follow the rules imposed upon well-formed XML parsed entities, which can have multiple top nodes). For example, a XclDocumentFragment might have only one child and that child node could be a Text node. Such a structure model represents neither an HTML document nor a well-formed XML document. When a XclDocumentFragment is inserted into a Document (or indeed any other Node that may take children) the children of the XclDocumentFragment and not the XclDocumentFragment itself are inserted into the Node. This makes the XclDocumentFragment very useful when the user wishes to create nodes that are siblings; the XclDocumentFragment acts as the parent of these nodes so that the user can use the standard methods from the Node interface, such as insertBefore and appendChild. XclDocumentFragment has the all the properties and methods of XclNode as well as the properties and methods defined below.

XclDocument

The XclDocument interface represents the entire HTML or XML document. Conceptually, it is the root of the document tree, and provides the primary access to the document's data. Since elements, text nodes, comments, processing instructions, etc. cannot exist outside the context of a Document, the XclDocument interface also contains the factory methods needed to create these objects. The Node objects created have a ownerDocument attribute which associates them with the XclDocument within whose context they were created. XclDocument has the all the properties and methods of Node as well as the properties and methods defined below.

doctype property

XclDocumentType doctype;

The Document Type Declaration (see XclDocumentType) associated with this document. For HTML documents as well as XML documents without a document type declaration this returns null. The DOM Level 2 does not support editing the Document Type Declaration, therefore docType cannot be altered in any way, including through the use of methods, such as insertNode or removeNode, which are inherited from the Node interface.

implementation property

XclDomimplementation implementation;

The XclDOMImplementation object that handles this document. A DOM application may use objects from multiple implementations.

documentElement property

XclElement documentElement;

This is a convenience attribute that allows direct access to the child node that is the root element of the document. For HTML documents, this is the element with the tagName “HTML”.

createElement( ) method

XclElement createElement(XclDOMString tag Name)

createDocumentFragment( ) method

XclDocumentFragment createDocumentFragment( )

createTextNode( ) method

XclText createTextNode(XclDOMString data)

createComment(data) method

XclComment createComment(XclDOMString data) method

createCDATASection(data) method

XclCDATASection createCDATASection(XclDOMString data) method

createprocessinginstruction( ) method

XclProcessing Instruction createProcessing Instruction(

XclDOMString target,

XclDOMString data

)

createAttribute( ) method

XclAftr createAttribute(XclDOMString name)

Creates an Attr of the given name. Note that the Attr instance can then be set on an Element using the setAttributeNode method. To create an attribute with a qualified name and namespace URI, use the createAttributeNS method. This method returns a new Attr object with the nodeName attribute set to name, and localName, prefix, and namespaceURI set to null.

createEntityReference( ) method

XclEntityReference createEntityReference(XclDOMString name)

getElementsByTagName( ) method

XclNodeList getElementsByTagName(XclDOMString tagname)

importNode( ) method

XclNode importNode(XclNode importedNode, boolean deep)

createElementNS( ) method

XclElement createElementNS(

XclDOMString namespaceURI,

XclDOMString qualifiedName

)

createAttributeNS( ) method

XclAttr createAttributeNS(

XclDOMString namespaceURI,

XclDOMString qualifiedName

)

getElementsByTagNameNS( ) method

XclNodeList getElementsByTagNameNS(

XclDOMString namespaceURI, XclDOMString localName

)

getElementByid( ) method

XclElement getElementByid(XclDOMString elementid)

parseXMLString( ) method

XclNode parseXMLString(String xml)

This is a Process-container specific extension to DOM level 2.

XclNode

The XclNode interface is the primary datatype for the entire Xcl Document Object Model. It represents a single node in the document tree. While all objects implementing the XclNode interface expose methods for dealing with children, not all objects implementing the XclNode interface may have children. For example, XclText nodes may not have children, and adding children to such nodes results in a DOMException being raised. The attributes nodeName, nodeValue and attributes are included as a mechanism to get at node information without casting down to the specific derived interface. In cases where there is no obvious mapping of these attributes for a specific nodeType (e.g., nodeValue for an XclElement or attributes for a XclComment), this returns null. Note that the specialized interfaces may contain additional and more convenient mechanisms to get and set the relevant information.

Constants

The XclNode class has the following constants:

XclNode.ELEMENT_NODE: This constant is of type short and its value is 1.

XclNode.ATTRIBUTE_NODE: This constant is of type short and its value is 2.

XclNode.TEXT_NODE: This constant is of type short and its value is 3.

XclNode.CDATA_SECTION_NODE: This constant is of type short and its value is 4.

XclNode.ENTITY REFERENCE NODE: This constant is of type short and its value is 5.

XclNode.ENTITY_NODE: This constant is of type short and its value is 6.

XclNode.PROCESSING INSTRUCTION NODE: This constant is of type short and its value is 7.

XclNode.COMMENT NODE: This constant is of type short and its value is 8.

XclNode.DOCUMENT_NODE: This constant is of type short and its value is 9.

XclNode.DOCUMENT TYPE NODE: This constant is of type short and its value is 10.

XclNode.DOCUMENT FRAGMENT NODE: This constant is of type short and its value is 11.

XclNode.NOTATION_NODE: This constant is of type short and its value is 12.

nodeName property

String nodeName

nodeValue property

String nodeValue

nodeType property

short nodeType

parentNode property

XclNode parentNode

childNodes property

XclNodeList childNodes

firstChild property

XclNode firstChild

lastChild property

XclNode lastChild

previousSibling property

XclNode previoussibling

nextSibling property

XclNode nextSibling

attributes property

XclNamedNodeMap attributes

ownerDocument property

XclDocument ownerDocument

namespaceURI property

String namespaceURI

prefix property

String prefix

localName property

String localName

insertBefore( ) method

XclNode insertBefore(XclNode newChild, XclNode refChild)

replaceChild( ) method

XclNode replaceChild(XclNode newChild, XclNode oldChild)

removeChild( ) method

XclNode removeChild(XclNode oldChild)

appendChild( ) method

XclNode appendChild(XclNode newchild)

hasChildNodes( ) method

boolean hasChildNodes( )

cloneNode(deep) method

XclNode cloneNode(boolean deep)

normalize( ) method

void normalize( )

supports(feature, version)

boolean supports(XclDOMString feature, XclDOMString version)

XclNodeList

The NodeList interface provides the abstraction of an ordered collection of nodes, without defining or constraining how this collection is implemented. NodeList objects in the DOM are live. The items in the NodeList are accessible via an integral index, starting from 0.

length property

int length

item( ) method

XclNode item(unsigned long index)

The index parameter is of type unsigned long. This object can also be differentiated using square bracket notation (e.g. obj[1]). Differentiating with an integer index is equivalent to invoking the item method with that index.

XclNamedNodeMap

Objects implementing the NamedNodeMap interface are used to represent collections of nodes that can be accessed by name. Note that NamedNodeMap does not inherit from NodeList; NamedNodeMaps are not maintained in any particular order. Objects contained in an object implementing NamedNodeMap may also be accessed by an ordinal index, but this is simply to allow convenient enumeration of the contents of a NamedNodeMap, and does not imply that the DOM specifies an order to these Nodes. NamedNodeMap objects in the DOM are live.

length property

int length

getNameditem( ) method

XclNode getNamedltem(XclDOMString name)

setNameditem( ) method

XclNode setNamedltem(XclNode arg)

removeNameditem( ) method

XclNode removeNameditem(XclDOMString name)

item( ) method

XclNode item(unsigned long index)

This object can also be differentiated using square bracket notation (e.g. obj[1]). Differentiating with an integer index is equivalent to invoking the item method with that index.

getNameditemNS( ) method

XclNode getNamedltemNS(XclDOMString namespaceURI, XclDOMString localName)

setNameditemNS( ) method

XclNode setNamedltemNS(XclNode arg)

removeNameditemNS( ) method

XclNode removeNamedltemNS(

XclDOMString namespaceURI,

XclDOMString localName

)

XclCharacterData

The CharacterData interface extends Node with a set of attributes and methods for accessing character data in the DOM. For clarity this set is defined here rather than on each object that uses these attributes and methods. No DOM objects correspond directly to CharacterData, though Text and others do inherit the interface from it. All offsets in this interface start from 0. As explained in the DOMString interface, text strings in the DOM are represented in UTF-16, i.e. as a sequence of 16-bit units. In the following, the term 16-bit units is used whenever necessary to indicate that indexing on CharacterData is done in 16-bit units. CharacterData has the all the properties and methods of Node as well as the properties and methods defined below.

data property

String data

length property

int length

substringData( ) method

XclDOMString substringData(unsigned long offset, unsigned long count)

appendData( ) method

void appendData(XclDOMString arg)

insertData( ) method

void insertData(unsigned long offset, unsigned long arg)

deleteData( ) method

void deleteData(unsigned long offset, unsigned long count)

replaceData( ) method

void replaceData(

unsigned long offset,

unsigned long count,

unsigned long arg

)

XclAttr

The Attr interface represents an attribute in an Element object. Typically the allowable values for the attribute are defined in a document type definition. Attr objects inherit the Node interface, but since they are not actually child nodes of the element they describe, the DOM does not consider them part of the document tree. Thus, the Node attributes parentNode, previousSibling, and nextsibling have a null value for Attr objects. The DOM takes the view that attributes are properties of elements rather than having a separate identity from the elements they are associated with; this should make it more efficient to implement such features as default attributes associated with all elements of a given type. Furthermore, Attr nodes may not be immediate children of a XclDocumentFragment. However, they can be associated with Element nodes contained within a XclDocumentFragment. In short, users and implementers of the DOM need to be aware that Attr nodes have some things in common with other objects inheriting the Node interface, but they also are quite distinct. The attribute's effective value is determined as follows: if this attribute has been explicitly assigned any value, that value is the attribute's effective value; otherwise, if there is a declaration for this attribute, and that declaration includes a default value, then that default value is the attribute's effective value; otherwise, the attribute does not exist on this element in the structure model until it has been explicitly added. Note that the nodevalue attribute on the Attr instance can also be used to retrieve the string version of the attribute's value(s).

In XML, where the value of an attribute can contain entity references, the child nodes of the Attr node provide a representation in which entity references are not expanded. These child nodes may be either Text or EntityReference nodes. Because the attribute type may be unknown, there are no tokenized attribute values. Attr has the all the properties and methods of Node as well as the properties and methods defined below.

name property

String name

specified property

boolean specified

value property

String value

ownerElement property

XclElement ownerElement

XclElement

The XclElement interface represents an element in an HTML or XML document. Elements may have attributes associated with them; since the XclElement interface inherits from XclNode, the generic XclNode interface attribute attributes may be used to retrieve the set of all attributes for an element. There are methods on the XclElement interface to retrieve either an XclAttr object by name or an attribute value by name. In XML, where an attribute value may contain entity references, an XclAttr object should be retrieved to examine the possibly fairly complex sub-tree representing the attribute value. On the other hand, in HTML, where all attributes have simple string values, methods to directly access an attribute value can safely be used as a convenience. In DOM Level 2, the method normalize is inherited from the Node interface where it was moved. Element has the all the properties and methods of Node as well as the properties and methods defined below.

tagName property

String tagName

getattribute( ) method

XclDOMString getAttribute(XclDOMString name)

setAttribute( ) method

void setAttribute(XclDOMString name, XclDOMString value)

removeAttribute( ) method

void removeAttribute(XclDOMString name)

getAttributeNode( ) method

XclAttr getAttributeNode(XclDOMString name)

setAttributeNode( ) method

XclAftr setAttributeNode(XclAttr newAttr)

removeAttributeNode( ) method

XclAttr removeAttributeNode(XclAttr oldAttr)

getElementsByTagName( ) method

XclNodeList getElementsByTagName(XclDOMString name)

getAttributeNS( ) method

XclDOMString getAffributeNS(

XclDOMString namespaceURI,

XclDOMString localName

)

setAttributeNS( ) method

void setAttributeNS(

XclDOMString namespaceURI,

XclDOMString qualifiedName,

XclDOMString value

)

removeAttributeNS( ) method

void removeAttributeNS(

XclDOMString namespaceURI,

XclDOMString localName

)

getAttributeNodeNS( ) method

XclAttr getAttributeNodeNS(

XclDOMString namespaceURI,

XclDOMString localName

)

setAttributeNodeNS( ) method

XclAttr setAttributeNodeNS(XclAttr newAttr)

getElementsByTagNameNS( ) method

XclNodeList getElementsByTagNameNS(

XclDOMString namespaceURI,

XclDOMString localName

)

hasAttribute( ) method

boolean hasAttribute(XclDOMString name)

hasAttributeNS( ) method

boolean hasAttributeNS(

XclDOMString namespaceURI,

XclDOMString localName

)

XclText

The XclText interface inherits from XclCharacterData and represents the textual content (termed character data in XML) of an XclElement or XclAttr. If there is no markup inside an element's content, the text is contained in a single object implementing the XclText interface that is the only child of the element. If there is markup, it is parsed into the information items (elements, comments, etc.) and XclText nodes that form the list of children of the element. When a document is first made available via the DOM, there is only one XclText node for each block of text. Users may create adjacent XclText nodes that represent the contents of a given element without any intervening markup, but should be aware that there is no way to represent the separations between these nodes in XML or HTML, so they will not (in general) persist between DOM editing sessions. The normalize( ) method on XclNode merges any such adjacent XclText objects into a single node for each block of text. XclText has the all the properties and methods of XclCharacterData as well as the properties and methods defined below.

splitText( ) method

XclText splitText(unsigned long offset)

XclComment

XclComment has the all the properties and methods of XclCharacterData as well as the properties and methods defined below.

XclCDATASection

CDATA sections are used to escape blocks of text containing characters that would otherwise be regarded as markup. The only delimiter that is recognized in a CDATA section is the “]]>” string that ends the CDATA section. CDATA sections cannot be nested. Their primary purpose is for including material such as XML fragments, without needing to escape all the delimiters. The XclDOMString attribute of the Text node holds the text that is contained by the CDATA section. Note that this may contain characters that need to be escaped outside of CDATA sections and that, depending on the character encoding (“charset”) chosen for serialization, it may be impossible to write out some characters as part of a CDATA section. The XclCDATASection interface inherits from the XclCharacterData interface through the XclText interface. Adjacent XclCDATASections nodes are not merged by use of the normalize method of the XclNode interface. Because no markup is recognized within a CDATASection, character numeric references cannot be used as an escape mechanism when serializing. Therefore, action needs to be taken when serializing a XclCDATASection with a character encoding where some of the contained characters cannot be represented. Failure to do so would not produce well-formed XML. One potential solution in the serialization process is to end the CDATA section before the character, output the character using a character reference or entity reference, and open a new CDATA section for any further characters in the text node. Note, however, that some code conversion libraries at the time of writing do not return an error or exception when a character is missing from the encoding, making the task of ensuring that data is not corrupted on serialization more difficult. CDATASection has the all the properties and methods of Text as well as the properties and methods defined below.

XclDocumentType

Each XclDocument has a doctype attribute whose value is either null or a XclDocumentType object. The XclDocumentType interface in the DOM Core provides an interface to the list of entities that are defined for the document, and little else because the effect of namespaces and the various XML schema efforts on DTD representation are not currently standardized. The DOM Level 2 does not support editing XclDocumentType nodes. XclDocumentType has the all the properties and methods of XclNode as well as the properties and methods defined below.

name property

String name

entities property

XclNamedNodeMap entities

notations property

XclNamedNodeMap notations

publicid property

String publicld

systemid property

String systemId

internalSubset property

String internalSubset

XclNotation

This interface represents a notation declared in the DTD. A notation either declares, by name, the format of an unparsed entity (see section 4.7 of the XML 1.0 specification), or is used for formal declaration of processing instruction targets (see section 2.6 of the XML 1.0 specification). The nodeName attribute inherited from XclNode is set to the declared name of the notation. The DOM Level 1 does not support editing XclNotation nodes; they are therefore read only. A XclNotation node does not have any parent. XclNotation has the all the properties and methods of XclNode as well as the properties and methods defined below.

publicid property

String publicld

systemid property

String systemid

XclEntity

This interface represents an entity, either parsed or unparsed, in an XML document. Note that this models the entity itself not the entity declaration. Entity declaration modeling has been left for a later Level of the DOM specification. The nodeName attribute that is inherited from XclNode contains the name of the entity. An XML processor may choose to completely expand entities before the structure model is passed to the DOM; in this case there will be no XclEntityReference nodes in the document tree. XML does not mandate that a non-validating XML processor read and process entity declarations made in the external subset or declared in external parameter entities. This means that parsed entities declared in the external subset need not be expanded by some classes of applications, and that the replacement value of the entity may not be available. When the replacement value is available the corresponding XclEntity node's child list represents the structure of that replacement text. Otherwise, the child list is empty. The DOM Level 2 does not support editing XclEntity nodes; if a user wants to make changes to the contents of an XclEntity, every related XclEntityReference node has to be replaced in the structure model by a clone of the XclEntity's contents, and then the desired changes must be made to each of those clones instead. XclEntity nodes and all their descendants are read only.

An XclEntity node does not have any parent. If the entity contains an unbound namespace prefix, the namespaceURI of the corresponding node in the XclEntity node subtree is null. The same is true for XclEntityReference nodes that refer to this entity, when they are created using the createEntityReference method of the XclDocument interface. The DOM Level 2 does not support any mechanism to resolve namespace prefixes. XclEntity has the all the properties and methods of XclNode as well as the properties and methods defined below.

publicld property

String publicld

systemId property

String systemid

notationName property

String notationName

XclEntityReference

XclEntityReference objects may be inserted into the structure model when an entity reference is in the source document, or when the user wishes to insert an entity reference. Note that character references and references to predefined entities are considered to be expanded by the HTML or XML processor so that characters are represented by their Unicode equivalent rather than by an entity reference. Moreover, the XML processor may completely expand references to entities while building the structure model, instead of providing XclEntityReference objects. If it does provide such objects, then for a given XclEntityReference node, it may be that there is no XclEntity node representing the referenced entity. If such an XclEntity exists, then the subtree of the XclEntityReference node is in general a copy of the XclEntity node subtree. However, this may not be true when an entity contains an unbound namespace prefix. In such a case, because the namespace prefix resolution depends on where the entity reference is, the descendants of the XclEntityReference node may be bound to different namespace URIs. As for XclEntity nodes, XclEntityReference nodes and all their descendants are read only. EntityReference has the all the properties and methods of XclNode as well as the properties and methods defined below.

XclProcessingInstruction

The XclProcessingInstruction interface represents a “processing instruction”, used in XML as a way to keep processor-specific information in the text of the document. ProcessingInstruction has the all the properties and methods of XclNode as well as the properties and methods defined below.

data property

String data

XclComponent

This is the javascript binding for an XCL Component. It inherits all the properties and methods of XclElement. executes method

XclNodeList executes

executes this component

getName( ) method

String getName( )

Returns the name of the rule, as a String.

setName( ) method

void setName( )

Sets the name of the rule to the specified string.

getParameter( ) method

XclParameter getParameter(String name)

getPublish( ) method

XclPublish getPublish(String name)

getsubscribe( ) method

XclSubscribe getSubscribe( )

getvariable( ) method

XclVariable getVariable(String name)

setParameter( ) method

void setParameter(XclNodeList parameter)

XclLibrary

This is the javascript binding for an XCL Library. It inherits all the properties and methods of XclDocument.

getcomponent( ) method

XclComponent getComponent(String name)

getQuery( ) method

XclQuery getQuery(String name)

getRule( ) method

XclRule getRule(String name)

getswatcho method

XclSwatch getSwatch(String name)

gettransform

XclTransform getTransform(String name)

XclQuery

This JavaScript API supports the interaction with XCL Query. XclQuery has the all the properties and methods of XclComponent as well as the properties and methods defined below.

deleteNode( ) method

public boolean deleteNode(int position)

getCurrentPos( ) method

public int getCurrentPos( )

getResult( ) method

XclNode getResult(int position)

getResultCount( ) method

int getResultCount( )

getResults( ) method

XclNodeList getResults( )

insertNode( ) method

boolean insertNode(XclNode node)

moveFirstChunk( ) method

void moveFirstChunk( )

moveNextChunk( ) method

void moveNextChunk( )

movePreviousChunk( ) method

void movePreviousChunk( )

moveLastChunk( ) method

void moveLastChunk( )

moveFirstltem( ) method

boolean moveFirstitem( )

moveLastitem( ) method

boolean moveLastitem( )

moveNextitem( ) method

boolean moveNextItem( )

movePreviousItem( ) method

boolean movePreviousitem( )

setQueryContext( ) method

void setQueryContext(String contextName)

setQueryResource( ) method

void setQueryResource(String resourceName)

setQueryString( ) method

void setQueryString(String expression)

Sets this query's xpath expression.

XclRule

This is the JavaScript binding for an XCL Rule. It inherits all the properties and methods of XclComponent.

XclSwatch

This is the JavaScript binding for an XCL Swatch. It inherits all the properties and methods of XclComponent.

XclTransform

This is the JavaScript binding for an XCL Transform. It inherits all the properties and methods of XclComponent.

XclVariable

This is the JavaScript binding for an XCL Variable. It inherits all the properties and methods of XclElement.

getValue( ) method

public XclNodeList getvalue( )

setvalue( ) method

public void setValue(XclNodeList value)

getName( ) method

String getName( )

setName( ) method

String setName( )

XclParameter

This is the JavaScript binding for a Component Parameter. It inherits all the properties and methods of XCL Variable.

XclPublish

This is the JavaScript binding for a Publish Variable. It inherits all the properties and methods of XCL Variable.

getarticle( ) method

String getarticle( )

setarticle( ) method

void setArticle(String name)

getpassthrough( ) method

boolean getpassthrough( )

setpassthrough( ) method

boolean setPassthrough(String name)

fire( ) method

void fire( )

getTrigger( ) method

String getTrigger( )

setTrigger( ) method

void setTrigger(String trigger)

XclSubscribe

This is the JavaScript binding for a Subscribe Variable. It inherits all the properties and methods of XCL Variable.

getTrigger( ) method

public String getTrigger( )

setTrigger( ) method

public void setTrigger(String trigger)

XclEvent

The JavaScript API supports the manipulation of XCL Events.

XclWidget

The JavaScript API supports the manipulation of instances of XCL Widget.

XclCollection

The JavaScript API supports the manipulation of instances of XCL Collection.

XclJournal

The JavaScript API supports the manipulation of the Process-container Journal.

Names

The JavaScript API supports the interaction with Java JNDI.

Services

The JavaScript API supports the interaction with any Process-container Service Interface.

HTML Model

The JavaScript API supports the manipulation of HTML within the Page using W3 DOM Level 2 HTML bindings.

XSLT Model

The JavaScript API supports the manipulation of XSLT within the Page using a set of proprietary XSLT bindings.

CSS Model

The JavaScript API supports the manipulation of CSS within the Page HTML using a set of proprietary CSS bindings.

11. Extension API

The Process-container Extensions technology is the way that the Process-container Engine supports extensions of its capabilities through ‘plug-in’ Java implemented functionality. These plugins are based on the Java Servlet interface with special added Process-container Extension semantics.

Permission Installed

One very important characteristic of an Extension is that unlike Process-containers which can arrive in your engine in a highly dynamic manner, Extensions are explicitly downloaded and installed. This means that Extensions can be more powerful than Process-containers without causing any undue security concerns. In fact, unlike Process-containers, standard Java security models are supported that allow an extension to access operating system level network and file i/o, window functionality, etc.

J2EE Conformant

The Extensions environment is expected to have a appropriate level of J2EE conformance guaranteed. This is used to allow Extensions to be designed to run on J2EE compatible platforms and allow the user to use the full J2EE environment if desired with such things as transactional guarantees expressed consistently across the JDBC, EJB, and JMS worlds.

Extension Scenarios

This is to support the following example extension scenarios: Transport Extension, Protocol Extension, Replication Protocol, Tracking Protocol, Database integration, Application integration, Self contained Application, and Analytic Extensions.

Extension Architecture

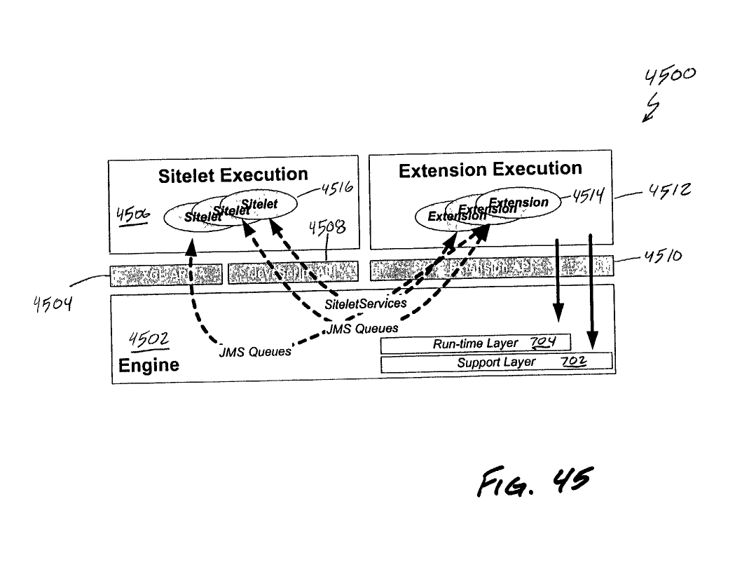

Turning to FIG. 45, the extensions architecture is much like Process-container Execution, but instead of Process-containers being executed, Extensions are being executed. They interact with the Process-container Engine via the Extension API. The Extension API includes the following elements: Extension Objects, Support Layer packages, and Runtime Layer Objects.

Extension as Servlet

All Extensions may be Java HTTP Servlets. This means that they support the Servlet interface. This provides: HTTP request/response processing and lifecycle (startup/shutdown) services.

Extension Lifecycle

Extensions use the Java Servlet interface lifetime services. This means that Extensions are started up when the associated servlet is first brought into scope, and shut-down when the associated servlet leaves scope. Entering scope can happen when the extension is statically installed and the engine is booted, and after the extension is dynamically installed (downloaded) and configured.

Dynamic Extensions

Extensions can be downloaded from the network using standard URLs. When they are down-loaded, they are started up. The first time they are loaded, persistent properties can be set that are used to configure the extension using the Java JNDI interface. This dynamic configuration allows the downloaded Extension to guarantee it is configured properly before it is used.

Extension as Service

All Extensions can also be an instance of Process-container Service Interface. This allows Extensions to provide services to other Extensions as well as executing Process-containers through the JavaScript API.

Extension API

The Extensions API provides access to the following Process-container Engine functionality: the ability to create a Process-container with a specified VURL; the ability to delete a Process-container with a specified VURL; and the ability to clone a Process-container with a specified VURL to create a duplicate Process-container with a different specified VURL.

Extension Objects

The following are the basic Extension objects:

Process-containerExtension

The Process-containerExtension is a subtype of HTTPServlet from the Java Servlet package. This is the class that is subtyped in order to create an implementation of a desired Extension.

Process-containerEngine

The Process-containerEngine is available from the Process-containerExtension, and represents a very high level Extension API specific abstraction of functionality of the Process-container Engine capabilities. These include the Process-container Factory, Process-container Persistence, and Engine Lifecycle.

Process-Container

The Process-container object is an Extension API specific abstraction of the Process-container object in the Process-container Layer. It represents the following capabilities: Process-container Shell Annotation Management, Process-container Transaction Management, Process-container Attachment Management, Process-container Journal Management, and Process-container State.

Process-containerTransaction

The Process-container Transaction object is an Extension API specific abstraction of the Process-container Transaction.

Process-containerJournal

The Process-containerLog object is an Extension API specific abstraction of the Process-container Journal.

Support Layer packages

There are certain Support Layer packages that are visible from, and expected to be used with the Extensions API: Java JNDI, Java JMS, Java Servlet, Xerces DOM/XML, and Xalan XSLT/XPATH. It is important to realize that Extensions can use, and are encouraged to use these packages. For instance these are guaranteed to be available in both Process-container Client and Process-container Server peer configurations.

Runtime Layer Objects

There are certain Runtine Layer objects that are visible from, and expected to be used with the Extensions API: Process-container Session Subsystem, Process-container Event Interface, Process-container Attachment Interface, Process-container Packet Interface, Process-container Email Interface, Process-container Message Interface, and Process-container Service Interface.

Self Contained Application

It is assumed that Extensions will be written that represent self-contained applications. These applications rely on the manipulation of Process-containers and other Extension API capabilities, to create a part of or a whole of an application.

Analytic Extensions

It is assumed that Extensions will be written that represent rules engines or other analytic capabilities. These are generic semantic drivers, but do not represent connectivity or integration with external standards or subsystems.

12. Process-Container Store

The Process-container Store is a subcomponent of the Runtime Layer that provides a fundamental capability to make Process-container instances and associated XML core objects persistent. The Process-container Store attempts to make as few decisions about how a Process-container is stored as possible. Types of Storage include Standalone document storage, Database Blob storage, and/or Database Structured storage. The default scheme is to manage Process-containers as standalone documents in flat file systems. An alternate scheme is to manage Process-containers as blobs in database systems. Another alternate scheme is to manage Process-containers as structured data in XML aware database systems.

Transactionality

The Process-container Store is transactionally manipulated using Java JTA transactions. This means the following things: Atomic: Any changes to a Process-container made within a JTA-transaction either are all made or none are made; Isolation: Process-containers may not necessarily be transactionally isolated from multiple run-time users. This isolation may be done via conventions between users; Durable: Any changes to a Process-container made within a JTA-transaction once made, are available even if the system has crashed.

Persistent Objects

The Store uses three types of storage to capture the shared and non-shared state of a Process-container: Serialized Process-container, Serialized Journal, and/or Serialized Binders. The Serialized Process-container is an XML document that is the serialized form of the Process-container XML minus the instances of Process-container Resource it has imported through Binders. The Serialized Journal is an XML document that is the serialized form of the Process-container XML minus the instances of Process-container Resource it has imported through Binders. Serialized Binders are stored separately from the Process-container and Journal because they are potentially shared resources across multiple Process-container instances.

The Store supports a set of types of indexing for Process-containers contained within it. Process-containers are automatically accessible by specifying their identity using the Process-container's Resource VURL Resource. Process-containers are also accessible by Process-container Variable. These are instances of XCL Variable placed within the body of the Process-container itself. Other features include Process-container Management; Binder Management; Downloading; Caching; Authentication, and Versioning.

13. Distribution

The Process-container environment has a unique set of distribution challenges and opportunities because of the asynchronous nature of Process-containers.

Process-Container Mobility

Process-containers are first of all asynchronous self contained portable agents. This means that they can be moved around easily between instance of a Process-container Peer. The Process-container Engine by itself however knows nothing about the mechanics of transport. This is contained in the one or more instances of a Transport Extension. The Transport may or may not implement the desired protocols completely so the Extensions API supports the creation of instances of Protocol Extension to enhance protocols beyond what the Transport provides.

Messaging

The Process-container Engine may rely on the availability of a Java JMS provider. The Runtime Layer and the Extension API are designed to allow the use of standard messaging systems to move Process-containers, Email, and other information between Engines. A Process-container Distribution Protocol may be used as well as a Pipelined Messaging Architecture.

Transport Extension

Transports are special types of Process-container Extensions that provide connectivity via various transports. Asynchronous transports are supported by the Process-container Environment. Examples of asynchronous transports are:

EMAIL: a ubiquitous store and forward transport characterized by unreliable delivery. Send protocols are usually different from receive protocols. Send protocol is usually SMTP or MAPI. Receive protocols are typically POP, IMAP, or MAPI.

QUEUE: Queuing is a store and forward transport characterized by reliable, often transactional delivery. There are commonly publish/subscribe interest based filtering mechanisms associated with this type of transport. Examples are Microsoft MSMQ, IBM MQSeries, and TIBCO. Almost all of these can be access via the JAVA JMS interface.

Synchronous transports are supported by the Process-container environment as well. Examples are:

HTTP: A ubiquitous request-response protocol, this MIME based delivery mechanisms was designed to support browser interactions, but has matured to support more standard transport scenarios.

IIOP: Used by both CORBA and Java RMI remote procedure calls, this transport is typically used for highly structured procedural calls.

FTP: Used throughout the WEB world, this an efficient, though unreliable synchronous protocol for exchanging Process-containers and related objects as byte-streams.

Protocol Extension

The Extensions API may be used to support Process-container Protocols that are not standard parts of the Process-container Environment. Below are some examples:

Reliable Delivery Protocol

The Process-container Environment supports a special type of extension protocol called the Process-container Distribution Protocol SDP. This protocol is transport independent and adds special features to both asynchronous and synchronous transports. The SDP provides the capability to ensure that between two engine endpoints, a given message of a given identity is received at least once. If there is some failure at the transport layer which causes a given message to be lost, then the message will be resent until successful delivery is acknowledged. If duplicate messages are sent, then the duplicates will be culled from the receiving side. The SDP provides the capability to have the sending side receive out of band notifications of various SDP events. Examples are: successful delivery and unsuccessful delivery.

Synchronization Protocol

A Synchronization protocol is where a Process-container that was transported to another Process-container Engine can have the remote version send its updates back to the original clone.

Replication Protocol

A Replication protocol is where a Process-container that was transported to another Process-container Engine can have updates to the original replicated to the remote Process-container.

Load Balancing Protocol

A Partitioning prototocol is where incoming messages can be re-directed to another Process-container Engine in order to balance workload across multiple Process-container Engines.

Tracking Protocol

A Workflow prototocol is where events on remote Process-containers can be received by extensions within the local Process-container Engine.

14. Other Features

Integration

The Process-container environment is designed to support integration with external products. Features include Database integration including Mapping Process-container Transactions XML to and from external data sources and Asynchronous Synchronization Protocols, and Application integration including SQL integration and API integration.

Other features include Profiling and Authoring. To support authoring features including a Process-container Tool, XCL Wizards, XCL Libraries, XCL Binders, XCL runtime debugging are provided.

Indexing

Indexing support is provided in the Process-container environment in order to create ‘index’ transactions that can be used locate and access resources. The Usage Model provides that Indices are used to support the access, through queries, of organized abstractions of data called indexes. Examples of index usage include: Dynamic Table of Contents, Help indexes, Application specific directories, Glossaries, Cross references/Hyper linking.

Navigation

Indices are designed to support publish-subscribe events that are directed to the page. Inter-Process-container indexing is also possible.

Processing Model

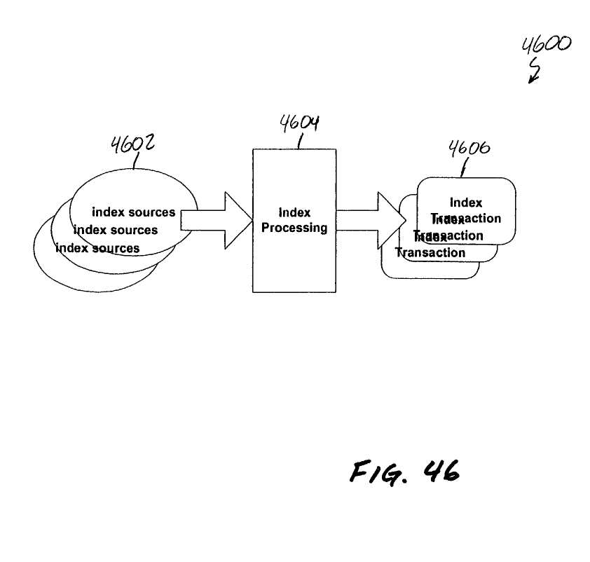

As illustrated in FIG. 46, the overall architecture of the index model is divided into three conceptual constructs: indexing sources, index processing, and a resultant set of indexing transactions. Indices are built based on information that is extracted from: XCL components, Javascript API, and Extensions API. The Run-time model includes read and write accesses. Indices are used at run-time in the following ways: read and write access through the Javascript API; read and write access through the Extension API; and read and write access through XCL components.

Discretion

Discretion within the Process-container Environment is where individual Process-container Transaction instances are annotated with special element level meta-data that contains specific permissions for specific individuals and groups (roles). This enables features such as Permissions including Read, View, Create, Delete permissions.

Security

The Process-container environment fully supports security adequate to providing the following functionality: Signatures, Encryption, and Authentication. Other aspects include an Extension Security Model, a Journal Security Model, a Binder Security Model, a JavaScript Security Model, an XCL Security Model, and a Process-container Interaction Security Model including Client side Authentication.

Sessions

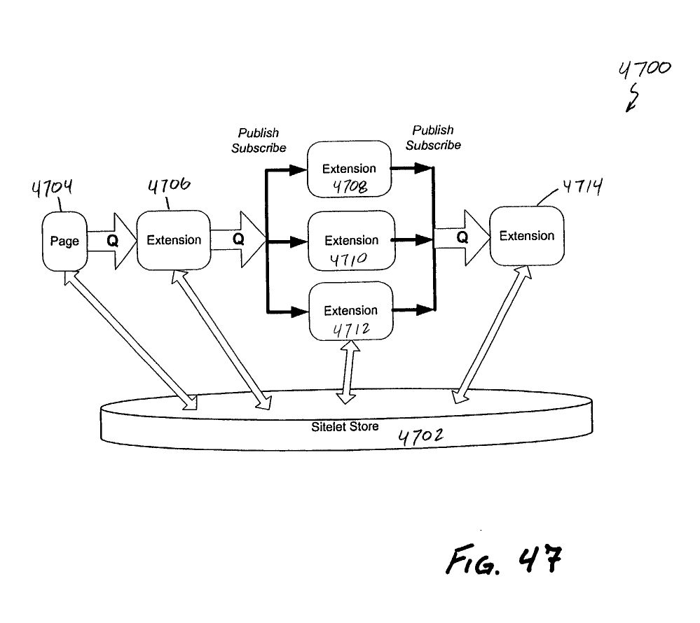

The architecture to support execution and back-end processing of Process-containers is illustrated in FIG. 47.

E. Process Descriptions

The system discussed above, including the hardware components and the program, are useful to perform the methods of the invention. However, it should be understood that not all of the above described components and program elements are necessary to perform any of the present invention's methods. In fact, in some embodiments, none of the above described system is required to practice the invention's methods. The system described above is an example of a system that would be useful in practicing the invention's methods. For example, the XCL model described above is useful, but it is not absolutely necessary to develop a Process-container in order to perform the methods of the invention.

Referring to FIG. 1, the flow depicted by the dashed circle represents a method embodiment of the present invention that may be performed on the server devices 106, 108 and the client devices 102, 104. It must be understood that the particular arrangement of elements in the FIG. 1, as well as the order of exemplary steps of various methods discussed herein, is not meant to imply a fixed order, sequence, and/or timing to the steps; embodiments of the present invention can be practiced in any order, sequence, and/or timing that is practicable.

In general terms and referring the FIG. 1, the method steps of the present invention can be summarized as follows. A client device 104 is used to define a process that involves transactions with remote users. A representation of the process is stored in a process-container along with any documents necessary to execute the transactions that make up the process. The client device 104 transmits the process-container to a remote server device 106 that may include a database or other application. The remote server interacts with the process-container, modifying and/or updating the documents stored therein as necessary, and then sends the process-container on its way according to the process definition within the logic of the process-container. Eventually the client device 104 that initiated the process, receive the process-container and is able to displaying the new contents of the process-container or otherwise interact with it.

F. Conclusion

It is clear from the foregoing discussion that the disclosed systems and methods of providing Process-container platforms represents an improvement in the art of process automation and collaboration. While the method and apparatus of the present invention has been described in terms of its presently preferred and alternate embodiments, those skilled in the art will recognize that the present invention may be practiced with modification and alteration within the spirit and scope of the appended claims. The specifications and drawings are, accordingly, to be regarded in an illustrative rather than a restrictive sense.

Further, even though only certain embodiments have been described in detail, those having ordinary skill in the art will certainly appreciate and understand that many modifications, changes, and enhancements are possible without departing from the teachings thereof. All such modifications are intended to be encompassed within the following claims.

What is claimed is:

1. A method comprising:
defining a process including at least one transaction;
storing a representation of the at least one transaction in a process-container;
transmitting the process-container to at least one remote entity;
receiving the process-container from the at least one remote entity; and
displaying contents of the process-container.

2. A method comprising:
defining a process including at least one transaction;
storing a representation of the at least one transaction in a process-container;
transmitting the process-container to at least one remote entity; and
updating the process-container on the at least one remote entity.

3. The method of claim 2 further comprising:
receiving the process-container from the at least one remote entity.

4. The method of claim 2 further comprising:
displaying contents of the process-container.

5. A method comprising:
defining a process including at least one transaction;
storing the at least one transaction in a process-container;
transmitting the process-container to at least one remote entity; and
interacting with the process-container on the at least one remote entity.

6. The method of claim 5 further comprising:
receiving the process-container from the at least one remote entity.

7. The method of claim 5 further comprising:
displaying the contents of the process-container.

8. A process-container comprising:
a logic module;
a storage module communicatively coupled to the logic module; and
an interface module communicatively coupled to the logic module.

9. A process-container comprising:
a logic module;
a storage module in communication with the logic module; and
an interface module in communication with the logic module.

10. A process-container comprising:
a presentation module;
a logic module coupled to the presentation module; and
a data module coupled to the presentation module.

11. The process-container of claim 10 further comprising a journal module coupled to the presentation module.

12. The process-container of claim 10 wherein the logic is coupled to the data module.

13. A process-container comprising:
a data module;
a logic module coupled to the data module; and
a presentation module coupled to the data module.

14. The process-container of claim 13 further comprising a journal module coupled to the data module.

15. The process-container of claim 14 wherein the logic is coupled to the journal module.

16. A process-container comprising:
at least one binder;
at least one attachment coupled to the at least one binder; and
at least one transaction coupled to the at least one binder.

17. The process-container of claim 16 further comprising a journal coupled to the at least one binder.

18. The process-container of claim 17 wherein the journal includes at least one mutation.

19. The process-container of claim 17 wherein the journal includes a plurality of mutations grouped into at least one cycle.

20. The process-container of claim 16 further comprising an identifier coupled to the at least one binder.

21. The process-container of claim 16 further comprising a shell annotation coupled to the at least one binder.

22. The process-container of claim 16 wherein the at least one binder includes at least one resource.

23. The process-container of claim 22 wherein the at least one resource includes at least one of an opaque resource, an object resource, a meta-data resource, and a data resource.

24. The process-container of claim 22 wherein the at least one resource includes a virtual uniform resource locator (VURL).

25. The process-container of claim 16 wherein the at least one attachment includes at least one multipurpose internet mail extension (MIME) bytestream.

26. The process-container of claim 25 wherein the at least one MIME bytestream includes at least one application document.

27. The process-container of claim 16 wherein the at least one attachment includes at least one application document.

28. The process-container of claim 16 wherein the at least one transaction includes at least one resource.

29. The process-container of claim 28 wherein the at least one resource includes at least one extensible markup language (XML) document.

30. The process-container of claim 29 wherein the at least one XML document is compliant to an external document type definition (DTD).

31. The process-container of claim 16 wherein the at least one transaction includes at least one data processing instruction.

32. The process-container of claim 16 wherein the process-container is operable to be executed on a peer.

33. The process-container of claim 16 wherein the process-container is operable to be transmitted between a plurality of peers.

34. A peer for executing a process-container comprising:
a runtime support environment including
an engine wherein the engine includes at least one of means for object mapping, means for persistence, means for journaling, means for querying, means for schema validation, means for compounding documents, and means for synchronizing documents.

35. A peer for executing a process-container comprising:
a runtime support environment including
an engine;
an extension application program interface (API) coupled to the engine; and
at least one process-container extension coupled to the extension API.

36. The peer of claim 35 wherein the at least one process-container extension includes at least one of a gateway extension, a workflow extension, a rules extension, a protocol extension, and a transport extension.

37. The peer of claim 35 wherein the virtual machine includes a Java virtual machine.

38. The peer of claim 35 wherein the engine includes a support module;
a runtime module coupled to the support module;
a core module coupled to the runtime module; and
a process-container module coupled to the core module.

39. The peer of claim 38 wherein the engine further includes at least one API.

40. The peer of claim 39 wherein the at least one API includes at least one of an extension API, a JavaScript API, and a XML component language (XCL) API.

41. The peer of claim 38 wherein the support module includes at least one of an interpreter package, a language parser package, a extensible stylesheet language transformation (XSLT) processor, a XML path language processor (XPATH), a servlet package, a naming interface package, a directory interface package, a message service package, a mail package, and an activation framework package.

42. The peer of claim 38 wherein the runtime module includes at least one of a persistent store subsystem, a process-container session subsystem, a verb protocol subsystem, a process-container event interface, a process-container packet interface, a process-container attachment interface, a process-container email interface, a process-container message interface, and a process-container service interface.

43. The peer of claim 38 wherein the core module includes at least one of means for object mapping, means for persistence, means for journaling, means for querying, means for schema validation, means for compounding documents, and means for synchronizing documents.

44. The peer of claim 38 wherein the process-container module includes at least one process-container.

45. The peer of claim 38 wherein the process-container module includes at least one of a binder, an attachment, a transaction, and a journal.

46. A system for automating a process comprising:
at least one process-container; and
at least one peer;
wherein the at least one process-container includes data and instructions relevant to a process and wherein the at least one peer is operable to execute the instructions, transmit the process-container, and receive the process-container.

47. The system of claim 46 wherein the at least one process-container is mobile.

48. The system of claim 46 wherein the at least one process-container is self-contained.

49. The system of claim 48 wherein the at least one process-container is self-contained wherein the peer is operable to execute the process-container without reference to other resources.

50. The system of claim 48 wherein the at least one process-container is self-contained wherein the peer is operable to execute the process-container off-line.

51. The system of claim 46 wherein the at least one process-container is asynchronous.

52. The system of claim 46 wherein the at least one process-container is executable.

53. The system of claim 46 wherein the at least one process-container is visualizable.

54. The system of claim 53 wherein the at least one process-container is visualizable as a web site.

55. The system of claim 46 wherein the at least one process-container is an agent.

56. The system of claim 46 wherein the at least one process-container is operable to provide a communication link to a peer on a remote system.

57. A device, comprising:
a processor; and
a storage device coupled to said processor and storing instructions adapted to be executed by said processor to:
define a process including at least one transaction;
store a representation of the at least one transaction in a process-container;
transmit the process-container to at least one remote entity;
receive the process-container from the at least one remote entity; and
display contents of the process-container.

58. A medium storing instructions adapted to be executed by a processor to perform a method of collaborating, said method comprising:
defining a process including at least one transaction;
storing a representation of the at least one transaction in a process-container;
transmitting the process-container to at least one remote entity;
receiving the process-container from the at least one remote entity; and
displaying contents of the process-container.

59. A medium transmitting instructions adapted to be executed by a processor to perform a method of collaborating, said method comprising:
defining a process including at least one transaction;
storing a representation of the at least one transaction in a process-container;
transmitting the process-container to at least one remote entity;
receiving the process-container from the at least one remote entity; and
displaying contents of the process-container.

60. A computer-readable medium that stores program code and data accessible by and executable by a processor in a data processing system, the program code and data including:
a first module operable to define a process including at least one transaction;
a second module operable to store a representation of the at least one transaction in a process-container;
a third module operable to transmit the process-container to at least one remote entity;
a fourth module operable to receive the process-container from the at least one remote entity; and
a fifth module operable to display contents of the process-container.

61. A system for collaborating comprising:
means for defining a process including at least one transaction;
means for storing a representation of the at least one transaction in a process-container;
means for transmitting the process-container to at least one remote entity;
means for receiving the process-container from the at least one remote entity; and
means for displaying contents of the process-container.

62. A system for process automation comprising:
means for defining a process including at least one task;
means for storing a representation of the at least one task in a process-container;
means for transmitting the process-container to at least one remote entity;
means for performing the at least one task on the at least one remote entity; and
means for updating the process-container based on performance of the at least one task.

63. The system of claim 62 further comprising:
means for receiving the process-container from the at least one remote entity; and
means for displaying contents of the process-container.
